(19) United States
(12) Patent Application Publication
(10) Pub. No.: US 2014/0343851 A1
(43) Pub. Date: Nov. 20, 2014

(54) SYSTEMS AND METHODS FOR MONITORING, MANAGING, AND FACILITATING LOCATION- AND/OR OTHER CRITERIA-DEPENDENT TARGETED COMMUNICATIONS AND/OR TRANSACTIONS

(71) Applicant: Joseph Michael, Los Angeles, CA (US)

(72) Inventor: Joseph Michael, Los Angeles, CA (US)

(21) Appl. No.: 14/454,489

(22) Filed: Aug. 7, 2014

Related U.S. Application Data
(63) Continuation of application No. 13/461,663, filed on May 1, 2012.
Application No. 13/461,663 is a continuation-in-part of application No. 13/192,449, filed on Jul. 27, 2011.
Application No. 13/192,449 is a continuation-in-part of application No. 13/161,483, filed on Jun. 15, 2011, now abandoned.

(51) Int. Cl. G01C 21/36

(52) U.S. Cl. CPC G01C 21/3605
USPC 701/538

(57) ABSTRACT

A method for monitoring, managing, and facilitating location- and/or other criteria-dependent targeted communications and/or transactions includes: receiving signals and/or information that include or provide, or facilitate or initiate a process of providing access to, location information and one or more criteria, requirements, preferences, and/or other inputs pertaining to, or initiating or facilitating, one or more desired or requested communications and/or transactions, the information including, or being associated or established in association with, one or more identifiers at least one of which is mobile, floating, or transportable in relation to one or more of a machine, an apparatus, a device, an object, and a sentient entity with which the identifier is associated; and processing the signals and/or information to identify in association with at least one of the one or more identifiers one or more transactions, advertisements, messages, and/or communications that satisfy one or more criteria, requirements, and/or preferences.

### CROSS-REFERENCE TO RELATED APPLICATIONS

This application is a continuation of U.S. patent application Ser. No. 13/461,663 filed May 1, 2012, which is a continuation-in-part of U.S. patent application Ser. No. 13/192,449, entitled “Systems and methods for monitoring, managing, and facilitating transactions involving vehicles”, filed on Jul. 27, 2011, and U.S. patent application Ser. No. 13/161,483, entitled “Systems and methods for monitoring and managing transportation infrastructure and locations of vehicles therein”, filed on Jun. 15, 2011, which are hereby incorporated by reference.

### TECHNICAL FIELD

The present invention relates generally to communications and/or transactions and, in particular, monitoring, managing, and facilitating communications and/or transactions relating to one or more transportation infrastructures and/or marketplaces.

### BACKGROUND ART

Transportation infrastructures provide many benefits to societies in addition to potentially increasing the efficiency and cost effectiveness of moving large numbers of people, goods, and/or other objects from one location to another. A significant challenge in relation to maintaining and successfully managing transportation infrastructures is how to simultaneously accommodate the sometimes conflicting requirements, goals, interests, or preferences of, for example, rush-hour commuters and law enforcement agencies.

Another key consideration in transportation infrastructure management is safety, for example, attempts are often made to strike an appropriate balance between a desire to effectively enforce traffic laws and a need in some circumstances to allow the vast majority of vehicles to continue moving through infrastructure networks (e.g., roads, highways, checkpoints) without being stopped or with minimal delays.

Consumers face various challenges in relation to efficiently finding desired goods and/or services and as to best practices in making purchasing decisions. Merchants face various challenges in relation to efficiently moving (selling) inventories of goods and/or, as a service provider, maintaining support resources on a cost-effective basis. Moreover, consumers and merchants alike are often uncertain as to what advertising or other information sources they should pay attention to in evaluating purchase options and consider utilizing to improve sales, respectively.

Accordingly, it would be useful to be able to provide an apparatus or method for monitoring, managing, and facilitating communications and/or transactions that addresses one or more of the foregoing considerations, or that provides a benefit such as improved efficiency, costs savings, or better or more informed decision making processes, for example, in relation to use, operation, or management of one or more transportation infrastructures and/or marketplaces.

### SUMMARY OF THE INVENTION

Example embodiments described herein involve the provision or utilization of transportation infrastructure utilization information (e.g., in relation to traffic management). The transportation infrastructure utilization information is accessed, utilized, and/or updated in association with a vehicle (e.g., in response to receiving signals including, associated with, or in association with information identifying and/or pertaining to a vehicle). The signals and/or information are processed to identify a circumstance that satisfies criteria for facilitating, controlling, or initiating one or more communications and/or transactions pertaining to, involving, or in relation to the vehicle (and/or other vehicles) and one or more transportation infrastructures.

In an example embodiment, a method for monitoring, managing, and facilitating communications and/or transactions relating to transportation infrastructure utilization includes: receiving signals including, associated with, or in association with information identifying and/or pertaining to a vehicle, the signals including or providing, or facilitating or initiating a process of providing access to transportation infrastructure utilization information (e.g., involving or in relation to the vehicle and/or other vehicles); processing the signals and/or information to identify, responsive to, or determined by or in relation to or in consideration of, the transportation infrastructure utilization information and in association with the vehicle (and/or other vehicles), a circumstance that satisfies criteria for facilitating, controlling, or initiating one or more communications and/or transactions pertaining to, involving, or in relation to the vehicle (and/or other vehicles) and one or more transportation infrastructures (or portions thereof); and applying one or more of the signals and/or information, the transportation infrastructure utilization information, times and/or locations of transportation infrastructure utilization by the vehicle, the circumstance, and one or more of the criteria to information (e.g., transportation infrastructure utilization information) associated with the vehicle to facilitate, control, or initiate an action or process involving the one or more communications and/or transactions and controlling or utilizing one or more electronic communications and/or display devices to effect at least a portion of the action or process.

Example embodiments described herein involve the provision or utilization of identifier information (e.g., an identifier) in relation to one or more communications and/or transactions. For example, the identifier information is applied to determine and/or provide one or more communication and/or transaction amounts associated with or in association with one or more communications and/or transactions pertaining to, involving, or in relation to one or more transportation infrastructures. In example embodiments, the identifier information includes one or more identifiers at least one of which is mobile, floating, or transportable (e.g., in relation to a vehicle).

In an example embodiment, a method for monitoring, managing, and facilitating communications and/or transactions relating to transportation infrastructure utilization includes: receiving signals including, associated with, or in association with identifier information provided or obtained by, identifying, and/or pertaining to one or more of a vehicle, a personal computing or communications device, a programmable or reprogrammable device, object, or article of media, and a person, the signals including or providing, or facilitating or initiating a process of providing access to transportation infrastructure utilization information (e.g., involving or in relation to the vehicle and/or other vehicles); processing the signals and/or information to identify, responsive to, or determined by or in relation to or in consideration of, the transportation infrastructure utilization information and in association with the identifier information, a circumstance that satisfies criteria for facilitating, controlling, or initiating one or more communications and/or transactions pertaining to, involving, or in relation to one or more transportation infrastructures; and controlling or utilizing one or more electronic communications and/or display devices to facilitate or initiate a process of applying the identifier information to determine and/or provide one or more communication and/or transaction amounts associated with or in association with the one or more communications and/or transactions.

Example embodiments described herein involve the electronic provision or facilitation of a group of marketplace participants in relation to one or more marketplaces and/or infrastructures. Communications and/or transactions relating to infrastructure and/or marketplace utilization are monitored, managed, and facilitated. For example, an identifier is utilized to automatically activate one or more electronic communications and/or display devices in association with multiple different participants, respectively, in relation to a process of determining one or more communication and/or transaction amounts.

In an example embodiment, a method for monitoring, managing, and facilitating communications and/or transactions relating to infrastructure and/or marketplace utilization includes: accessing information including one or more inputs and/or parameters for one or more communications and/or transactions involving usage or utilization by a vehicle of one or more transportation infrastructures and/or parking facilities or spaces, and/or at least one member of a group of marketplace participants (e.g., entities and/or merchants) involved, associated, or affiliated with one or more of a marketplace (or marketplaces) and the one or more transportation infrastructures and/or parking facilities or spaces; and applying an identifier to selectively activate one or more electronic communications and/or display devices in association with multiple different members of the group, respectively, to facilitate or initiate a process of determining one or more communication and/or transaction amounts to be charged to an account depending upon the one or more inputs and/or parameters.

Example embodiments described herein involve the provision or utilization of identifier information (e.g., an identifier) in relation to an action or process involving one or more location- and/or other criteria-dependent targeted communications and/or transactions. Signals and/or information (e.g., including, associated with, or received or established in association with identifier information) are processed to identify one or more transactions, advertisements, messages, and/or communications that satisfy one or more of one or more criteria, requirements, and/or preferences. The identifier information is utilized to determine and/or provide one or more amounts, charges, and/or non-monetary considerations associated with or in association with the one or more transactions, advertisements, messages, and/or communications. In example embodiments, the identifier information includes one or more identifiers at least one of which is mobile, floating, or transportable (e.g., in relation to a vehicle). Example methodologies and technologies described herein additionally involve facilitating or initiating a process of transmitting (e.g., broadcasting) and/or receiving one or more advertisements, messages, and/or communications that satisfy the one or more criteria, requirements, and/or preferences (e.g., specified in, determined from, or generated in consideration of one or more of, for example: the location information, one or more broadcast and/or receipt criteria, requirements, and/or preferences, a level/tier of service or membership, and an identification of mutually-specified subject matter as between criteria, requirements, preferences, and/or other inputs associated with or provided by broadcasting and receiving members/participants, respectively).

In an example embodiment, a method for monitoring, managing, and facilitating location- and/or other criteria-dependent targeted communications and/or transactions includes: receiving signals and/or information including, associated with, or in association with identifier information (e.g., information provided or obtained by, identifying, and/or pertaining to a vehicle, a personal computing or communications device, and entity, and/or a person), the signals and/or information including or providing, or facilitating or initiating a process of providing access to, location information and one or more criteria and/or other inputs pertaining to one or more desired or requested communications and/or transactions; processing the signals and/or information to identify in association with the identifier information one or more transactions, advertisements, messages, and/or communications that satisfy one or more of a group of criteria, requirements, and/or preferences(e.g., a group of interrelated criteria, requirements, and/or preferences including, for example, one or more transaction criteria, one or more transaction requirements and/or preferences specified in, determined from, or generated in consideration of the location information, and one or more communications criteria, requirements, and/or preferences); and controlling or utilizing one or more electronic communications and/or display devices to facilitate or initiate a process of applying the identifier information to determine and/or provide one or more amounts, charges, and/or non-monetary considerations (e.g., a proffered alternative to monetary payment, such as a good or service) associated with or in association with the one or more transactions, advertisements, messages, and/or communications.

Example embodiments described herein involve the provision or utilization of one or more identifiers in relation to an action or process of accessing or providing access to location information and one or more criteria, requirements, preferences, and/or (other) inputs pertaining to, or initiating or facilitating, one or more desired or requested communications and/or transactions. Signals and/or information (that include or provide, or facilitate or initiate the action or process) are processed to identify (e.g., in association with at least one of the one or more identifiers) one or more transactions, advertisements, messages, and/or communications that satisfy one or more of the criteria, requirements, and/or preferences. By way of example, the location information pertains to one or more identifiers with which at least one of the inputs is associated or established in association with. By way of example, the location information pertains to one or more desired or requested communications and/or transactions. In example embodiments, at least one of the one or more identifiers is mobile, floating, or transportable (e.g., in relation to one or more of a machine, an apparatus, a device, an object, and a sentient entity with which the identifier is associated). In example embodiments, the one or more identifiers include multiple different identifiers, at least one which is provided or obtained by a personal computing or communications device or other auxiliary device. Example methodologies and technologies described herein additionally involve accessing, or facilitating or initiating a process of providing access to, an interface that allows a user to perform actions (e.g., in relation to controlling a visual presentation involving one or more transactions, advertisements, messages, and/or communications) including, inter alia, controlling and/or managing one or more searches and/or broadcasts (e.g., selecting, or otherwise providing or determining, criteria and/or inputs utilized in generating a visual presentation of search results and/or responses to broadcasts).

In an example embodiment, a method for monitoring, managing, and facilitating location- and/or other criteria-dependent targeted communications and/or transactions includes: receiving signals and/or information that include or provide, or facilitate or initiate a process of providing access to, location information and one or more criteria, requirements, preferences, and/or other inputs pertaining to, or initiating or facilitating, one or more desired or requested communications and/or transactions, the information including, or being associated or established in association with, one or more identifiers at least one of which is mobile, floating, or transportable in relation to one or more of a machine, an apparatus, a device, an object, and a sentient entity (e.g., one or more of a vehicle, a personal computing or communications device, a programmable or reprogrammable device, object, or article of media, and a person) with which the identifier is associated; and processing the signals and/or information to identify in association with the identifier one or more transactions, advertisements, messages, and/or communications that satisfy one or more criteria, requirements, and/or preferences (e.g., one or more location-dependent and/or targeted criteria, requirements, and/or preferences).

Example embodiments described herein involve the provision or utilization of one or more identifiers in relation to one or more transactions, advertisements, messages, and/or communications, one or more inputs and/or parameters thereof being associated with or established in association with the one or more identifiers. For example, the one or more identifiers are applied to facilitate or initiate a process of providing or determining one or more amounts, charges, and/or non-monetary considerations associated with the one or more transactions, advertisements, messages, and/or communications. Example methodologies and technologies described herein additionally involve, or facilitate or initiate, an action or process of transferring funds (e.g., between accounts of and/or associated with the members and/or participants) and/or transferring, or providing access to, one or more non-monetary tenders in relation to the one or more amounts, charges, and/or non-monetary considerations.

In an example embodiment, a method for monitoring, managing, and facilitating location- and/or other criteria-dependent targeted communications and/or transactions includes: accessing information including one or more inputs and/or parameters for one or more transactions, advertisements, messages, and/or communications, at least one of the inputs and/or parameters being associated with or established in association with one or more identifiers (e.g., provided or obtained by, identifying, and/or pertaining to a vehicle, a personal computing or communications device, an entity, and/or a person), the information including marketplace utilization information associating one or more members and/or participants of a marketplace (or marketplaces) with at least one of the one or more identifiers; and applying the one or more identifiers to facilitate or initiate a process of providing or determining one or more amounts, charges, and/or non-monetary considerations associated with the one or more transactions, advertisements, messages, and/or communications depending upon the marketplace utilization information and the one or more inputs and/or parameters.

Further with regard to the one or more identifiers, example methodologies and technologies described herein involve or facilitate activation of and/or management of the one or more identifiers. For example, one or more electronic communications and/or display devices are controlled or utilized to allow a user to provide inputs to a software application or program that controls a process of managing, selecting, or otherwise providing or determining, criteria and/or inputs utilized by or in relation to multiple identifiers (e.g., activating, deactivating, relocating or reassigning an identifier and/or changing a prioritization as between a plurality of the identifiers). By way of an additional example, an interface can be provided that allows a user to perform actions (e.g., in relation to controlling and/or managing one or more identifiers) including, inter alia, selecting, or otherwise providing or determining, criteria and/or inputs utilized in an automated process for activating and/or deactivating one or more identifiers. Example methodologies and technologies described herein additionally involve facilitating or initiating an action or process of presenting a visual representation of one or more of, for example: the one or more identifiers (e.g., an icon indicating a type of identifier) and a location of at least one of the one or more identifiers (e.g., of an activated primary identifier, or of all activated identifiers).

Further with regard to interfaces, example methodologies and technologies described herein involve or facilitate activation of and/or management of one or more visual presentations (e.g., involving one or more transactions, advertisements, messages, and/or communications). For example, one or more electronic communications and/or display devices are controlled or utilized to allow a user to provide inputs to a software application or program that controls a process of establishing or generating a sequence of visual presentations (e.g., establishing and controlling an order in which different groups of search results and/or responses to broadcasts are presented in relation to each other). By way of an additional example, an interface can be provided that allows a user to perform actions (e.g., in relation to controlling a visual presentation involving one or more transactions, advertisements, messages, and/or communications) including, inter alia, selecting, or otherwise providing or determining, criteria and/or inputs utilized in an automated process for generating a sequence of visual presentations of one or more search results and/or responses to broadcasts.

Example methodologies and technologies described herein additionally involve providing access to or utilizing a custom add-in or plug-in system application which functions as an extension and overlay to an existing system application or other platform that facilitates one or more of, for example: traffic management, vehicle navigation, communications and/or transactions relating to transportation infrastructure and/or marketplace utilization, an on-line auction or other electronic communications network-facilitated interface, platform, or service that allows buyers and sellers of goods and/or services to offer or request transactions and/or communications with each other, communications and/or transactions involving one or more transaction facilitators, assistants, and/or advisors, communications and/or transactions launched or initiated directly from an on-line or other electronic communications network-facilitated social or professional network interface or platform, communications and/or transactions launched or initiated directly from an on-line or other electronic communications network-facilitated search or question answering interface or platform, and activation of and/or management of the one or more identifiers.

### BRIEF DESCRIPTION OF THE DRAWINGS

FIG. 1 shows an example implementation of a system for monitoring and managing transportation infrastructure and locations of vehicles therein;

FIG. 2 shows an example electronic tracking device suitable for the system of FIG. 1;

FIG. 3 shows an example implementation of a method for monitoring and managing transportation infrastructure and locations of vehicles therein;

FIG. 4 shows an example interactive interface presenting a visual representation of a region, vehicles within the region, and information associated with the vehicles;

FIG. 5 shows another example interactive interface presenting a visual representation of a region, a restricted area within the region, vehicles within the region, and information associated with the vehicles;

FIG. 6 shows an example apparatus for monitoring and managing usage of a parking space;

FIG. 6A shows an image capture/code reader device capturing an image of code provided on or generated by the parking meter apparatus of FIG. 6;

FIG. 7 shows another example apparatus for monitoring and managing usage of a parking space;

FIG. 7A shows code generated by a code generator device being captured by the image capture/code reader device of the parking meter apparatus of FIG. 7;

FIG. 8 shows an example implementation of a method for monitoring and managing usage of a parking space;

FIG. 9 shows an example implementation of a system for monitoring, managing, and facilitating transactions involving vehicles;

FIG. 10 shows an example electronic device suitable for the system of FIG. 9;

FIG. 11 shows an example implementation of a method for monitoring, managing, and facilitating transactions involving vehicles;

FIG. 12 shows an example depiction of an infrastructure(s)/marketplace(s) environment;

FIG. 13 shows an example embodiment of a method for monitoring, managing, and facilitating communications and/or transactions relating to transportation infrastructure utilization;

FIG. 14 shows another example embodiment of a method for monitoring, managing, and facilitating communications and/or transactions relating to infrastructure and/or marketplace utilization;

FIG. 15 shows an example interface presenting a visual presentation of an infrastructure(s)/marketplace(s) environment and received communications;

FIGS. 16A-16C show examples of targeted areas defined in relation to routes or paths and/or locations in infrastructure(s)/marketplace(s) environment;

FIG. 17 shows an example embodiment of a method for monitoring, managing, and facilitating location- and/or other criteria-dependent targeted communications and/or transactions;

FIG. 18 shows an example of how a sequence of visual presentations can be specified or otherwise determined and controlled utilizing the systems and methods described herein;

FIG. 19 shows another example embodiment of a method for monitoring, managing, and facilitating location- and/or other criteria-dependent targeted communications and/or transactions; and

FIG. 20 shows still another example embodiment of a method for monitoring, managing, and facilitating location- and/or other criteria-dependent targeted communications and/or transactions.

### DISCLOSURE OF INVENTION

Example embodiments described herein involve methods and technologies for monitoring and managing transportation infrastructure and locations of vehicles therein. For purposes of this disclosure, the term “transportation infrastructure” includes, by way of example, but not of limitation: road and highway networks in addition to parking spaces and facilities associated therewith and/or accessible thereby, including structures (bridges, tunnels, culverts, retaining walls), signage and markings, electrical systems (street lighting and traffic lights), edge treatments (curbs, sidewalks, landscaping) and specialized facilities such as road maintenance depots and rest areas; railways, including structures, terminal facilities (rail yards, train stations), level crossings, signalizing and communications systems; canals and navigable waterways requiring continuous maintenance (dredging, etc.); seaports and lighthouses; airports, including air navigational systems; mass transit systems (commuter rail systems, subways, tramways, trolleys and bus transportation); bicycle paths and pedestrian walkways; and ferries. For purposes of this disclosure, the term “vehicles” includes, by way of example, but not of limitation: motorized vehicles, non-motorized vehicles, road vehicles, all-terrain vehicles, railway vehicles, amphibious vehicles, as well as watercraft, hovercraft, aircraft, spacecraft, and other vehicles and vessels. Example embodiments of the methods and technologies described herein facilitate monitoring and managing transportation infrastructure and locations of vehicles therein. Other example embodiments of the methods and technologies described herein facilitate monitoring and managing locations of vehicles, persons, and/or objects in relation to an area or region of interest or concern, independent of whether the area or region includes, constitutes, facilitates, provides access to, or is a part of a transportation infrastructure.

In an example method, a network (or other communication means) is utilized to provide user interfaces at personal computing devices, or at other devices capable of generating interfaces (e.g., interactive displays), in response to commands received and/or resources accessed via the network.

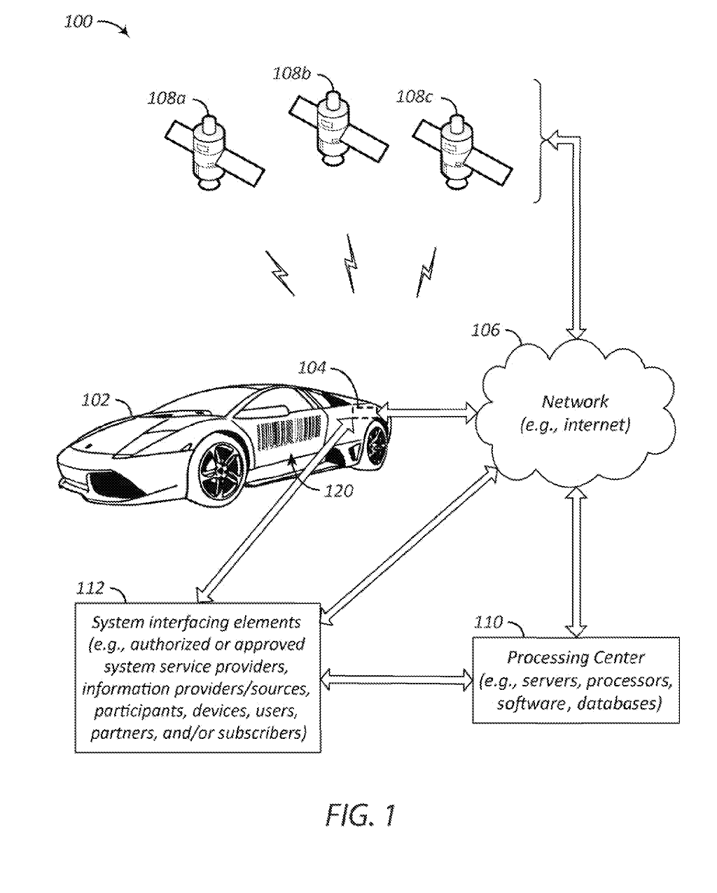

FIG. 1 shows an example implementation of a system 100 for monitoring and managing transportation infrastructure and locations of vehicles therein. In this example implementation, a vehicle 102 is equipped with an electronic tracking device 104 (shown in dashed lines) configured to communicate with a network 106 (e.g., the internet) via satellites 108a, 108b, and 108c. In this example implementation, the network 106 is also utilized to facilitate communications links between a processing center 110 (e.g., implemented in the form of servers, processors, or the like operating under the control of software and/or other sources of commands or inputs), system interfacing elements 112 (e.g., authorized or approved system service providers, information providers/sources, participants, devices, users, partners, and/or subscribers), and the electronic tracking device 104.

For purposes of this disclosure, the term “electronic tracking device” includes, by way of example, but not of limitation: any device attached to a vehicle or other movable thing that reveals its location or movement by transmission of electronic signals. In an example embodiment, the electronic tracking device 104 includes a Global Positioning System (GPS) tracking device or unit (e.g., a GPS module configured to receive GPS signals from the satellites 108a, 108b, and 108c and calculate coordinates) and a modem or other communications device configured to transmit location and telemetry input data.

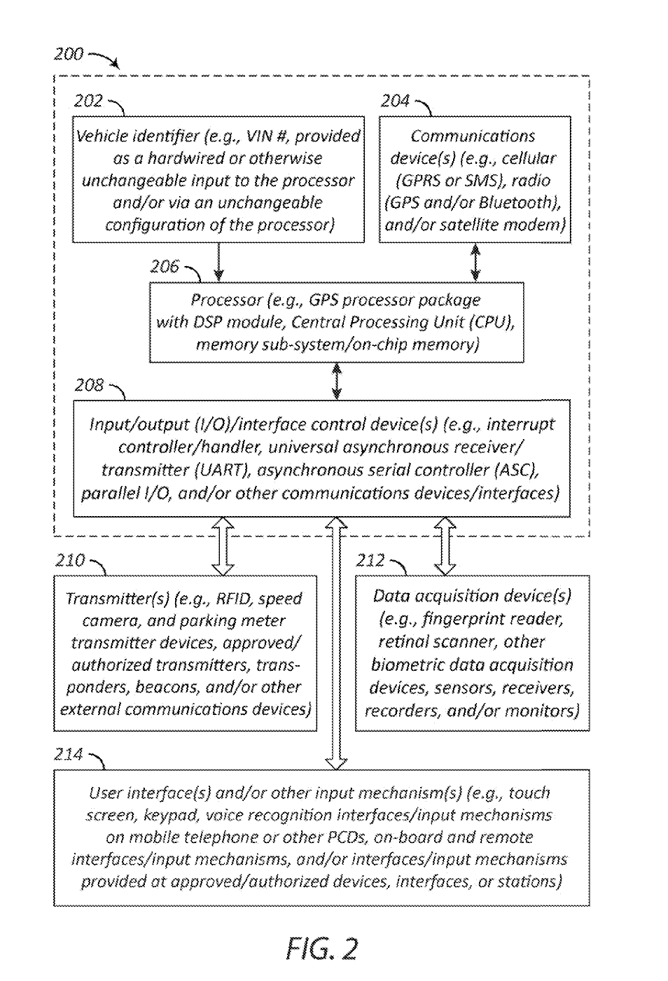

Referring to FIG. 2, an example electronic tracking device 200 (suitable for the system 100 for monitoring and managing transportation infrastructure and locations of vehicles therein) includes a vehicle identifier 202, communications device(s) 204, a processor 206, and input/output (I/O)/interface control device(s) 208 configured as shown. When a vehicle is registered, a license plate is issued. All vehicles are identified with a particular Vehicle Identification Number (VIN) or the Hull Identification Number (HIN) for vessels/boats. Each year the registration establishes the registered owner and also the lienholder. By way of example, the vehicle identifier 202 can be the VIN of the vehicle equipped with the electronic tracking device 200 or other numbers, letters, characters, symbols, codes, or the like, whether human-readable, machine-readable, or both. In an example embodiment, the vehicle identifier 202 includes, represents, and/or provides vehicle identification information that uniquely identifies the vehicle equipped with the electronic tracking device 200. In an example embodiment, the electronic tracking device 200 is configured such that the vehicle identification information cannot be changed or prevented from being transmitted during normal operation of the electronic tracking device. By way of example, the vehicle identifier 202 is implemented/provided as a hardwired or otherwise unchangeable input to the processor 206 and/or via an unchangeable configuration of the processor 206. Moreover, in an example embodiment, the electronic tracking device 200 is configured such that an attempt to change, modify, damage, make unauthorized alterations to, or otherwise tamper with the vehicle identifier 202 and/or processor 206 results in an alert or alarm being generated, e.g., transmitted by the communications device(s) 204 to one or more of, for example: a state, a county, a city, a town, a municipality, a court, a government agency, a law enforcement agency, a department of motor vehicles, a parking and/or traffic enforcement agency, a company or other private-sector entity or organization, authorized operators and users of a system for monitoring and managing transportation infrastructure and locations of vehicles therein, an individual or a group, an owner or a registered owner of the vehicle, a person or persons authorized or approved by the owner and/or the registered owner of the vehicle, a lienholder, an insurance company, an authorized or approved source or device, and a processor or controller.

The communications device(s) 204 include, for example, a cellular (GPRS or SMS), radio (GPS), and/or satellite modem. The communications device(s) 204 can include one or more of, for example: modems, transmitters, transponders, beacons, transceivers, and/or receivers. In an example embodiment, the communications device(s) 204 include a communications device that utilizes a short-range wireless technology or standard (e.g., Bluetooth), or a wireless local area network (WLAN) (e.g., based on the IEEE 802.11 standards). Thus, in example embodiments, the electronic tracking device 200 includes a communications device facilitating one or more of cellular, radio and satellite communications.

The processor 206 includes or is implemented utilizing, for example, a GPS processor package with a digital signal processing (DSP) module (for processing signals received from GPS satellites), a Central Processing Unit (CPU), and a memory sub-system/on-chip memory. By way of example, the DSP module includes GPS correlation hardware configured to extract GPS data from incoming intermediate frequency (IF) data, various implementations of which are known to one of ordinary skill in the art.

The input/output (I/O)/interface control device(s) 208 include one or more of, for example: an interrupt controller/handler, a universal asynchronous receiver/transmitter (UART), an asynchronous serial controller (ASC), a parallel I/O, and other communications devices/interfaces. In example embodiments, the electronic tracking device 200 includes one or more devices that serve as both a communications device 204 and an input/output (I/O)/interface control device 208. The input/output (I/O)/interface control device(s) 208 receive signals that include data, information, commands, and/or other inputs, as shown in FIG. 2, from one or more of: transmitter(s) 210, data acquisition device(s) 212, and user interface(s) and/or other input mechanism(s) 214. The transmitter(s) 210 include one or more of, for example: a radio-frequency identification (RFID) transmitter/transponder, a camera (e.g., a speed camera, hand-held digital camera) equipped with a transmitter or other communications device, a parking meter transmitter device, and approved/authorized transmitters, transponders, beacons, and other external communications devices (i.e., separate from or remotely located in relation to the electronic tracking device 200). The data acquisition device(s) 212 include one or more of, for example: a fingerprint reader, a retinal scanner, and other biometric data acquisition devices, sensors (e.g., blood alcohol sensor), receivers, recorders, and monitors. The user interface(s) and/or other input mechanism(s) 214 include one or more of, for example: a touch screen, a keypad, voice recognition interfaces/input mechanisms on mobile telephones, smartphones, or other personal computing devices (PCDs), on-board and remote interfaces/input mechanisms, and interfaces/input mechanisms provided at approved/authorized devices, interfaces, or stations. In alternative embodiments, one or more of the transmitter(s) 210, the data acquisition device(s) 212, and the user interface(s) and/or other input mechanism(s) 214 are a component, a part, or a peripheral of the electronic tracking device 200.

In an example embodiment, an apparatus for monitoring and managing transportation infrastructure and locations of vehicles therein includes: an electronic tracking device with a transmitter that generates signals that include information relating to (e.g., identifying) one or more of a vehicle equipped with the electronic tracking device (e.g., VIN or other unique identifier), an owner (e.g., registered owner), a driver, a custodian (e.g., renter), or a passenger of the vehicle, a person, an animal, or an object within, secured to, or transported by the vehicle, and a person, an entity, an object, a status, a condition, an event, an indication, or an interrupt associated with the vehicle. In an example embodiment, the signals are transmitted over an interval of time (e.g., during which the vehicle changes its location in relation to one or more devices that receive the signals).

In example embodiments, one or more of the communications device(s) 204 is configured to transmit the signals to one or more participatory elements of a monitoring system (e.g., a system for monitoring and managing transportation infrastructure and locations of vehicles therein). For example, and referring to FIG. 1, the communications device 204 is included as a part, a component, or a peripheral of the electronic tracking device 104 and is configured to transmit the signals, either directly or indirectly (e.g., via the network 106 or the satellites 108a, 108b, and 108c), to the processing center 110 and/or one or more of the system interfacing elements 112. In example embodiments, the processing center 110 and/or other participatory elements of a monitoring system receive or are provided with the signals and/or information (e.g., signals and/or information received over an interval of time). In example embodiments, the processing center 110 and/or other participatory elements of a monitoring system store the signals and/or information, utilize the signals and/or information to update one or more databases, and/or process the signals and/or information.

Referring again to FIG. 2, in an example embodiment, the electronic tracking device 200 is configured to receive and respond to interrupts and/or commands from one or more of: authorized or approved sources and/or devices (e.g., law enforcement agencies, police and other authorized transmitter devices, blood alcohol sensors, one or more departments of motor vehicles, parking and/or traffic enforcement agencies, operators and users of a system for monitoring and managing transportation infrastructure and locations of vehicles therein, a person or an entity authorized or approved to receive or collect funds, an owner or a registered owner of the vehicle, a person or persons authorized or approved by the owner and/or the registered owner of the vehicle, lienholders, insurance companies, a processor or controller of or in communication with the electronic tracking device 200), biometric data acquisition devices, user-input mechanisms (e.g., on-board touch screen, mobile telephone, smartphone, or personal communication device (PCD) of the registered owner of the vehicle, emergency call devices), RFID transmitters, speed camera transmitters, and parking meters.

In example embodiments, and referring also to FIG. 1, one or more of the transmitter(s) 210, the data acquisition device(s) 212, and the user interface(s) and/or other input mechanism(s) 214 are included among the system interfacing elements 112 (FIG. 1). For example, the system interfacing elements 112 can include a speed camera or other image capture device configured to read a code 120 (e.g., a bar code) provided on the vehicle 102 and to utilize information or data obtained from reading the code 120 to generate (or facilitate the generation of) an interrupt and/or command. In an example embodiment, the information or data is obtained (directly) by reading the code 120. In another example embodiment, the information or data used by a system interfacing element 112 to determine if an interrupt and/or command should be generated is provided at least in part by another source (e.g., the processing center 110) or device. For example, the speed camera transmits or causes another device to transmit an interrupt and/or command in response to a determination or information indicating that the vehicle 102 is or was traveling at an unlawful, inappropriate, or excessive speed. In this example, a speed camera transmitter can uplink the interrupt and/or command (e.g., to the processing center 110) or directly transmit the interrupt and/or command (e.g., to a receiver or other communications device of the electronic tracking device 200). In example embodiments, a speed camera (or other transmitter-equipped system interfacing element 112) can also transmit an interrupt and/or command, as well as other information or data, either directly or indirectly, to other participatory elements of a monitoring system.

The code 120 can be provided in the form of numbers, letters, characters, symbols, and/or other indicia, whether visible or otherwise (e.g., code that is not revealed by visible light, but rather by infrared). The code 120 can be human-readable, machine-readable, or both. In example embodiments, the code 120 is provided on the vehicle 102 in the form of a material such as paint (e.g., in conjunction with applying paint to the vehicle during its manufacture) that is readable by a speed camera or other image capture device independent of whether the electronic tracking device 104 is present or operational. Thus, the code 120 can serve as an alternative or supplemental means for providing vehicle identification information, i.e., means that can be utilized when the electronic tracking device 200 malfunctions or ceases normal operation (i.e., transmitting the signals), or if the vehicle has not been provided with an electronic tracking device, or if the electronic tracking device has been removed from the vehicle.

In example embodiments, the interrupts and/or commands facilitate, control, or initiate (e.g., in response to commands or instructions executed by the processor 206 and/or by a processor/controller accessible to and/or in communication with the electronic tracking device 200) one or more of, for example: modifying the information transmitted or adding additional information to the signals transmitted by the electronic tracking device; providing information and/or notifications to authorized operators and users of a system for monitoring and managing transportation infrastructure and locations of vehicles therein; controlling an interactive user interface, a graphical user interface, or a display inside the vehicle, on a mobile communications device (e.g., a mobile telephone, a smartphone, or other PCD configured to facilitate wireless communications), and/or at a remote location to provide one or more of information, instructions, a notification, a warning, and a prompt; transferring funds from an account associated with one or more of the vehicle, an owner, a driver, a custodian, or a passenger of the vehicle, a person, an animal, an object within, secured to, or transported by the vehicle, and a person, an entity, an object, a status, a condition, an event, an indication, or an interrupt associated with the vehicle to one or more other accounts; and issuing a ticket, citation, warning or other communication. It should be understood that the personal computing devices described herein are presented as examples of devices capable of generating interfaces (e.g., interactive displays) in response to commands received and/or resources accessed via a network (or other communication means) and that the scope of the invention(s) includes implementations in which other devices are alternatively or additionally utilized to provide interfaces in relation to or otherwise implement the technologies and/or methodologies described herein.

The process of modifying the information transmitted or adding additional information to the signals transmitted by the electronic tracking device includes, by way of example, changing information associated with the vehicle or a status of a person or object associated with the vehicle, or adding biometric information (e.g., biometric information identifying in association with the vehicle an unauthorized driver of the vehicle or a wanted criminal), RFID information (e.g., RFID information received by the electronic tracking device 200 identifying stolen goods on board the vehicle), or emergency call information (e.g., information constituting an emergency call or a call for help received from an approved/authorized transmitter, beacon, or the like) to the signals. In an example embodiment, the electronic tracking device 200 includes or is operatively coupled or connected to a data acquisition device 212 (e.g., a fingerprint reader, retinal scanner, or blood alcohol sensor), which can be configured to require an input from the driver (e.g., as a prerequisite to enabling operation of the vehicle), as well as an input from some or all of the passengers (e.g., associating inputs provided at one or more data acquisition device(s) 212 with particular seats in the vehicle). Detection of a passenger who has not provided an input via a data acquisition device 212 can be accomplished utilizing weight sensors in the seats to provide this additional input to the electronic tracking device 200.

The process of providing information and/or notifications to authorized operators and users of a system for monitoring and managing transportation infrastructure and locations of vehicles therein includes, by way of example, providing information and/or notifications relating to vehicle registration (e.g., information about a vehicle registration process, a notification of a registration renewal deadline, a notification to a law enforcement agency that a vehicle registered to a felon or some other category or type of criminal has been identified within a particular area or region), a driver's license (e.g., a notification of a deadline for renewing a driver's license), an insurance policy (e.g., a notification of a deadline for renewing an automobile insurance policy), and/or a location (e.g., a tracked location) of a stolen vehicle (thereby assisting law enforcement agencies in tracking stolen vehicles and reducing the overall cost to insurance companies and the overall insurance rate to the general public.) The authorized operators and users include one or more of, for example: a law enforcement agency, a government agency (e.g., one or more departments of motor vehicles), a state, a county, a city, a town, or a municipality, a company or other private-sector entity or organization (e.g., a lienholder, an insurance company), an individual or a group (e.g., security guards/personnel, private investigators, deputized individuals, groups of citizens) provided with an authorized or approved device (e.g., proprietary equipment), an owner or a registered owner of the vehicle, and a person authorized or approved by the owner and/or the registered owner (e.g., family members, employees).

The process of controlling an interactive user interface, a graphical user interface, or a display inside the vehicle, on a mobile communications device, and/or at a remote location to provide one or more of information, instructions, a notification, a warning, and a prompt includes, by way of example, controlling an interactive user interface, a graphical user interface, or a display to provide information to a driver that his or her vehicle is approaching a checkpoint, an accident, or a potential hazard. For example, the interface or display is controlled to provide the information on a map (e.g., updated utilizing GPS data) that includes visual representations of, or icons representing, police, DUI, and/or other checkpoints in an area or region that the vehicle is moving through. In another example embodiment, the interface or display is controlled to provide information to a government agency (e.g., United States Secret Service), a law enforcement agency (e.g., state or city police), and/or a security organization (e.g., private security personnel) that a vehicle (e.g., registered to a felon, criminal, or other person or entity of interest or concern) has been identified or information relating to a detected or reported location and/or movement of the vehicle. For example, the interface or display is controlled to provide the information on a map (or other representation of an area or region) that includes visual representations of, or icons representing, detected vehicles and/or information associated with each of the vehicles (e.g., information downloaded from a database maintained at the processing center 110).

In another example embodiment, the interface or display (e.g., generated inside the vehicle and/or on a mobile communications device associated with the owner or registered owner of the vehicle) is controlled to provide a notification relating to registration of the vehicle, e.g., a message notifying a person who has been in California for 20 days that they need to register their vehicle if they now reside in California. Information as to whether a person has accepted gainful employment in California, claimed a homeowner's exemption in California, has rented or leased a residence in California, has acquired a California driver's license or registered to vote, enrolled in an institute of higher learning as a California resident, or enrolled their dependents in school (K-12) can also be taken into consideration in controlling the interface or display. For example, nonresident military personnel stationed in California and their spouses may operate their vehicles with valid out-of-state license plates from their home state of the state where the military person was last stationed. In example embodiments, one or more departments of motor vehicles (DMVs) are participants in a monitoring system that shares and/or aggregates information as between the DMV(s) and other authorized or approved participants (e.g., lienholders). Technically, a lienholder is the co-owner of a vehicle. If the registered owner fails to pay the lienholder, the location of the vehicle can be established in assisting the lienholder repossess the vehicle. This will reduce the cost of repossession to many financial institutions. To this end, in another example embodiment, the interface or display (e.g., generated at a remote location in relation to the vehicle) is controlled to provide a notification (e.g., to a lienholder) pertaining to one or more of, for example: names and addresses of the registered owner of the vehicle, the legal owner of the vehicle, and interested parties in relation to the vehicle (e.g., from DMV vehicle history records, which are incorporated into one or more databases maintained and managed, for example, by one or more monitoring system participants).

In another example embodiment, the interface or display (e.g., generated inside the vehicle and/or on a mobile communications device associated with the owner or registered owner of the vehicle) is controlled to provide a warning relating to a location and/or movement of the vehicle. For example, the interface or display (and, optionally, also a speaker or other sound generating device) is controlled to provide a visual representation of the warning (e.g., a text message, such as: “You are traveling at an excessive speed. This is a courtesy warning. Next time, you will receive a citation and fine, and possibly additional penalties, impounding of your vehicle, and/or suspension or revocation of your driver's license as may be appropriate or required under the law.”)

In another example embodiment, the interface or display (e.g., generated inside the vehicle, on a mobile communications device associated with the owner or registered owner of the vehicle, and/or at a remote location in relation to the vehicle) is controlled to provide a prompt relating to the vehicle. For example, the interface or display (and, optionally, also a speaker or other sound generating device) is controlled to provide a visual representation of the prompt (e.g., a user interface presenting a message field or other visual representation of a prompt to renew and/or authorize a transfer of funds for renewal of a vehicle registration, a driver's license, and/or automobile insurance).

The process of transferring funds from an account associated with one or more of the vehicle, an owner, a driver, a custodian, or a passenger of the vehicle, a person, an animal, an object within, secured to, or transported by the vehicle, and a person, an entity, an object, a status, a condition, an event, an indication, or an interrupt associated with the vehicle to one or more other accounts includes, by way of example, transferring funds from an account associated with a renter of the vehicle (e.g., if a moving violation involving the vehicle is detected or determined to have occurred while the renter was driving the vehicle) or a passenger of the vehicle identified from biometric data (e.g., an obligor parent in child support arrears identified, for example, by checking identified passengers or other persons in the vehicle to determine if they are included in a “deadbeat parents” database), or transferring funds from the account to one or more accounts associated with multiple departments of motor vehicles (e.g., revenue splitting between California and Michigan DMVs). The one or more other accounts are associated with one or more of, for example: an entity authorized to receive or collect funds in relation to a parking or moving violation associated with the vehicle, a government agency (e.g., a DMV), a state, a county, a city, a town, a municipality, a court, a lienholder, and an insurance company.

The process of issuing a ticket, citation, warning or other communication includes, by way of example, issuing a ticket, citation, warning or other communication in relation to a parking or moving violation associated with the vehicle). For example, the VIN of the vehicle is transmitted with a computer or processor generates the citation for a particular violation associated with the vehicle. In the case of speeding violations, vehicle speed can be determined using GPS data only, radar reports of the speed of the vehicle associated with a particular VIN, or utilizing GPS data in conjunction with radar speed measurements.

The technologies and methods described herein can be implemented, by way of example, utilizing one or more websites, user interfaces, and/or applications. In an example embodiment, referring again to FIG. 1, the processing center 110 can perform the functions of, provide, or facilitate a service host (e.g., implemented in the form of servers, processors, or the like operating under the control of software and/or other sources of commands or inputs) configured, for example, to utilize a system application or other platform to facilitate vehicle associated monitoring and/or other activities or tasks, for example, by hosting a website accessible by system participants and/or users via the network 106.

In example embodiments, technologies and methods for monitoring and managing transportation infrastructure and locations of vehicles therein are implemented via a website (and/or one or more other resources accessible via a network or otherwise).

In example embodiments, technologies and methods for improving a vehicle registration process are implemented as an addition and/or an improvement to an existing website such as the official website of California Department of Motor Vehicles (dmv.ca.gov), The Los Angeles Police Department (www.lapdonline.org), or The Federal Bureau of Investigation (www.fbi.gov). In an example embodiment, one or more interfaces are generated utilizing a custom plug-in system application which functions as an extension and overlay to an existing system application or other platform that facilitates, for example, on-line vehicle registration renewal and/or driver's license renewal. It should be understood that the user interfaces described herein can be implemented or provided utilizing a website, an addition and/or an improvement to an existing website, or a resource other than a website, and independent of whether the resource is directly accessible by the user. Furthermore, resources can be distributed with respect to their physical locations and can be controlled, individually or as groups (e.g., shared resources), by one or more service hosts and/or system participants.

In an example “Vehicle Digital Registration” technology and/or methodology, each manufacturer of a motor vehicle is required, encouraged, and/or incentivized to install an electronic tracking device or other transmission device that communicates (e.g., continually transmits) information including vehicle identification information (e.g., the VIN of the vehicle) to a satellite and/or a sensor which establish the VIN of a vehicle to a satellite. For example, a DMV or other government agency can make the installation of a transmitter/sensor a requirement (e.g., a required step in the vehicle registration process) and mandatory in new vehicles as well as used vehicles.

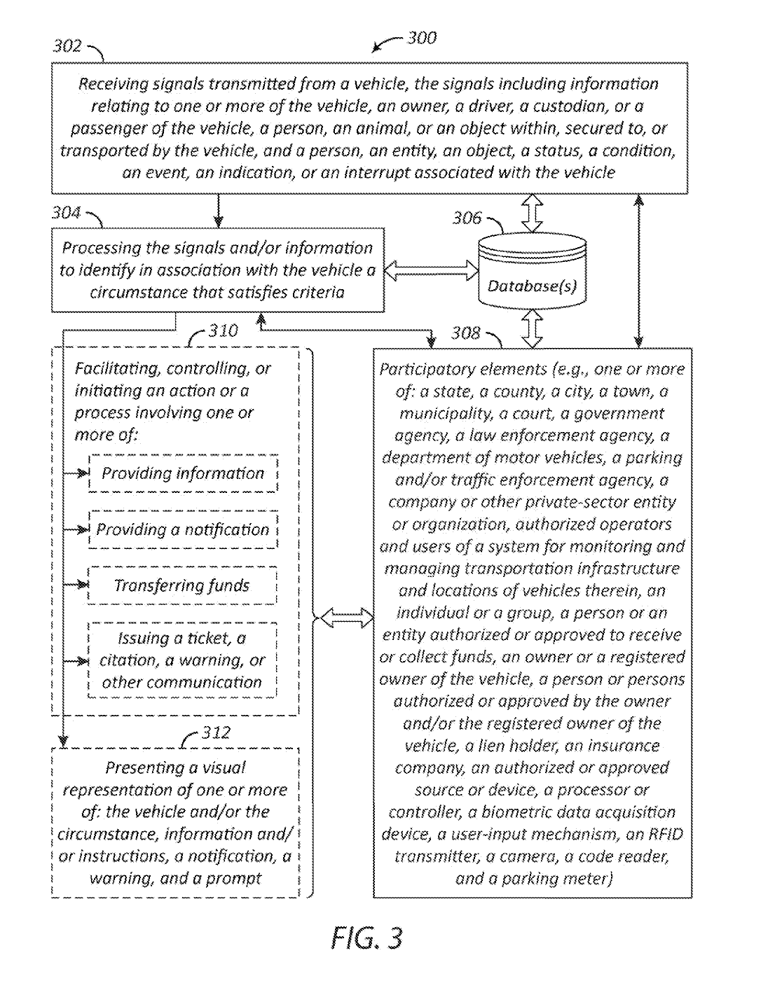

FIG. 3 shows an example implementation of a method 300 for monitoring and managing transportation infrastructure and locations of vehicles therein. At 302, signals transmitted from a vehicle are received (e.g., and referring also to FIG. 1, by one or more of the network 106, the satellites 108a, 108b, and 108c, the processing center 110, and the system interfacing elements 112). The signals include information relating to (e.g., identifying) one or more of, for example: the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle. In an example embodiment, the signals are received over an interval of time.

At 304, the signals and/or information are processed to identify in association with the vehicle a circumstance that satisfies (predetermined or other) criteria. The signals and/or information are processed, for example, by the processing center 110 and/or one or more of the system interfacing elements 112 (e.g., operators, users, and/or devices involved in or facilitating a system for monitoring and managing transportation infrastructure and locations of vehicles therein). In example embodiments, the signals and/or information are processed at least in part by participatory elements 308. By way of example, the participatory elements 308 include one or more of: a state, a county, a city, a town, a municipality, a court, a government agency, a law enforcement agency, a department of motor vehicles, a parking and/or traffic enforcement agency, a company or other private-sector entity or organization, authorized operators and users of a system for monitoring and managing transportation infrastructure and locations of vehicles therein, an individual or a group, a person or an entity authorized or approved to receive or collect funds, an owner or a registered owner of the vehicle, a person or persons authorized or approved by the owner and/or the registered owner of the vehicle, a lienholder, an insurance company, an authorized or approved source or device, a processor or controller, a biometric data acquisition device, a user-input mechanism, an RFID transmitter, a camera, a code reader, and a parking meter. In example embodiments, information, data, and/or programs stored in one or more database(s) 306 is utilized in processing the signals and/or information. The database(s) 306 include one or more of, for example, a law enforcement database, a DMV database, an insurance database, and a lienholder database. It should be understood that the database(s) 306 can include additional database(s) pertaining, for example, to other types of information and/or data as described herein.

In an example embodiment, the circumstance is an identification, a determination, and/or a prediction of one or more of a parking violation and a moving violation associated with one or more of the vehicle, an owner, a driver, a custodian, or a passenger of the vehicle, and a person within or transported by the vehicle.

In another example embodiment, the circumstance is an identification, a determination, and/or a prediction that one or more of a registration, a driver's license, and an insurance policy associated with one or more of the vehicle, an owner, a driver, a custodian, or a passenger of the vehicle, and a person within or transported by the vehicle is, or will be, expired, out-of-state, canceled, revoked, and/or suspended.

In another example embodiment, the circumstance is an identification, a determination, and/or a prediction that one or more of an account, a tax, an assessment, a charge, a surcharge, a fee, a fine, and a penalty associated with one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle is, or will be, late, overdue, unpaid, delinquent, and/or in default (e.g., a deadbeat parent passenger of the vehicle who is late in paying child support; valuables, such as jewelry tracked with RFID-based technology, that were purchased pursuant to an installment payment plan now in default).

In another example embodiment, the circumstance is a crime, reported, detected or suspected criminal activity, or an identification, a determination, and/or a prediction of a crime or criminal activity associated with one or more of the vehicle, an owner, a driver, a custodian, or a passenger of the vehicle, a person, an animal, or an object within, secured to, or transported by the vehicle, and a person (e.g., human trafficking/smuggling), an entity, an object (e.g., stolen goods), a status, a condition, an event, an indication, or an interrupt associated with the vehicle.

In another example embodiment, the circumstance is an identification, a determination, and/or a prediction of a status associated with one or more of the vehicle (e.g., stolen), an owner, a driver, a custodian, or a passenger of the vehicle, a person, an animal, or an object within, secured to, or transported by the vehicle, and a person (e.g., felon, parolee, registered sex offender, child molester), an entity, an object, a condition, an event, an indication, or an interrupt associated with the vehicle.

In another example embodiment, the circumstance is an identification, a determination, and/or a prediction of one or more of a condition (e.g., illegal, non-exempted, excessive or increasing levels of emissions, or greenhouse gases, that are being generated by the vehicle; intoxication/impairment of the driver of the vehicle), an indication (e.g., vehicle transmitter malfunctioning, attempt was made to disable), and an interrupt associated with one or more of the vehicle, an owner, a driver, a custodian, or a passenger of the vehicle, a person, an animal, or an object within, secured to, or transported by the vehicle, a person, an entity, an object, a status, or an event associated with the vehicle, and a location, an area, a region, or an environment within which the vehicle is located, or that the vehicle is approaching or departing from. Examples of interrupts include: an alert (e.g., child abduction/Amber Alert, hazardous materials alert/Hazmat alert), an emergency call (e.g., SOS, 911, body function/vital signs monitor automatically generating emergency call, for example, in response to cardiac arrest), an alarm (e.g., silent alarm triggered by an undercover peace officer inside the vehicle).

In another example embodiment, the circumstance is an event (e.g., a presidential motorcade) for or during which a location of the vehicle or a person, an animal, or an object within, secured to, or transported by the vehicle presents or potentially raises a concern in relation to the event.

In another example embodiment, the circumstance is an identification, a determination, and/or a prediction that a location (e.g., a tracked location) of the vehicle is within, approaching, or departing from an area, a region, or an environment designated as prohibited, unlicensed, limited, restricted, or cautionary access in relation to one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle.

In another example embodiment, the circumstance is an identification, a determination, and/or a prediction that a location (e.g., a tracked location) of the vehicle is outside, departing from, or returning to an area, a region, or an environment designated as allowed, permitted, licensed, unlimited, unrestricted, or safe access in relation to one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle.

At 310, an action or a process is facilitated, controlled, or initiated (e.g., by one or more of the participatory elements 308). The action or process involves one or more of, for example: providing information, providing a notification, transferring funds, and issuing a ticket, citation, warning or other communication. In an example embodiment, a method for monitoring and managing transportation infrastructure and locations of vehicles therein includes processing the signals and/or the information to identify in association with the vehicle a circumstance that satisfies criteria for facilitating, controlling, or initiating an action or a process involving one or more of providing information, providing a notification, transferring funds, and issuing a ticket, a citation, a warning, or other communication.

An action or a process involving providing information includes, by way of example, providing information pertaining to one or more of the vehicle, an owner, a driver, a custodian, or a passenger of the vehicle, a person, an animal, or an object within, secured to, or transported by the vehicle, a person, an entity, an object, a status, a condition, an event, an indication, or an interrupt associated with the vehicle, the circumstance, and a location, an area, a region, or an environment within which the vehicle is located, or that the vehicle is approaching or departing from, to one of more of, for example: a law enforcement agency, a government agency, a state, a county, a city, a town, or a municipality, a company or other private-sector entity or organization, an individual or a group provided with an authorized or approved device, an owner or a registered owner of the vehicle, and a person authorized or approved by the owner and/or the registered owner.

With respect to an action or a process involving providing a notification, the notification pertains to one or more of, for example: a parking violation and/or a moving violation associated with one or more of the vehicle, an owner, a driver, a custodian, or a passenger of the vehicle, and a person within or transported by the vehicle; a crime, criminal activity, illegal action, prohibited substance, criminal record or notice and/or conviction associated with one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle; a location and/or a movement of the vehicle; locations and/or movements of one or more vehicles associated with a person, persons, entity, object, group, organization, event, enterprise, and/or circumstance; an event for or during which a location of the vehicle or a person, an animal, or an object within, secured to, or transported by the vehicle presents or potentially raises a concern in relation to the event; an area, a region, or an environment designated as prohibited, unlicensed, limited, restricted, or cautionary access in relation to one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle; an area, a region, or an environment designated as allowed, permitted, licensed, unlimited, unrestricted, or safe access in relation to one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle; a registration, a driver's license, and/or an insurance policy associated with one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle; vehicle registration requirements for new residents of the state; and information and/or updates to information in a DMV or other database.

An action or a process involving transferring funds includes, by way of example, transferring funds from an account associated with one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle to one or more other accounts (e.g., revenue splitting between California and Michigan DMVs). By way of example, the one or more other accounts are associated with one or more of: an entity authorized to receive or collect funds in relation to a parking or moving violation associated with the vehicle, a state agency (e.g., a DMV), a city, a municipality, a court, a lienholder, and an insurance company.

With respect to an action or a process involving issuing a ticket, a citation, a warning, or other communication, in an example embodiment, the ticket, citation, warning, or other communication is electronically issued and/or automatically transmitted (e.g., to the person ticketed/cited/warned and/or to other interested, appropriate, or designated recipients such as, for example, a parole officer, a parent/guardian, or a superior officer). In an example embodiment, a ticket, a citation, a warning, or other communication in relation to a parking or moving violation associated with the vehicle is automatically generated and electronically transmitted (e.g., at a time deemed appropriate depending upon the nature and/or circumstances of the violation).

In an example embodiment, a citation is automatically generated and transmitted (e.g., when it is detected or otherwise determined that a vehicle is using public roads with an expired registration). To this end, the database(s) 306 can also include or facilitate access to information indicating whether a road is public or private. Thus, example methodologies and technologies described herein embody and/or provide an “Automatic Citation Tool” that can be utilized by law enforcement agencies or others to track and/or find vehicles that travel on roadways and/or use public streets with expired registrations or registrations soon to expire or in a renewal grace period. The “Automatic Citation Tool” described herein compares favorably, at least in terms of efficiency, to the traditional process of a parking enforcement officer or law officer visually inspecting the license tag of a license plate in order to identify vehicles that are using the public roadways with expired registrations.

In another example embodiment, an account, person, or entity associated with a vehicle is automatically billed when it is detected or otherwise determined that the vehicle is not properly registered. For example, a bill is automatically generated after a vehicle from another state (or country) has been within the border of a state for a period of time (e.g., a minimum number of days) triggering a requirement of vehicle registration in that state. Thus, example methodologies and technologies described herein embody and/or provide an “Automatic Registration Billing Tool” that can be utilized by a DMV to help increase the amount of vehicle registration revenues received and the speed with which they are received. Moreover, the “Automatic Registration Billing Tool” described herein stands to dissuade the pervasive practice—often perpetrated by the owners of expensive vehicles—of purchasing vehicles in another state, which may have lower or no vehicle registration fees, but using the vehicle primarily in some other state (e.g., purchasing and registering a vehicle in Nevada, while garaging and using the vehicle in California). In another embodiment, an “Automatic Registration Billing Tool” automatically determines (e.g., based on monitored locations of the vehicle) circumstances when a prorated, shared, or other distribution of vehicle registration fees (or other vehicle-related fees or revenues) is warranted as between multiple states or other jurisdictions.

Example methodologies and technologies described herein present, or facilitate a presentation of, visual representations pertaining to a vehicle, a circumstance, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle, information, and/or notifications. Example implementations utilize a network and/or communications links and one or more interfaces and/or displays are to present the visual representations.

At 312, a visual representation is presented (e.g., to one or more of the participatory elements 308). By way of example, the visual representation presented is a visual representation of one or more of: the vehicle and/or the circumstance, information and/or instructions, a notification, a warning, and a prompt. In an example embodiment, a method for monitoring and managing transportation infrastructure and locations of vehicles therein includes presenting a visual representation of one or more of: the vehicle and/or the circumstance, information and/or instructions, a notification, a warning, and a prompt.

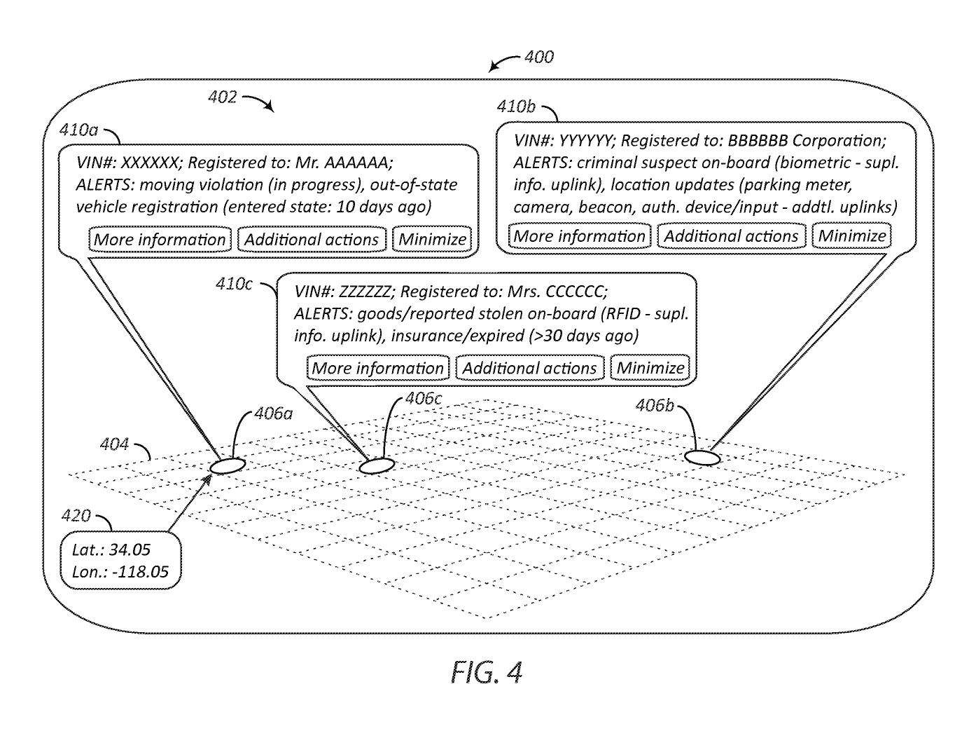

FIG. 4 shows an example interactive interface 400 presenting a visual representation 402 of a region 404, vehicles 406a, 406b, and 406c within the region, and information associated with the vehicles. In this example, interface portions 410a, 410b, and 410c (of the interface 400) are controlled to provide information associated with the vehicles 406a, 406b, and 406c, respectively. Within each of the interface portions 410a, 410b, and 410c, sub-portions denoted “More information”, “Additional actions”, and “Minimize” are actuated, for example, by touching a location of the interface 400 bound by one of the sub-portions. For example, in response to selections and/or inputs provided at a menu or interface facilitating “Additional actions”, a display portion 420 is generated to present latitude and longitude information for a particular vehicle. In this example, the interface portion 410a provides the following information about and/or associated with the vehicle 406a: “VIN #: XXXXXX; Registered to: Mr. AAAAAA. ALERTS: moving violation (in progress), out-of-state vehicle registration (entered state: 10 days ago)”. In this example, the interface portion 410b provides the following information about and/or associated with the vehicle 406b: “VIN #: YYYYYY; Registered to: BBBBBB Corporation; ALERTS: criminal suspect on-board (biometric-supl. info. uplink), location updates (parking meter, camera, beacon, auth. device/input -addtl. uplinks)”. In this example, the interface portion 410c provides the following information about and/or associated with the vehicle 406c: “VIN #: ZZZZZZ; Registered to: Mrs. CCCCCC; ALERTS: goods/reported stolen on-board (RFID-supl. info. uplink), insurance/expired (>30 days ago)”.

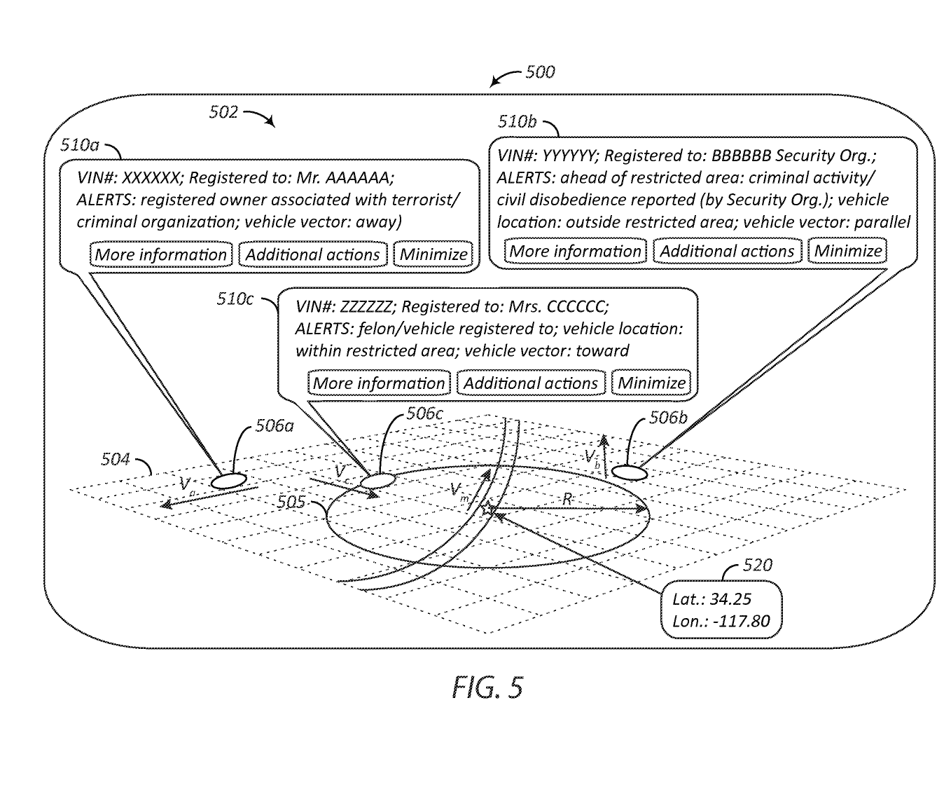

FIG. 5 shows another example interactive interface 500 presenting a visual representation 502 of a region 504, a restricted area 505 within the region, vehicles 506a, 506b, and 506c within the region, and information associated with the vehicles. In this example, interface portions 510a, 510b, and 510c (of the interface 500) are controlled to provide information associated with the vehicles 506a, 506b, and 506c, respectively. Within each of the interface portions 510a, 510b, and 510c, sub-portions denoted “More information”, “Additional actions”, and “Minimize” are actuated, for example, by touching a location of the interface 500 bound by one of the sub-portions. For example, in response to selections and/or inputs provided at a menu or interface facilitating “Additional actions”, a display portion 520 is generated to present latitude and longitude information for a particular vehicle. In this example, the interface portion 510a provides the following information about and/or associated with the vehicle 506a: “VIN #: X; Registered to: Mr. AAAAAA; ALERTS: registered owner associated with terrorist/criminal organization; vehicle vector: away)”. In this example, the interface portion 510b provides the following information about and/or associated with the vehicle 506b: “VIN #: YYYYYY; Registered to: BBBBBB Security Org.; ALERTS: ahead of restricted area: criminal activity/civil disobedience reported (by Security Org.); vehicle location: outside restricted area; vehicle vector: parallel”. In this example, the interface portion 510c provides the following information about and/or associated with the vehicle 506c: “VIN #: ZZZZZZ; Registered to: Mrs. CCCCCC; ALERTS: felon/vehicle registered to; vehicle location: within restricted area; vehicle vector: toward”.

Example methodologies and technologies described herein present, or facilitate a presentation of, visual representations of vehicles detected within a specified or otherwise determined area or region. In the example interface 500, a restricted area 505 is an area or region defined by a circular boundary existing at a radius R about a center point located at the “star” icon. In this example, the center point of the restricted area 505 moves with (e.g., tracks using GPS data) the location of the “star” icon (which, by way of example, serves as a visual representation of a vehicle in a presidential motorcade). An area or region can be specified or determined in various ways, resulting in boundaries that are circular, non-circular, square, rectangular, or other shapes. An area or region can be specified or determined such that it includes multiple portions (e.g., overlapping and/or non-overlapping portions), which can be stationary or fixed in relation to the region 504, move or reposition in relation to a location of a tracked vehicle, person, or object, or a combination of static and dynamically specified or determined portions (e.g., of a searched and/or monitored area or region).

The interface 500 is generated, for example, in response to a search request and includes visual representations presented in a user-friendly manner or other arrangement (e.g., appropriate for providing a law enforcement officer of other person with an arrangement of information optimized to permit reading of the most critical information first, for example, within each line of text presented). For example, if a law enforcement officer searches for all vehicles with a 5 block radius, the display 500 is controlled to present information about or associated with the detected vehicles (e.g., vehicle identification information, information about the registered owners of the vehicles, etc.) Search request criteria can be changed to accommodate different crime prevention scenarios. For example, the radius R can be set to 1/10 mile to identify vehicles located a short distance from a bank robbery, theft, or other crime in progress.

In an example embodiment, search results are generated based on search criteria/circumstance, and further filtered, if desired. In example embodiments, search results can be analyzed immediately and/or at a later time. The data can also be retroactively analyzed (e.g., in consideration of additional information and/or data from other sources or devices).

In an example embodiment, the display 500 is controlled to present information including, for example, updated and/or new information or inputs provided by authorized or approved sources or devices. Updated and/or new information or inputs used to control generation of a visual representation at the display 500 can be provided, for example, in response to an interrupt or other signal generated by an officer in the field, citizen, or other person who has observed or become aware of criminal activity/civil disobedience (e.g., in association with, for example, a location, a vehicle, a person, and/or a group). Updated and/or new information or inputs used to control generation of a visual representation at the display 500 can also be provided, for example, by a person with an image capture device (e.g., equipped with code reading software), independent of whether the image capture device is configured to facilitate wireless communications. For example, images captured by the device (e.g., an authorized or approved device) can be transferred through a wired connection, removable memory component, or otherwise to another computer or device that communicates the image data and/or associated information to a processing center. Updated and/or new information or inputs used to control generation of a visual representation at the display 500 can also be provided, for example, via a Bluetooth, Wi-Fi, or other wireless communications link. For example, persons participating in or conducting surveillance, neighborhood watch, and/or various other “citizen sentinel” activities (e.g., while sitting at a sidewalk café at which a Wi-Fi connection is available) can be provided with access to a secure website or other interface through which they can provide updated and/or new information or inputs that can be used to control generation of a visual representation at the display 500. In this regard, information associated with such persons can also be used to assess the credibility or likely significance, importance, or criticality of information or inputs submitted by said persons.

Referring again to FIG. 3, an example method for monitoring and managing transportation infrastructure and locations of vehicles therein further includes adding information pertaining to one or more of the vehicle, an owner, a driver, a custodian, or a passenger of the vehicle, a person, an animal, or an object within, secured to, or transported by the vehicle, a person, an entity, an object, a status, a condition, an event, an indication, or an interrupt associated with the vehicle, the circumstance, and a location, an area, a region, or an environment within which the vehicle is located, or that the vehicle is approaching or departing from, to a database and/or using the information to update a database. In another example embodiment, the method for monitoring and managing transportation infrastructure and locations of vehicles therein further includes adding to or modifying the information, the circumstance, and/or the criteria in response to an input or inputs provided by one or more of, for example: a state, a county, a city, a town, or a municipality, a court, a government agency, a law enforcement agency, a department of motor vehicles, a parking and/or traffic enforcement agency, a company or other private-sector entity or organization, authorized operators and users of a system for monitoring and managing transportation infrastructure and locations of vehicles therein, an individual or a group provided with one or more authorized or approved devices, the use of which results in input(s) being provided, a person or an entity authorized or approved to receive or collect funds in relation to a parking or moving violation associated with the vehicle, an owner or a registered owner of the vehicle, a person or persons authorized or approved by the owner and/or the registered owner of the vehicle, a lienholder, an insurance company, an authorized or approved source (e.g., of inputs and/or data) or device (e.g., law enforcement agency transmitter devices and other authorized or approved transmitters, beacons, or communications devices), a processor or controller (e.g., of or in communication with an electronic tracking device monitoring the location of the vehicle), a biometric data acquisition device, a user-input mechanism (e.g., on-board touch screen, mobile communications device, and/or PCD of the registered owner of vehicle, emergency call devices), an RFID transmitter, a camera (e.g., a speed camera or other image capture device), a code reader (e.g., a device that reads a bar code or other code on the vehicle), and a parking meter (e.g., a device configured to monitor and manage usage of a parking space and to receive information and/or other inputs in association with a vehicle).

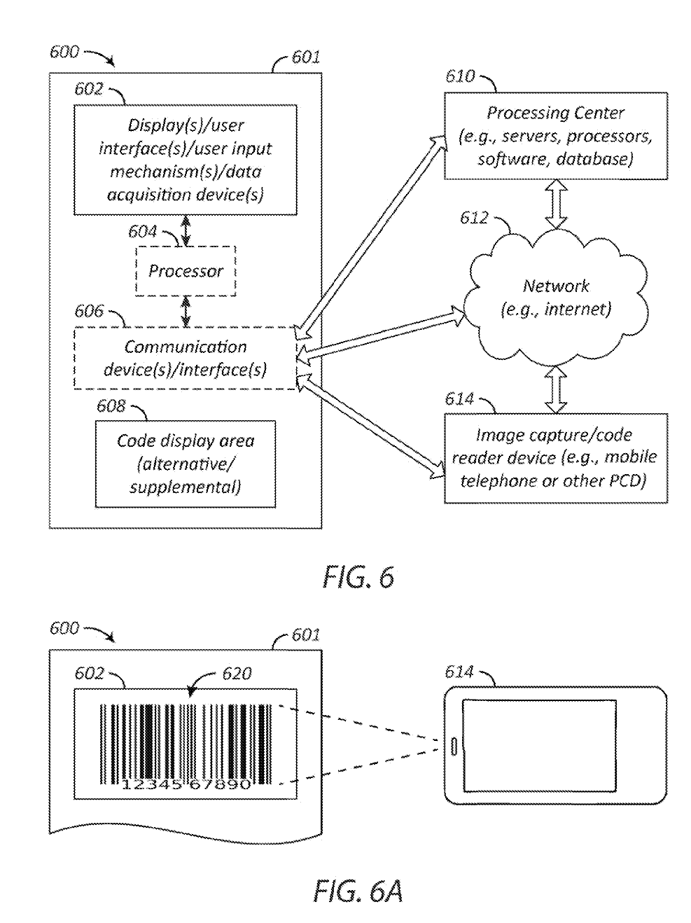

FIG. 6 shows an example apparatus 600 for monitoring and managing usage of a parking space. In an example embodiment, the apparatus 600 includes a parking meter 601 that facilitates providing information including a parking meter start time, a parking meter stop time, and an association between the parking meter and an account, and initiates or requests a transaction in which the account is charged (or debited) depending upon an amount of time passing between the start time and the stop time.

In an example embodiment, the association is between a uniquely identified parking meter and an account and is established utilizing a code. In an example embodiment, the association is established by a device that captures an image of the code and is configured with or utilizes or accesses code reader software that processes the image to read the code.

Referring again to FIG. 6, the parking meter 601 includes display(s)/user interface(s)/user input mechanism(s)/data acquisition device(s) 602, a processor 604, communication device(s)/interface(s) 606, and a code display area (alternative/supplemental) 608 configured as shown. In this example embodiment, the association is established utilizing a code provided on or generated by the parking meter 601. To this end, and referring also to FIG. 6A, an image capture/code reader device 614 (e.g., a mobile telephone, a smartphone, or a PCD) is utilized to capture an image of a code 620 (which is depicted, in this example, as a bar code) provided on or generated by the parking meter apparatus. In this example embodiment, the parking meter 601 is configured with (or utilizes or accesses) code generator software to generate the code 620 presented at the display 602. The code 620 can be provided in the form of numbers, letters, characters, symbols, and/or other indicia, whether visible or otherwise (e.g., code that is not revealed by visible light, but rather by infrared). The code 620 can be human-readable, machine-readable, or both. In an example embodiment, the code 620 is presented on the display 602 and/or printed, embossed, or applied on an external portion 608 of the parking meter 601 (e.g., provided on a metal plate secured to the parking meter 601).

The image capture/code reader device 614 can be provided, for example, in the form of a mobile telephone, a smartphone, or a PCD configured with a camera and with code reader software (and/or configured to utilize or access code reader software). Various software programs/products suitable for reading and/or decoding images of code captured by mobile telephones, smartphones, and PCDs are commercially available.

In this example embodiment, the communication device(s)/interface(s) 606 is configured to communicate with a processing center 610 (e.g., implemented in the form of servers, processors, or the like operating under the control of software and/or other sources of commands or inputs) directly and/or via a network 612 (e.g., the internet).

In an example embodiment, the parking meter 601 is configured to transmit or initiate a process of providing a communication to a device (e.g., the image capture/code reader device 614) that captures an image of the code 620. The communication can be provided directly from the parking meter 601 (e.g., generated by the processor 604), or from a remote processing location or center (e.g., in response to information provided to the processing center 610 by the parking meter 601). In an example embodiment, the communication includes a resource (e.g., URL) or other information that provides a user of the device with access to a receipt (e.g., PDF file/image) or other documentation or information relating to a transaction involving and/or usage of the parking meter.

In operation, the image capture/code reader device 614 is used to capture an image of the code 620 which, as previously discussed, can be presented at the processor-controlled display 602 and/or on the external display area 608. The external display area 608, as an alternative means for presenting the code 620, is useful for providing a lower cost parking meter (e.g., that is not configured to electronically present the code 620 at the display 602). The external display area 608, as a supplemental means for presenting the code 620, is useful for providing a parking meter that allows a user of the image capture/code reader device 614 to capture an image of the code 620 from a distance (e.g., while initially approaching the parking meter 601). In an example embodiment, the process of providing information including a parking meter start time, a parking meter stop time, and an association between the parking meter and an account can be performed utilizing the processor-controlled display 602 (at the parking meter 601), a user interface or other input mechanism separate from the parking meter 601 (e.g., presented on board the vehicle, at the image capture/code reader device 614, and/or at a mobile telephone, a smartphone, or a PCD of the registered owner of vehicle), or a combination thereof. For example, the process of providing information including a parking meter start time and an association between the parking meter and an account can be initiated by scanning or capturing an image of the code 620 presented at the external display area 608. In this example, the image capture/code reader device 614 captures an image of the code 620 and reads and/or decodes the captured image to establish the parking meter start time which is communicated to the parking meter 601 and/or the processing center 610 along with other information (e.g., stored on board or accessible to the image capture/code reader device 614) that can be used to establish the association between the parking meter and an account (e.g., an account associated with the owner of the image capture/code reader device 614). The association between the parking meter 601 and an account can be established at the parking meter start time or at another time. In an example embodiment, both the parking meter start and stop times are established utilizing the code 620 (e.g., by capturing an image of the code 620, reading and/or decoding the captured image, and communicating information including the start and stop times to the parking meter 601 and/or the processing center 610. In an example embodiment, the parking meter 601 is configured to establish the stop time utilizing an alternative code (e.g., provided to a person authenticated as being associated with the account and/or with a vehicle associated with the account). This accommodates a circumstance (occurring, for example, at a parking lot or parking garage) in which the driver has lost or cannot locate the image capture/code reader device 614, in response to which an attendant can provide the driver with an alternative code that the driver can use (e.g., keyed in or otherwise provided as an input at the display 602) to establish the parking meter stop time.

In an example embodiment, the parking meter 601 includes an interactive user interface, a graphical user interface, or display configured to provide a visual representation of one or more of, for example: an acknowledgement that the association, the start time and/or the stop time has been established, a prompt or request for additional information or user inputs (e.g., to associate a new/different/valid account with the generated code, to renew registration/license/insurance, to authorize transfer of funds for renewal of driver's license/vehicle registration/automobile insurance), information and/or instructions (e.g., hours when the parking space can be used, maximum amount of time permitted to park in the space/lot, how to obtain an alternative code if an authorized image capture/code reader device is lost, misplaced, or inoperative), a notification (e.g., a message notifying a person who has been in California for 20 days that they need to register their vehicle if they now reside in California), and a warning (e.g., a text message, such as: “When you were driving in [town, street] on [day] at approximately [time], you were traveling at an excessive speed. This is a courtesy warning. Next time, you will receive a citation and fine, and possibly additional penalties, impounding of your vehicle, and/or suspension or revocation of your driver's license as may be appropriate or required under the law.”)

In an example embodiment, the parking meter 601 (and/or a remote processing location/center in communication with the parking meter) is configured to access supplemental information identifying and/or in relation to a vehicle, person, entity and/or object associated with the account. In another example embodiment, the parking meter 601 (and/or a remote processing location/center in communication with the parking meter) is configured to provide or facilitate access to the supplemental information, parking meter usage information, and/or notifications relating to said information by one or more of, for example: an owner, an operator, or a vendor of the parking meter, a maintenance or service company, authorized operators and users of a system for monitoring and managing transportation infrastructure and locations of vehicles therein, a law enforcement agency, a parking enforcement agency, a government agency, a company or other private-sector entity or organization, a lienholder, an insurance company, authorized or approved individuals or groups, an owner or a registered owner of the vehicle, and a person or persons authorized or approved by the owner and/or the registered owner of the vehicle.

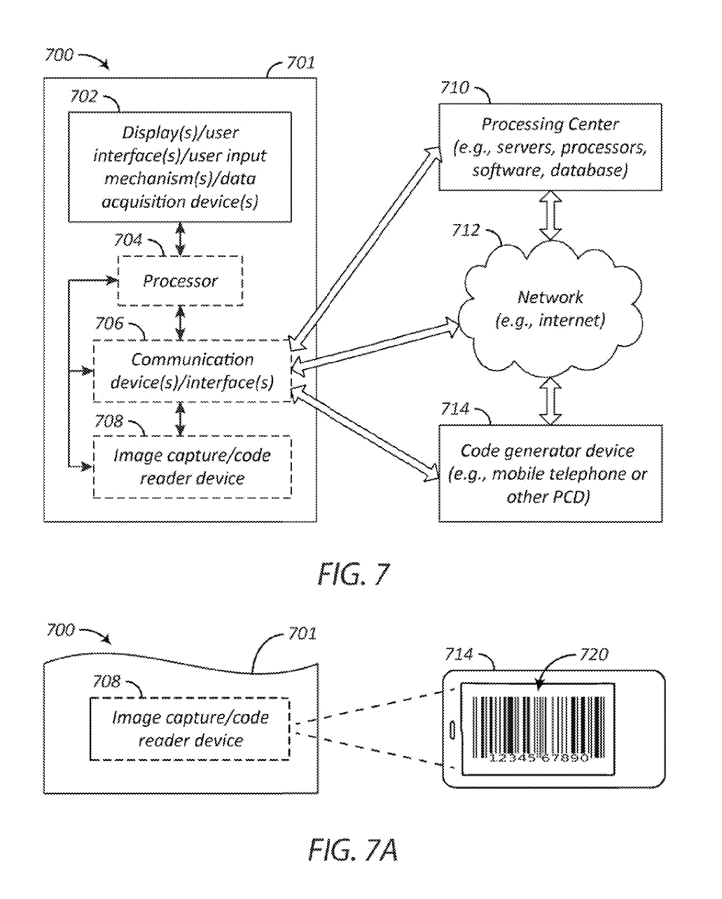

FIG. 7 shows another example apparatus 700 for monitoring and managing usage of a parking space. In an example embodiment, the apparatus 700 includes a parking meter 701 that facilitates providing information including a parking meter start time, a parking meter stop time, and an association between the parking meter and an account, and initiates or requests a transaction in which the account is charged (or debited) depending upon an amount of time passing between the start time and the stop time.

In an example embodiment, the association is between a uniquely identified parking meter and an account and is established utilizing a code. In an example embodiment, the association is established by a device that captures an image of the code and is configured with or utilizes or accesses code reader software that processes the image to read the code.

Referring again to FIG. 7, the parking meter 701 includes display(s)/user interface(s)/user input mechanism(s)/data acquisition device(s) 702, a processor 704, communication device(s)/interface(s) 706, and an image capture/code reader device 708 configured as shown. In this example embodiment, the association is established utilizing a code provided on or generated by a code generator device. To this end, and referring also to FIG. 7A, a code generator device 714 (e.g., a mobile telephone, a smartphone, or a PCD) is utilized to generate an image of a code 720 (which is depicted, in this example, as a bar code). In this example embodiment, the code generator device 714 is configured with (or utilizes or accesses) code generator software to generate the code 720 (e.g., presented at a display of a mobile telephone, a smartphone, or a PCD).

The code 720 can be provided in the form of numbers, letters, characters, symbols, and/or other indicia, whether visible or otherwise (e.g., code that is not revealed by visible light, but rather by infrared). The code 720 can be human-readable, machine-readable, or both. In an example embodiment, the code 720 includes information (e.g., VIN) that uniquely identifies a vehicle.

The image capture/code reader device 708 can be provided, for example, in the form of a digital camera or other image capture device (of the parking meter 701) and code reader software run by (and/or utilized or accessible to) the processor 704. In an example embodiment, the processor 704 processes the image captured by the image capture/code reader device 708 to read the code 720. Various software programs/products suitable for reading and/or decoding images of code captured by digital cameras or other image capture devices are commercially available.

In this example embodiment, the communication device(s)/interface(s) 706 is configured to communicate with a processing center 710 (e.g., implemented in the form of servers, processors, or the like operating under the control of software and/or other sources of commands or inputs) directly and/or via a network 712 (e.g., the internet). In an example embodiment, the parking meter 701 is configured to transmit or initiate a process of providing a communication to a device (e.g., the code generator device 714) that generates an image of the code 720. The communication can be provided directly from the parking meter 701 (e.g., generated by the processor 704), or from a remote processing location or center (e.g., in response to information provided to the processing center 710 by the parking meter 701). In an example embodiment, the communication includes a resource (e.g., URL) or other information that provides a user of the device with access to a receipt (e.g., PDF file/image) or other documentation or information relating to a transaction involving and/or usage of the parking meter.

In operation, the image capture/code reader device 708 is used to capture an image of the code 720 presented at a display of the code generator device 714. In an example embodiment, the process of providing information including a parking meter start time, a parking meter stop time, and an association between the parking meter and an account can be performed utilizing the processor-controlled display 702 (at the parking meter 701), a user interface or other input mechanism separate from the parking meter 701 (e.g., presented on board the vehicle, at the code generator device 714, and/or at a mobile communications device or PCD of the registered owner of vehicle), or a combination thereof. For example, the process of providing information including a parking meter start time and an association between the parking meter and an account can be initiated by scanning or capturing an image of the code 720 presented at a display of the code generator device 714. In this example, the image capture/code reader device 708 captures an image of the code 720 and reads and/or decodes the captured image to establish the parking meter start time which is communicated to the processor 704 (of parking meter 701) and/or the processing center 710 along with other information (e.g., provided by the code generator device 714) that can be used to establish the association between the parking meter and an account (e.g., an account associated with the owner of the code generator device 714). The association between the parking meter 701 and an account can be established at the parking meter start time or at another time. In an example embodiment, both the parking meter start and stop times are established utilizing the code 720 (e.g., by capturing an image of the code 720, reading and/or decoding the captured image, and communicating information including the start and stop times to the processor 704 (of parking meter 701) and/or the processing center 710. In an example embodiment, the parking meter 701 is configured to establish the stop time utilizing an alternative code (e.g., provided to a person authenticated as being associated with the account and/or with a vehicle associated with the account). This accommodates a circumstance (occurring, for example, at a parking lot or parking garage) in which the driver has lost or cannot locate the code generator device 714, in response to which an attendant can provide the driver with an alternative code (e.g., a printed image of the alternative code) that the driver can use (e.g., present the alternative code to the image capture/code reader device 708) to establish the parking meter stop time. In an example embodiment, a vending machine, a kiosk, or other publicly accessible interface, console, or station (e.g., that monitors and/or manages the metering of multiple parking spaces) is configured to allow a driver or other person to initiate or submit a request to be provided with an alternative code.

In an example embodiment, the parking meter 701 includes an interactive user interface, a graphical user interface, or display configured to provide a visual representation of one or more of, for example: an acknowledgement that the association, the start time and/or the stop time has been established, a prompt or request for additional information or user inputs (e.g., to associate a new/different/valid account with the generated code, to renew registration/license/insurance, to authorize transfer of funds for renewal of driver's license/vehicle registration/automobile insurance), information and/or instructions (e.g., hours when the parking space can be used, maximum amount of time permitted to park in the space/lot, how to obtain an alternative code if an authorized code generator device is lost, misplaced, or inoperative), a notification (e.g., a message notifying a person who has been in California for 20 days that they need to register their vehicle if they now reside in California), and a warning (e.g., a text message, such as: “When you were driving in [town, street] on [day] at approximately [time], you were traveling at an excessive speed. This is a courtesy warning. Next time, you will receive a citation and fine, and possibly additional penalties, impounding of your vehicle, and/or suspension or revocation of your driver's license as may be appropriate or required under the law.”)

In an example embodiment, the parking meter 701 (and/or a remote processing location/center in communication with the parking meter) is configured to access supplemental information identifying and/or in relation to a vehicle, person, entity and/or object associated with the account. In another example embodiment, the parking meter 701 (and/or a remote processing location/center in communication with the parking meter) is configured to provide or facilitate access to the supplemental information, parking meter usage information, and/or notifications relating to said information by one or more of, for example: an owner, an operator, or a vendor of the parking meter, a maintenance or service company, authorized operators and users of a system for monitoring and managing transportation infrastructure and locations of vehicles therein, a law enforcement agency, a parking enforcement agency, a government agency, a company or other private-sector entity or organization, a lienholder, an insurance company, authorized or approved individuals or groups, an owner or a registered owner of the vehicle, and a person or persons authorized or approved by the owner and/or the registered owner of the vehicle.

In an example “Parking Meter Digital Registration” technology and/or methodology, parking meters are provided with a code and/or a code generating device. In this example, a driver of a vehicle uses an image capture/code reader device such as a mobile telephone, a smartphone, or a PCD configured with a camera and with code reader software (and/or configured to utilize or access code reader software) to scan or capture an image of the code in order to activate the parking meter and/or establish a parking meter start time. Upon return, the driver can scan or image the code again and initiate and/or authorize a process of paying a parking fee for the duration of the time the vehicle has been parked. For example, the payment is automatically deducted from an account which has been previously set up or charged to a credit card.

In another example “Parking Meter Digital Registration” technology and/or methodology, parking meters are provided with an image capture/code reader device. In this example, a driver of a vehicle uses a code generator device such as a mobile telephone, a smartphone, or a PCD configured with a display and with code generator software (and/or configured to utilize or access code generator software) to generate an image of the code, which is read by the parking meter in order to activate the parking meter and/or establish a parking meter start time. Upon return, the image capture/code reader device (of the parking meter) is used to scan or image the code again and initiate and/or authorize a process of paying a parking fee for the duration of the time the vehicle has been parked. For example, the payment is automatically deducted from an account which has been previously set up or charged to a credit card.

In either case, a driver no longer has to have ready access to coins in order to pay for parking and avoids the unfortunate and all-too-frequent necessity of having to return to “feed” the parking meter. In an example embodiment, information identifying the parking meter and/or parking space is synchronized or associated with information pertaining to the vehicle and/or the driver. For example, information obtained from the driver's mobile telephone, smartphone, or PCD (e.g., during the process of activating the parking meter) is utilized to access the VIN of the vehicle from a database. In an example embodiment, an account (e.g., an account associated with the VIN) is automatically charged the parking fee. In an example embodiment, the parking fee is charged, debited, or billed to an account associated with, for example: an identified vehicle (e.g., identified by VIN), a mobile telephone, a smartphone, a PCD, an image capture device, a code reader device (e.g., a bar code scanner/reader), a code generator device, or other data input mechanism (e.g., that facilitates providing a code to a parking meter or an image capture/code reader device).

By way of further example, a registered owner of a vehicle is associated with an account that is linked to a credit card and/or allowed or required to maintain a deposit account in order to have credit available from which parking fees can be drawn (e.g., in association with a particular VIN). When a vehicle is parked in a specific parking space, then, without depositing coins, based upon the duration of use, an account is charged by a computer system. In this manner, the account (e.g., associated with the VIN) is only charged for the time of use while parked. As a consequence, parking fees are determined and charged with greater precision representing an advantage for drivers as compared to the current system where most people leave their parking space with unused time left on a meter. In an example embodiment, if the account to be charged lacks sufficient funds to pay a parking fee, a computer (or processing center of the like) can be programmed to automatically initiate a process of transmitting a citation and/or bill, by e-mail and/or mail, to the registered owner.

In an example embodiment, the VIN is transmitted and/or detected, and a computer program is used to identify when a particular vehicle is parked for more than an allowable period of time at a parking space and to automatically issue a citation to the registered owner. For example, a citation can be issued for a car parked in public streets with an expired registration. In another example, a citation is issued to someone associated with a vehicle parked in a no-parking zone or a red-zone. Due to the relatively small number of parking enforcement officers as compared to the number of vehicles (in a typical city or town), an accurate and substantially completely automated citation system can significantly increase parking revenues generated and can also eliminate or reduce the need for parking enforcement officers.

FIG. 8 shows an example implementation of a method 800 for monitoring and managing usage of a parking space. At 802, information is accessed, namely, information that includes a parking meter start time, a parking meter stop time, and an association between the parking meter and an account, the information resulting from a process of reading a code, the code identifying or being associated with one of the parking meter and the account. In an example embodiment, the association is between a uniquely identified parking meter and an account. In an example embodiment, the association is established at a parking meter start time. In an example embodiment, the process of reading a code includes reading the code two times or reading code at two different times (e.g., at a parking meter start time and at a parking meter stop time).

In example embodiments, signals transmitted from a parking meter and/or a vehicle are received (e.g., and referring also to FIGS. 1, 6, and 7, by one or more of, for example: a network, satellites, one or more processing centers, one or more system interfacing elements, one or more image capture/code reader devices, and one or more code generator devices. The signals can include information relating to (e.g., identifying) one or more of, for example: the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle. In an example embodiment, the signals are received over an interval of time.

At 804, a process of charging the account depending upon an amount of time passing between the parking meter start and stop times is facilitated or initiated. In an example embodiment, the signals and/or information can be processed to identify in association with the vehicle a circumstance that satisfies (predetermined or other) criteria. The signals and/or information are processed, for example, by one or more processing centers and/or one or more of the system interfacing elements (e.g., operators, users, and/or devices involved in or facilitating a system for monitoring and managing transportation infrastructure and locations of vehicles therein). In example embodiments, the signals and/or information are processed at least in part by participatory elements 808. By way of example, the participatory elements 808 include one or more of: a state, a county, a city, a town, a municipality, a court, a government agency, a law enforcement agency, a department of motor vehicles, a parking and/or traffic enforcement agency, a company or other private-sector entity or organization, authorized operators and users of a system for monitoring and managing transportation infrastructure and locations of vehicles therein, an individual or a group, a person or an entity authorized or approved to receive or collect funds, an owner or a registered owner of the vehicle, a person or persons authorized or approved by the owner and/or the registered owner of the vehicle, a lienholder, an insurance company, an authorized or approved source or device, a processor or controller, a biometric data acquisition device, a user-input mechanism, an RFID transmitter, a camera, a code reader, and a parking meter. In example embodiments, information, data, and/or programs stored in one or more database(s) 806 is utilized in processing the signals and/or information. The database(s) 806 include one or more of, for example, a law enforcement database, a DMV database, an insurance database, and a lienholder database. It should be understood that the database(s) 806 can include additional database(s) pertaining, for example, to other types of information and/or data as described herein.

Example methodologies and technologies described herein present, or facilitate a presentation of, visual representations pertaining to a vehicle, a circumstance, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle, information, and/or notifications. Example implementations utilize a network and/or communications links and one or more interfaces and/or displays are to present the visual representations. The circumstances include, by way of example, one of more of the previously discussed circumstances, the discussion of which is incorporated herein by reference.

At 810, an action or a process is facilitated, controlled, or initiated (e.g., by one or more of the participatory elements 808). The action or process involves presenting a visual representation of one or more of, for example: an acknowledgement that the association, the start time and/or the stop time has been established, a prompt or request for additional information or user inputs, information and/or instructions, a notification, and a warning. In an example embodiment, a method for monitoring and managing usage of a parking space includes facilitating or initiating a process of presenting (e.g., at an interactive user interface, a graphical user interface, or a display) a visual representation of one or more of, for example, an acknowledgement that the association, the start time and/or the stop time has been established, a prompt or request for additional information or user inputs (e.g., to associate a new/different/valid account with the generated code, to renew registration/license/insurance, to authorize transfer of funds for renewal of driver's license/vehicle registration/automobile insurance), information and/or instructions (e.g., hours when the parking space can be used, maximum amount of time permitted to park in the space/lot, how to obtain an alternative code if an authorized image capture/code reader device or code generator device is lost, misplaced, or inoperative), a notification (e.g., a message notifying a person who has been in California for 20 days that they need to register their vehicle if they now reside in California), and a warning (e.g., a text message, such as: “When you were driving in [town, street] on [day] at approximately [time], you were traveling at an excessive speed. This is a courtesy warning. Next time, you will receive a citation and fine, and possibly additional penalties, impounding of your vehicle, and/or suspension or revocation of your driver's license as may be appropriate or required under the law.”). In an example embodiment, the process can also include processing the signals and/or the information to identify in association with the parking meter and/or the vehicle a circumstance that satisfies criteria for facilitating, controlling, or initiating an action or a process involving one or more of providing information, providing a notification, transferring funds, and issuing a ticket, a citation, a bill, an invoice, a warning, or other communication.

At 812, a visual representation is presented (e.g., to one or more of the participatory elements 808). By way of example, the visual representation presented is a visual representation of one or more of: the parking meter, a mobile telephone or other PCD, a device that generates the code, a device that reads the code, a device, interface, or display that is separate from the parking meter (e.g., a workstation, interface, vending machine, kiosk), and a device, interface, or display that is remotely located in relation to the parking meter (e.g., a processing/monitoring center, facility, or station).

An example method for monitoring and managing usage of a parking space further includes providing, facilitating, or initiating a communication that includes a resource (e.g., URL) or other information that provides access to a receipt (e.g., PDF file/image) or other documentation or information relating to a charge to the account and/or usage of the parking meter.

An example method for monitoring and managing usage of a parking space further includes accessing, or facilitating or initiating a process of providing access to, supplemental information pertaining to one or more of a vehicle, a person, an entity, and an object associated with the account. In an example embodiment, the method for monitoring and managing usage of a parking space further includes accessing, or facilitating or initiating a process of providing access to, the supplemental information, parking meter usage information, and/or notifications relating to said information by one or more of, for example: an owner, an operator, or a vendor of the parking meter, a maintenance or service company, authorized operators and users of a system for monitoring and managing transportation infrastructure and locations of vehicles therein, a law enforcement agency, a parking enforcement agency, a government agency, a company or other private-sector entity or organization, a lienholder, an insurance company, authorized or approved individuals or groups, an owner or a registered owner of the vehicle, and a person or persons authorized or approved by the owner and/or the registered owner of the vehicle.

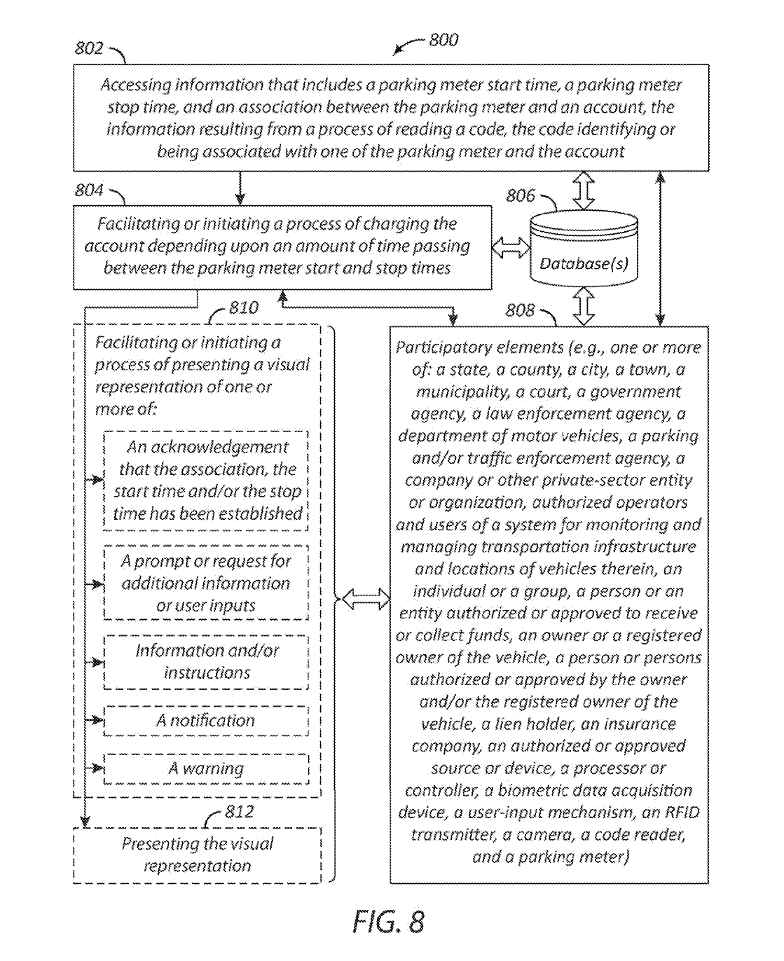

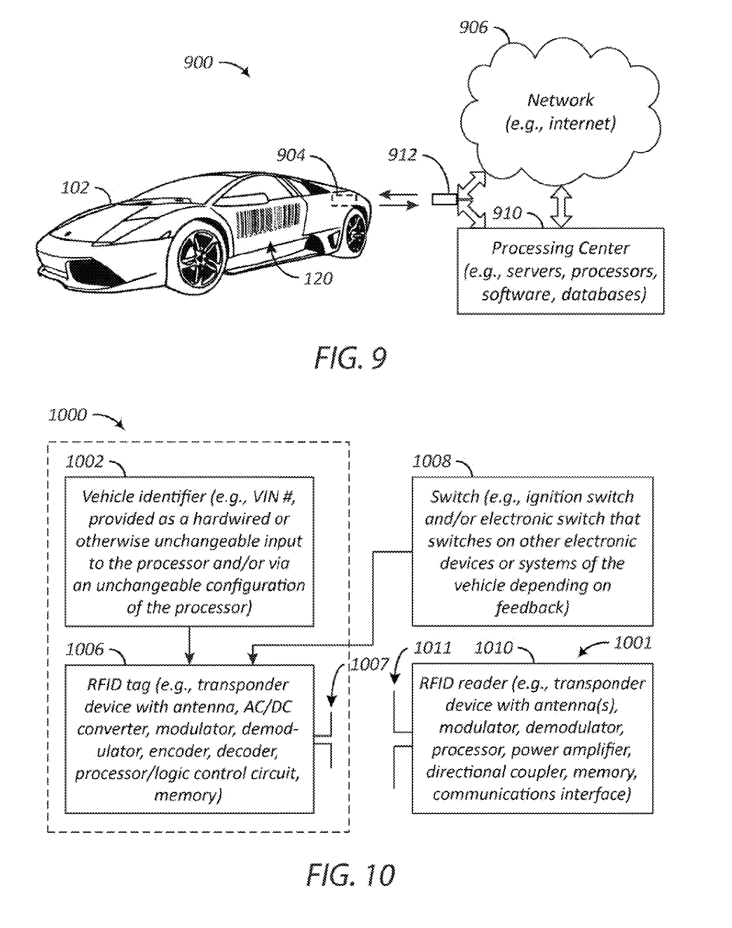

FIG. 9 shows an example implementation of a system 900 for monitoring, managing, and facilitating transactions involving vehicles. In this example implementation, a vehicle 102 is equipped with an electronic device 904 (shown in dashed lines) configured to communicate with a network 906 (e.g., the internet) via another electronic device 912. In an example implementation, the network 906 is also utilized to facilitate communications links between a processing center 910 (e.g., implemented in the form of servers, processors, or the like operating under the control of software and/or other sources of commands or inputs) and the electronic device 912.

In an example embodiment, the electronic device 904 includes a transponder or transmitter that generates or transmits signals that identify a vehicle equipped with the electronic device 904, and the electronic device 912 includes a receiver (e.g., a transponder or transceiver) configured to receive the signals. The electronic devices 904 and 912 are provided, for example, in the form of a RFID tag and a RFID reader, respectively.

In example embodiments, the electronic device 904 additionally includes, and/or is configured to interface with, electronics (or components thereof) such as previously described in relation to the electronic tracking device 104. The electronic device 904 can include, for example, a Global Positioning System (GPS) tracking device or unit (e.g., a GPS module configured to receive GPS signals from the satellites 108a, 108b, and 108c and calculate coordinates) and a modem or other communications device configured to transmit location and telemetry input data. Thus, in example embodiments, the electronic device 904 includes a GPS tracking device or unit. In example embodiments, the electronic device 904 includes, and/or is configured to interface with, electronics (or components thereof) such as previously described in relation to the communications device(s) 204, the input/output (I/O)/interface control device(s) 208, the transmitter(s) 210, the data acquisition device(s) 212, and the user interface(s) and/or other input mechanism(s) 214. Thus, in example embodiments, the electronic device 904 is configured to facilitate communications and/or interfacing elements, such as previously described in relation to the system interfacing elements 112 (e.g., authorized or approved system service providers, information providers/sources, participants, devices, users, partners, and/or subscribers). In example embodiments, the network 906 is additionally utilized to facilitate communications links between the electronic device 904 and one or more of the processing center 910 and the aforementioned system interfacing elements. Thus, in example embodiments, the electronic device 912 is a system interfacing element of the electronic device 904 and/or vice versa.

Referring to FIG. 10, example electronic devices 1000 and 1001 (suitable for the system 900 for monitoring, managing, and facilitating transactions involving vehicles) are shown. In example embodiments, the electronic devices 1000 and 1001 each include one or more electronic devices. In the example embodiments depicted in FIG. 10, the electronic device 1000 includes a RFID tag 1006 with an antenna 1007 (e.g., a dipole antenna) and a vehicle identifier 1002, which provides an input to the RFID tag 1006. In this example embodiment, the electronic device 1000 also includes or is operatively connected to a switch 1008 (e.g., for providing an additional input to the RFID tag 1006). The electronic device 1001 includes an RFID reader 1010 with an antenna 1011 (e.g., a dipole antenna). The vehicle identifier 1002 can be, for example, the VIN of the vehicle equipped with the electronic device 1000 or other numbers, letters, characters, symbols, codes, or the like, whether human-readable, machine-readable, or both. In an example embodiment, the vehicle identifier 1002 includes, represents, and/or provides vehicle identification information that uniquely identifies the vehicle equipped with the electronic device 1000. In an example embodiment, the electronic device 1000 is configured such that the vehicle identification information cannot be changed or prevented from being transmitted or generated during normal operation of the electronic device. By way of example, the vehicle identifier 1002 is implemented/provided as a hardwired or otherwise unchangeable input to the RFID tag 1006 and/or via an unchangeable configuration of the RFID tag 1006. Moreover, in an example embodiment, the electronic device 1000 is configured such that an attempt to change, modify, damage, make unauthorized alterations to, or otherwise tamper with the vehicle identifier 1002 and/or RFID tag 1006 results in an alert or alarm being generated, e.g., transmitted by one or more communications devices of the electronic device 1000 (such as the previously described communications device(s) 204). In various example embodiments, the electronic device 1000 includes a communications device facilitating one or more of cellular, radio and satellite communications.

The RFID tag 1006 includes or is implemented utilizing, for example, a transponder device with an antenna, an AC/DC converter, a modulator, a demodulator, an encoder, a decoder, a processor/logic control circuit, and memory. The RFID reader 1010 includes or is implemented utilizing, for example, a transponder device with antenna(s), a modulator, a demodulator, a processor, a power amplifier, a directional coupler, memory, and a communications interface. In an example embodiment, the RFID reader 1010 is configured as an interrogator, e.g., emits RF carrier signals (continuously or otherwise) and observes received RF signals for data. In the presence of the RFID tag 1006, signals emitted by the RFID reader 1010 are modulated by the RFID tag 1006, and the modulated signals are detected by the RFID reader 1010. In this example, the RFID reader 1010 demodulates the signals received from the RFID tag 1006 and decodes the demodulated signals. Backscatter modulation is utilized, by way of example, to modulate data onto the RF carrier with the RFID reader 1010 detecting changes in the RF carrier amplitude and recovering the data (e.g., code).

In example embodiments, the RFID tag 1006 is only powered when it is in the beam of the interrogator. In example embodiments, the RFID tag 1006 is powered by a battery or other power source (e.g., the vehicle battery), which in some circumstances potentially improves range. The RFID tag 1006 and the RFID reader 1010 can be configured to utilize transponder-driven and/or other communications protocols, various implementations of such protocols being known to one of ordinary skill in the art.

In an example embodiment, the vehicle is equipped with a switch (such as, for example, the switch 1008), and the signals are generated or transmitted depending upon a position, state, or output of the switch. By way of example, the switch 1008 can be an ignition switch and/or an electronic switch that switches on (e.g., applies power to) other electronic devices or systems of the vehicle depending on feedback (e.g., from the ignition lock cylinder of the vehicle). The switch 1008 can be a mechanical switch configured, for example, to be accessible from inside the vehicle (e.g., located inside the glove compartment, or at a hidden and/or selectively publicized location). Alternatively, the switch 1008 can be located at an exterior portion of the vehicle, such as the wheel well, or within the engine compartment or trunk.

The switch 1008, configured for providing an additional input to the RFID tag 1006, can be used to accommodate, facilitate, select, and/or initiate different modes of operation. For example, the electronic device 1000 can be selectively configured, depending upon whether the vehicle is running, to operate in either a “passive tag” mode (e.g., in which the RFID tag 1006 is only powered when it is in the beam of the interrogator) or an “active tag” mode (e.g., in which the RFID tag 1006 is powered by a battery or other power source). In an example embodiment, the signals are generated or transmitted only when the motor is running. In an example embodiment, the signals are generated or transmitted only when the motor is running and in response to a transmit command (e.g., provided by the driver or other person in the vehicle). The transmit command (and other commands and/or inputs as well) can be communicated to the electronic device 1000 via a signal received from another electronic device, or provided by another source or device. In an example embodiment, the signals are generated or transmitted independent of whether the motor is running

In an example embodiment, the electronic device 1000 includes, or is operatively connected to, circuitry for enabling and/or disabling the RFID tag 1006. The aforementioned circuitry can include the switch 1008 and/or is configured to be controllable by the switch 1008 or by one or more other inputs and/or commands.

Mode selection inputs (as well as other inputs and/or commands) can be provided via an input/output (I/O)/interface control device of the electronic device 1000, such as previously described in relation to the input/output (I/O)/interface control device(s) 208. Mode selection inputs (as well as other inputs and/or commands) can be provided remotely, e.g., utilizing a wireless communications device.

In example embodiments, the RFID tag 1006 selectively utilizes a mode or protocol (e.g., a transponder-driven protocol) depending, for example, upon the switch 1008 and/or one or more inputs and/or commands provided via an input/output (I/O)/interface control device.

In example systems, apparatuses, and methods described herein, the electronic device is selectively controllable for generating or transmitting the signals in multiple different operating modes. In an example embodiment, the electronic device 1000 receives a mode selection input (provided, for example, by the switch 1008, or via an input/output (I/O)/interface control device).

The RFID tag 1006 and the RFID reader 1010 can be configured to utilize far-field RFID technologies in which, for example, the RFID tag 1006 is read at a location beyond (outside) the range of the near-field of the RFID reader 1010. Backscatter modulation can be utilized in such implementations. Dimensions and/or impedances of the antennas 1007 and 1011 can be adjusted to tune to a particular frequency, control how much of the energy is reflected back (e.g., from the RFID tag 1006 toward the RFID reader 1010), and/or vary an amount of energy reflected back (e.g., to encode information provided by the RFID tag 1006).

The RFID tag 1006 and the RFID reader 1010 can be configured to utilize near-field RFID technologies in which, for example, the antenna 1007 of the RFID tag 1006 is located in the near-field of the antenna 1011 of the RFID reader 1010. For example, ultra high frequency (UHF) near-field radio frequency identification (RFID) devices can be utilized.

The terms “far-field” and “near-field” refer to regions, in relation to an antenna, in which a particular field effect (or combinations of field effects) is the dominant interaction that characterizes field behavior of the antenna within that particular region. The term “far-field” refers, for example, to a region (e.g., that extends from approximately two wavelengths distance from the antenna to infinity) in which the field of the antenna acts as “normal” electromagnetic radiation, the power of which decreases as the square of distance from the antenna. The term “near-field” refers, for example, to a region (e.g., within approximately one wavelength distance from the antenna) in which there are strong inductive and capacitative effects, which decrease in power more quickly with distance as compared to far-field radiation power. In the transition zone between these regions, both near- and far-field effects influence field behavior.

The RFID tag 1006 and the RFID reader 1010 can be configured as “hybrid devices”, for example, to utilize both far-field RFID and near-field RFID technologies. In an example embodiment, the switch 1008 is configured in conjunction with a user input mechanism (e.g., a button on the steering column or dash of the vehicle, a touch screen, or a voice recognition device) to allow a driver and/or passenger to select an account that is to be charged or debited in connection with a transaction involving a vehicle. For example, a primary or default account (e.g., a corporate or business account associated with the vehicle) is charged, unless an input is provided via the switch 1008 to designate an alternative account. In an example embodiment, an alternative account (such as a personal account, a new account, or an account not previously associated with transactions involving the vehicle) is recognized in real time, or “on-the-fly”, by reading additional information from the RFID tag 1006 and/or from another tag, such as a near-field communication (NFC) device located in or on the vehicle, or carried by a person (e.g., the driver of the vehicle).

In various example embodiments, one or both of the electronic devices 1000 and 1001 is configured to read a NFC device (e.g., which operates at 13.56 MHz on ISO/IEC 18000-3 air interface and at rates ranging from 106 kbit/s to 848 kbit/s and typically requires a distance of 4 cm or less between the NFC tag and reader). For example, the RFID reader 1010 (e.g., a NFC device located at an entrance/exit of a parking garage, or implemented in the form of a NFC-enabled handset, mobile telephone, or PCD) is utilized to read credit card and/or account information stored on another NFC device (e.g., a NFC tag, or a NFC-enabled electronic device, such as a smartphone running Google Wallet or another NFC-based application). In another example embodiment, the RFID tag 1006 includes or is operatively connected to a NFC reader device or an NFC-enabled handset, mobile telephone, or PCD, which is utilized to read the credit card and/or account information. In this example, the electronic device 1000, and/or a communications device operatively connected thereto, transmits or otherwise provides the credit card and/or account information to the electronic device 1001 and/or a processing center.

Additional examples of operating modes include, but are not limited to, a “disabled mode”, a “passive mode”, an “active mode”, a “far-field mode”, a “near-field mode”, and various combinations thereof. By way of example, in the “disabled mode”, the electronic device is prevented from transmitting signals. For example, if a vehicle is being towed or transported along a route that includes a toll road, the driver of the tow truck or transport vehicle can temporarily disable the electronic device equipped to the vehicle. In the “passive mode”, an electronic device that is capable of functioning, for example, as either an active device or a passive device is reconfigured such that it operates as a passive device. In the “active mode”, an electronic device that is capable of functioning, for example, as either an active device or a passive device is reconfigured such that it operates as an active device. The afore-described selectability between modes of operation that differ in their power requirements allows a driver, for example, to “boost” the signal level in environments or conditions that make reception difficult. In another example, the operator of a vessel transporting multiple vehicles equipped with electronic devices as described herein can temporarily activate (e.g., via wireless transmission of commands) the electronic devices to establish start times associated with the respective transactions of transporting each of the vehicles. In the far-field mode”, an electronic device that is capable of functioning, for example, as either a far-field device or a near-field device is reconfigured such that it operates as a far-field device. In the “near-field mode”, an electronic device that is capable of functioning, for example, as either a far-field device or a near-field device is reconfigured such that it operates as a near-field device. The afore-described selectability between modes of operation that differ in their range and/or utilize different electronic devices (e.g., of the apparatus) allows a driver, for example, to turn off the far field device after exiting a toll road and subsequently use a near-field device (e.g., the driver's NFC-enabled smartphone) to establish a start time when entering a parking structure.

Additional examples of operating modes involve migrating and/or sharing a process of generating, transmitting, and/or reading code (e.g., code identifying the vehicle). In an example “auxiliary device” mode, the electronic device (e.g., the electronic device 1000 and/or the electronic device 1001) communicates, for example, with an auxiliary device and provides the auxiliary device with information and/or data such as code identifying the vehicle. The auxiliary device, in turn, utilizes the information and/or data to generate or transmit the code. In example embodiments, the auxiliary device is, includes, or is provided via a NFC-enabled electronic device, such as a smartphone or PCD (e.g., of the driver or a passenger in the vehicle) that is configured with and/or provided with access to a NFC-based application (such as Google Wallet). In an example “auxiliary device” mode, the auxiliary device is provided with code identifying the vehicle and utilizes a NFC-based application to generate the code in response to the auxiliary device being positioned sufficiently close to a NFC code reader device (e.g., at an entrance or exit of a parking facility). In an example embodiment, the code is provided on a temporary basis, for example, the information and/or data includes instructions to the NFC-based application limiting the amount of time that the driver has to establish a start or stop time for a parking transaction involving the vehicle. Moreover, in an example embodiment, the information and/or data provides that the code automatically expires and/or is permanently deleted from the auxiliary device within an amount of time (e.g., a time limit) after the auxiliary device is provided with the code and authorized to use it in relation to a transaction involving the vehicle. In another example “auxiliary device” mode, the electronic device (e.g., the electronic device 1000 and/or the electronic device 1001) communicates indirectly with the auxiliary device (e.g., via one or more of the network 906 and the processing center 910). In another example “auxiliary device” mode, a source or device other than the electronic devices 1000 and 1001 (e.g., the processing center 910) communicates with the auxiliary device (e.g., a NFC-enabled smartphone) to provide the auxiliary device with the information and/or data (e.g., including and/or providing access to code identifying the vehicle).

In example embodiments, the electronic device 1001 includes multiple reader devices. In the case of a transportation infrastructure (e.g., a toll road), reader devices are located, for example, at the entrances and exits of the transportation infrastructure and/or provided in the form of hand-held reader devices that can be used by operators, employees, or service or other personnel of the transportation infrastructure (e.g., toll both attendants). In the case of a parking facility (e.g., a parking garage or parking lot), reader devices are located, for example, at the entrance(s) and exit(s) of the parking facility/lot and/or provided in the form of hand-held reader devices that can be used by operators, employees, or service or other personnel of the parking facility/lot (e.g., parking facility/lot attendants). In the case of a storage facility (e.g., a self storage facility), reader devices are located, for example, at entrance(s) and exit(s) of the storage facility and/or provided in the form of hand-held reader devices that can be used by operators, employees, or service or other personnel of the storage facility (e.g., storage facility attendants). In the case of an impound facility or lot (e.g., a police impound lot), reader devices are located, for example, at the entrance(s) and exit(s) of the impound facility or lot and/or provided in the form of hand-held reader devices that can be used by operators, employees, or service or other personnel of the impound facility or lot (e.g., impound facility/lot attendants). In the case of a vehicle transport vehicle (e.g., automobile transport vehicles), reader devices are located, for example, at the RO/RO entrance(s) and exit(s) of the vehicle transport vehicle and/or provided in the form of hand-held reader devices that can be used by vehicle transportation service personnel and/or the driver of the vehicle transport vehicle. In the case of a ship or other vehicle transport vessel or watercraft (e.g., cargo ship or freighter), reader devices are located, for example, at the RO/RO entrance(s) and exit(s) of the vehicle transport vehicle and/or provided in the form of hand-held reader devices that can be used by vehicle transportation service personnel and/or the crew of the ship or other vehicle transport vessel or watercraft. In the case of an airplane or other vehicle transport aircraft (e.g., cargo aircraft), reader devices are located, for example, at the RO/RO entrance(s) and exit(s) of the airplane or other vehicle transport aircraft and/or provided in the form of hand-held reader devices that can be used by vehicle transportation service personnel and/or the crew of the airplane or other vehicle transport aircraft.

In an example technology and/or methodology, a transaction start time is established (e.g., automatically established) by a reader device located at an entrance, a transaction stop time is established (e.g., automatically established) by a reader device located at an exit, and payment for the transaction (e.g., a transfer of funds determined in consideration of an amount of time passing from the start time to the stop time) is automatically deducted from an account (e.g., a credit card) associated with the transaction and/or the vehicle. Thus, the technologies and/or methodologies described herein stand to potentially eliminate prior inconveniences, such as having to stop to pay a toll road attendant or having to rush back to a parking garage prior to a time when the attendant is scheduled to leave (perhaps thereby imprisoning all vehicles in the garage until the next morning).

In example embodiments, the electronic device 1000 can operate in multiple operating modes simultaneously (e.g., utilizing multiple transponders). In example embodiments, the electronic device 1001 includes multiple reader devices (e.g., a far-field device and a near-field device).

In an example embodiment, the signals are generated or transmitted over an interval of time (e.g., whenever the motor of the vehicle is running and/or depending upon a position, state, or output of a switch or other inputs and/or commands). By way of example, the interval of time is associated with a transaction involving the vehicle and one or more of: a transportation infrastructure (e.g., a toll road), a parking facility or space (e.g., a parking garage), a storage facility or space (e.g., a self storage facility or space), an impound facility or lot (e.g., a police impound lot), a vehicle transport vehicle (e.g., automobile transport vehicles via “Roll On/Roll Off” (RO/RO)), a ship or other vehicle transport vessel or watercraft (e.g., cargo ship or freighter via RO/RO), and an airplane or other vehicle transport aircraft (e.g., cargo aircraft via RO/RO).

In an example embodiment, one or more of the signals establish a start time and/or a stop time associated with the transaction. In an example embodiment, the transaction includes charging an account (e.g., automatically charging an account) depending upon an amount of time passing between a start time and a stop time associated with the transaction.

In example systems, apparatuses, and methods described herein, one or more inputs and/or parameters for a transaction involving a vehicle are accessed, obtained, or established utilizing a signal and/or information that identifies or uniquely identifies the vehicle. By way of example, the transaction involves usage or utilization by the vehicle of, and/or custody or transportation of the vehicle by, one or more of: a transportation infrastructure (e.g., a toll road), a parking facility or space (e.g., a parking garage), a storage facility or space (e.g., a self storage facility or space), an impound facility or lot (e.g., a police impound lot), a vehicle transport vehicle (e.g., automobile transport vehicles via “Roll On/Roll Off” (RO/RO)), a ship or other vehicle transport vessel or watercraft (e.g., cargo ship or freighter via RO/RO), and an airplane or other vehicle transport aircraft (e.g., cargo aircraft via RO/RO). In example embodiments, the transaction includes charging an account associated with one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle to one or more other accounts.

In an example embodiment, an apparatus for monitoring, managing, and facilitating transactions involving a vehicle includes: an electronic device that transmits or generates signals including or in association with vehicle identification information that identifies (e.g., uniquely identifies) a vehicle equipped with the device, the signals including or providing, or facilitating or initiating a process of providing access to, one or more inputs and/or parameters for a transaction involving the vehicle (or information relating to such a transaction). In various example embodiments, the electronic device includes one or more transponders, transceivers, transmitters, receivers, ID tags, ID readers, code readers, code generators, RFID devices, NFC devices, or a combination thereof. In an example embodiment, the signals include vehicle identification information (e.g., the VIN of the vehicle). In an example embodiment, the signals include information relating to one or more of the vehicle equipped with the electronic device, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle.

Example implementations of the systems, apparatuses, and methods described herein involve generating or transmitting signals in association with a vehicle, the signals including, providing, or facilitating or initiating a process of providing one or more inputs for a transaction involving the vehicle. In another example embodiment, an apparatus for monitoring, managing, and facilitating transactions involving a vehicle includes: one or more electronic devices that facilitate providing information including one or more inputs and/or parameters for a transaction involving a vehicle, at least one of the inputs and/or parameters identifying the vehicle or being associated with or established in association with the vehicle, the one or more electronic devices including at least one device configured to initiate, request, and/or facilitate a transfer or charge from an account in relation to the transaction. In an example embodiment, the one or more electronic devices are selectively controllable for generating or transmitting the signals in multiple different operating modes.

In example embodiments, at least one of the inputs and/or parameters is established utilizing a code (e.g., data encoded on the RFID tag 1006). In example embodiments, the code includes information that uniquely identifies the vehicle. In example embodiments, the one or more electronic devices (e.g., the electronic device 1000 and/or the electronic device 1001) are configured to generate, transmit, and/or read the code. In example embodiments, the electronic device 1000 is configured (e.g., including one or more electronic devices) to generate, transmit, and/or read the code. In example embodiments, the electronic device 1001 is configured (e.g., including one or more electronic devices) to generate, transmit, and/or read the code.

In example embodiments, the inputs and/or parameters include a start time, a stop time, and an association between the vehicle and the transaction, and the one or more electronic devices (e.g., the electronic device 1000 and/or the electronic device 1001) are configured to establish one or more of the start time, the stop time, and the association. In example embodiments, the inputs and/or parameters (for the transaction involving a vehicle) include information and/or data pertaining to a circumstance, such as previously described herein, that satisfies (predetermined or other) criteria. For example, an amount charged for the transaction of driving on a toll road can be determined (e.g., amount per mile driven is adjusted) in consideration of one or more of: the time of day that the driving was done (e.g., whether during “rush hour” or “off peak” travel times) and a status of the driver (e.g., whether the driver is of a “preferred” or “special” status, such as an “experienced driver” or a “safe driver” as determined for example from DMV and/or insurance data, a veteran of a foreign war, a person with no criminal record, a diplomat, a visitor, or a designated guest of the transportation infrastructure and/or the state).

In example embodiments, the one or more electronic devices are configured to initiate, request, or facilitate a process of providing one or more communications. For example, the one or more communications are from a device that generates the signals, a device that receives the signals, and/or a remote processing location or center. The one or more communications can include a resource or other information that provides access to a receipt or other documentation or information relating to the transaction and/or usage or utilization by the vehicle of, and/or custody or transportation of the vehicle by, one or more of, for example: a transportation infrastructure, a parking facility or space, a storage facility or space, an impound facility or lot, a vehicle transport vehicle, a ship or other vehicle transport vessel or watercraft, and an airplane or other vehicle transport aircraft. In example embodiments, the one or more communications initiate, request, or facilitate a process of providing a resource or other information at a mobile telephone, a smartphone, or a PCD.

In an example embodiment, the one or more electronic devices include an interactive user interface, a graphical user interface, or display configured to provide a visual representation of one or more of, for example: an acknowledgement that a start time, a stop time, and/or an association between the vehicle and the transaction has been established, a prompt or request for additional information or user inputs (e.g., to associate a new/different/valid account with the transaction and/or vehicle, to authorize a transfer of funds in relation to the transaction), information and/or instructions (e.g., toll road rates, available credit for an account associated with the transaction, how to configure the electronic device for different modes of operation), a notification (e.g., a message notifying a person that a required input for the transaction has not been provided, failed to establish, and/or appears to be invalid or corrupted), and a warning (e.g., a text message, such as: “The account currently associated with this transaction has insufficient funds available. Please ensure that charges for your transaction are promptly paid and/or arrange for additional funds to be added to your account to avoid overdraft fees and other penalties.”). In an example embodiment, if the account to be charged lacks sufficient funds to pay for the transaction, a computer (or processing center of the like) can be programmed to automatically initiate a process of transmitting a bill or invoice, by e-mail and/or mail, to the registered owner. An account associated with a vehicle can also be associated with a vehicle registration process or procedure. Thus, in an example transaction, funds owed to a Department of Motor Vehicles or a state, for example, can be automatically transferred from the account (e.g., when payment for a registration renewal is not timely made or remains outstanding).

In an example embodiment, the one or more electronic devices are configured to access, or to initiate, request, or facilitate a process of providing access to, supplemental information identifying and/or in relation to a vehicle, person, entity and/or object associated with the account or with the transaction. In an example embodiment, the one or more electronic devices are configured to provide or facilitate access to the supplemental information, information associated with the transaction, and/or notifications relating to said information by one or more of, for example: an owner or operator of, or an authorized person or entity associated with, a transportation infrastructure, a parking facility or space, a storage facility or space, an impound facility or lot, a vehicle transport vehicle, a ship or other vehicle transport vessel or watercraft, and/or an airplane or other vehicle transport aircraft, a maintenance or service company, authorized operators and users of a system for monitoring and managing transportation infrastructure and locations of vehicles therein, a law enforcement agency, a parking enforcement agency, a government agency, a company or other private-sector entity or organization, a lienholder, a person or entity authorized or approved to repossess the vehicle, an insurance company, authorized or approved individuals or groups, an owner or a registered owner of the vehicle, and a person or persons authorized or approved by the owner and/or the registered owner of the vehicle.

In example embodiments, the processing center 910 and/or other participatory elements of a monitoring system receive or are provided with the signals and/or information (e.g., signals and/or information received over an interval of time). In example embodiments, the processing center 910 and/or other participatory elements of a monitoring system store the signals and/or information, utilize the signals and/or information to update one or more databases, and/or process the signals and/or information.

In an example embodiment, the electronic device 1000 is configured to receive and respond to interrupts and/or commands from one or more of, for example: authorized or approved sources and/or devices (e.g., law enforcement agencies, police and other authorized transmitter devices, blood alcohol sensors, one or more departments of motor vehicles, parking and/or traffic enforcement agencies, operators and users of a system for monitoring and managing transportation infrastructure and locations of vehicles therein, a person or an entity authorized or approved to receive or collect funds, an owner or a registered owner of the vehicle, a person or persons authorized or approved by the owner and/or the registered owner of the vehicle, lienholders, insurance companies, a processor or controller of or in communication with the electronic device 1000), biometric data acquisition devices, user-input mechanisms (e.g., on-board touch screen, mobile telephone, smartphone, or personal communication device (PCD) of the registered owner of the vehicle, emergency call devices), RFID devices (e.g., RFID transmitters and/or transponders), NFC devices, speed camera transmitters, and parking meters.

In example embodiments, the interrupts and/or commands facilitate, control, or initiate (e.g., in response to commands or instructions executed by the RFID tag 1006 and/or by a processor/controller accessible to and/or in communication with the electronic device 1000) one or more of, for example: modifying the information transmitted or adding additional information to the signals transmitted by the electronic device; providing information and/or notifications to authorized operators and users of a system for monitoring and managing transportation infrastructure and locations of vehicles therein; controlling an interactive user interface, a graphical user interface, or a display inside the vehicle, on a mobile communications device (e.g., a mobile telephone, a smartphone, or other PCD configured to facilitate wireless communications), and/or at a remote location to provide one or more of information, instructions, a notification, a warning, and a prompt; transferring funds from an account associated with one or more of the vehicle, an owner, a driver, a custodian, or a passenger of the vehicle, a person, an animal, an object within, secured to, or transported by the vehicle, and a person, an entity, an object, a status, a condition, an event, an indication, or an interrupt associated with the vehicle to one or more other accounts; and issuing a ticket, a citation, a bill, an invoice, a warning or other communication.

The authorized operators and users include one or more of, for example: an owner or operator of, or an authorized person or entity associated with, a transportation infrastructure (e.g., a toll road), a parking facility or space (e.g., a parking garage), a storage facility or space (e.g., a self storage facility or space), an impound facility or lot (e.g., a police impound lot), a vehicle transport vehicle (e.g., automobile transport vehicles via “Roll On/Roll Off” (RO/RO)), a ship or other vehicle transport vessel or watercraft (e.g., cargo ship or freighter via RO/RO), and/or an airplane or other vehicle transport aircraft (e.g., cargo aircraft via RO/RO), a law enforcement agency, a government agency (e.g., one or more departments of motor vehicles), a state, a county, a city, a town, or a municipality, a company or other private-sector entity or organization (e.g., a lienholder, an insurance company), an individual or a group (e.g., security guards/personnel, private investigators, deputized individuals, groups of citizens) provided with an authorized or approved device (e.g., proprietary equipment), an owner or a registered owner of the vehicle, and a person authorized or approved by the owner and/or the registered owner (e.g., family members, employees).

The one or more other accounts are associated with one or more of, for example: an owner or operator of, or an authorized person or entity associated with, a transportation infrastructure (e.g., a toll road), a parking facility or space (e.g., a parking garage), a storage facility or space (e.g., a self storage facility or space), an impound facility or lot (e.g., a police impound lot), a vehicle transport vehicle (e.g., automobile transport vehicles via “Roll On/Roll Off” (RO/RO)), a ship or other vehicle transport vessel or watercraft (e.g., cargo ship or freighter via RO/RO), and/or an airplane or other vehicle transport aircraft (e.g., cargo aircraft via RO/RO), an entity authorized or approved to receive or collect funds in relation to a parking or moving violation associated with the vehicle, a government agency, a state, a county, a city, a town, or a municipality, a court, a lienholder, and an insurance company.

The technologies and methods described herein can be implemented, by way of example, utilizing one or more websites, user interfaces, and/or applications. In an example embodiment, the processing center 910 can perform the functions of, provide, or facilitate a service host (e.g., implemented in the form of servers, processors, or the like operating under the control of software and/or other sources of commands or inputs) configured, for example, to utilize a system application or other platform to facilitate vehicle associated monitoring and/or other activities or tasks, for example, by hosting a website accessible by system participants and/or users via the network 906.

In example embodiments, technologies and methods for monitoring, managing, and facilitating transactions involving a vehicle are implemented via a website (and/or one or more other resources accessible via a network or otherwise).

In example embodiments, technologies and methods for monitoring, managing, and facilitating transactions involving a vehicle are implemented as an addition and/or an improvement to an existing website such as the official website of San Francisco FasTrak® (www.bayareafastrak.org) or E-ZPass® New York (www.e-zpassny.com). In an example embodiment, one or more interfaces are generated utilizing a custom plug-in system application which functions as an extension and overlay to an existing system application or other platform that facilitates, for example, on-line monitoring and managing of transactions involving vehicles and of accounts associated with said transactions. It should be understood that the user interfaces described herein can be implemented or provided utilizing a website, an addition and/or an improvement to an existing website, or a resource other than a website, and independent of whether the resource is directly accessible by the user. Furthermore, resources can be distributed with respect to their physical locations and can be controlled, individually or as groups (e.g., shared resources), by one or more service hosts and/or system participants.

In an example technology and/or methodology for monitoring, managing, and facilitating transactions involving a vehicle, each manufacturer of a motor vehicle is required, encouraged, and/or incentivized to install an electronic device that transmits or generates signals and/or information including vehicle identification information (e.g., the VIN of the vehicle) in response to an interrogation signal, for example, or when a field generated by an antenna associated with the electronic device electromagnetically couples with a field associated with another electronic device. For example, a DMV or other government agency can make the installation of a transmitter/transponder a requirement (e.g., a required step in the vehicle registration process) and mandatory in new vehicles as well as used vehicles.

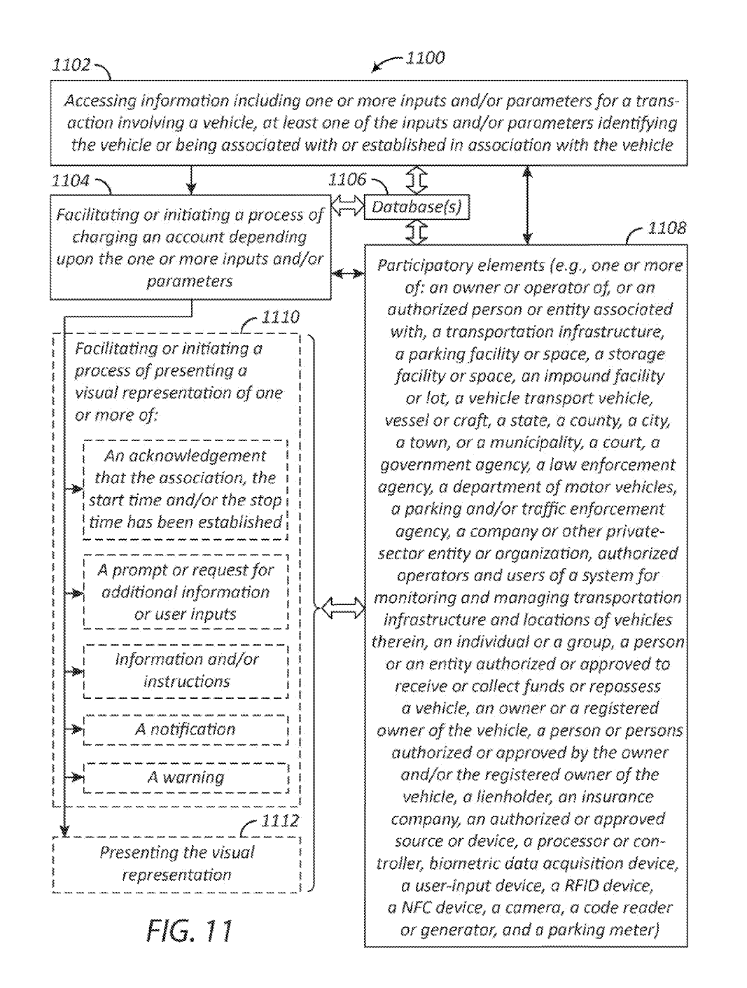

FIG. 11 shows an example implementation of a method 1100 for monitoring, managing, and facilitating transactions involving vehicles. At 1102, information is accessed, namely, information including one or more inputs and/or parameters for a transaction involving a vehicle, at least one of the inputs and/or parameters identifying the vehicle or being associated with or established in association with the vehicle.

In an example embodiment, the information includes vehicle identification information (e.g., a VIN or other information that uniquely identifies the vehicle). In an example embodiment, one or more of the inputs and/or parameters are established in association with the vehicle. In an example embodiment, the inputs and/or parameters include a start time, a stop time, and an association between the vehicle and the transaction. In an example embodiment, one or more of the vehicle identification information, the start time, the stop time, and the association (between the vehicle and the transaction) are accessed, obtained, or established from a process of reading a code (e.g., a code identifying or associated with the vehicle). In an example embodiment, the process of reading a code includes reading the code at two different times (e.g., establishing start and stop times associated with the transaction).

In example embodiments, signals transmitted or generated (e.g., by the electronic device 1000) are received (e.g., and referring also to FIGS. 1, 9, and 10, by one or more of, for example: a network, satellites, one or more processing centers, one or more system interfacing elements, one or more transponder/transceiver devices, one or more code reader devices, and one or more code generator devices. The signals can include information relating to (e.g., identifying) one or more of, for example: the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle. In an example embodiment, the signals are received over an interval of time.

At 1104, a process of charging an account depending upon the one or more inputs and/or parameters is facilitated or initiated. In an example embodiment, the signals and/or information, as previously discussed herein, can be processed to identify in association with the vehicle a circumstance that satisfies (predetermined or other) criteria. The signals and/or information are processed, for example, by one or more processing centers and/or one or more of the system interfacing elements (e.g., operators, users, and/or devices involved in or facilitating a system for monitoring and managing transportation infrastructure and locations of vehicles therein). In example embodiments, the signals and/or information are processed at least in part by participatory elements 1108. By way of example, the participatory elements 1108 include one or more of: an owner or operator of, or an authorized person or entity associated with, a transportation infrastructure, a parking facility or space, a storage facility or space, an impound facility or lot, a vehicle transport vehicle, a ship or other vehicle transport vessel or watercraft, and/or an airplane or other vehicle transport aircraft, a state, a county, a city, a town, or a municipality, a court, a government agency, a law enforcement agency, a department of motor vehicles, a parking and/or traffic enforcement agency, a company or other private-sector entity or organization, authorized operators and users of a system for monitoring and managing transportation infrastructure and locations of vehicles therein, an individual or a group provided with one or more authorized or approved devices, the use of which results in input(s) being provided, a person or an entity authorized or approved to receive or collect funds in relation to a parking or moving violation associated with the vehicle, an owner or a registered owner of the vehicle, a person or persons authorized or approved by the owner and/or the registered owner of the vehicle, a lienholder, a person or entity authorized or approved to repossess the vehicle, an insurance company, an authorized or approved source or device, a processor or controller, biometric data acquisition device, a user-input mechanism, a RFID device, a NFC device, a camera, a code reader or generator, and a parking meter. In example embodiments, information, data, and/or programs stored in one or more database(s) 1106 is utilized in processing the signals and/or information. The database(s) 1106 include one or more of, for example, a law enforcement database, a DMV database, an insurance database, a lienholder database, a transportation infrastructure database, a parking facility database, a storage facility database, an impound facility database, and a vehicle transport service database. It should be understood that the database(s) 1106 can include additional database(s) pertaining, for example, to other types of information and/or data as described herein.

Example methodologies and technologies described herein present, or facilitate a presentation of, visual representations pertaining to a vehicle, a circumstance, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle, information, and/or notifications. Example implementations utilize a network and/or communications links and one or more interfaces and/or displays are to present the visual representations. The circumstances include, by way of example, one of more of the previously discussed circumstances, the discussion of which is incorporated herein by reference.

At 1110, an action or a process is facilitated, controlled, or initiated (e.g., by one or more of the participatory elements 1108). The action or process involves presenting a visual representation of one or more of, for example: an acknowledgement that a start time, a stop time, and/or an association between the vehicle and the transaction has been established, a prompt or request for additional information or user inputs (e.g., to associate a new/different/valid account with the transaction and/or vehicle, to authorize a transfer of funds in relation to the transaction), information and/or instructions (e.g., toll road rates, available credit for an account associated with the transaction, how to configure the electronic device for different modes of operation), a notification (e.g., a message notifying a person that a required input for the transaction has not been provided, failed to establish, and/or appears to be invalid or corrupted), and a warning (e.g., a text message, such as: “The account currently associated with this transaction has insufficient funds available. Please ensure that charges for your transaction are promptly paid and/or arrange for additional funds to be added to your account to avoid overdraft fees and other penalties.”). In an example embodiment, if the account to be charged lacks sufficient funds to pay for the transaction, a computer (or processing center of the like) can be programmed to automatically initiate a process of transmitting a bill or invoice, for example, by e-mail and/or mail, to the registered owner. In an example embodiment, the process can also include processing the signals and/or the information to identify in association with the transaction and/or the vehicle a circumstance that satisfies criteria for facilitating, controlling, or initiating an action or a process involving one or more of providing information, providing a notification, transferring funds, and issuing a ticket, a citation, a bill, an invoice, a warning, or other communication.

At 1112, a visual representation is presented (e.g., to one or more of the participatory elements 1108). The visual representation is presented at one or more of, for example: a mobile telephone, a smartphone, or a PCD, a device that generates, transmits, or reads code identifying the vehicle, a device, interface, or display that is separate from a device that generates, transmits, or reads code identifying the vehicle (e.g., a workstation, interface, vending machine, or kiosk), and a device, interface, or display that is remotely located in relation to a device that generates, transmits, or reads code identifying the vehicle (e.g., a processing/monitoring center, facility, or station).

An example method for monitoring, managing, and facilitating transactions involving a vehicle further includes providing, facilitating, or initiating a communication that includes a resource (e.g., URL) or other information that provides access to a receipt (e.g., PDF file/image) or other documentation or information relating to a charge to the account and/or usage or utilization by the vehicle of, and/or custody or transportation of the vehicle by, one or more of, for example: a transportation infrastructure, a parking facility or space, a storage facility or space, an impound facility or lot, a vehicle transport vehicle, a ship or other vehicle transport vessel or watercraft, and an airplane or other vehicle transport aircraft.

An example method for monitoring, managing, and facilitating transactions involving a vehicle further includes accessing, or facilitating or initiating a process of providing access to, supplemental information pertaining to one or more of a vehicle, a person, an entity, and an object associated with the account or with the transaction. In an example embodiment, the method for monitoring, managing, and facilitating transactions involving a vehicle further includes accessing, or facilitating or initiating a process of providing access to, the supplemental information, information associated with the transaction, and/or notifications relating to said information by one or more of, for example: an owner or operator of, or an authorized person or entity associated with, a transportation infrastructure, a parking facility or space, a storage facility or space, an impound facility or lot, a vehicle transport vehicle, a ship or other vehicle transport vessel or watercraft, and/or an airplane or other vehicle transport aircraft, a maintenance or service company, authorized operators and users of a system for monitoring and managing transportation infrastructure and locations of vehicles therein, a law enforcement agency, a parking enforcement agency, a government agency, a company or other private-sector entity or organization, a lienholder, a person or entity authorized or approved to repossess the vehicle, an insurance company, authorized or approved individuals or groups, an owner or a registered owner of the vehicle, and a person or persons authorized or approved by the owner and/or the registered owner of the vehicle.

Example implementations of the systems, apparatuses, and methods described herein involve generating, transmitting, and/or receiving signals in association with vehicle identification information, the signals including or providing, or facilitating or initiating a process of providing access to, information including one or more inputs and/or parameters for a transaction involving the vehicle. In another example embodiment, a method for monitoring, managing, and facilitating transactions involving a vehicle includes: receiving signals generated or transmitted by an electronic device, the signals being generated or transmitted in association with vehicle identification information that identifies a vehicle equipped with the device, the signals including or providing, or facilitating or initiating a process of providing access to, information including one or more inputs and/or parameters for a transaction involving the vehicle; and processing the signals and/or information to identify in association with the vehicle a circumstance that satisfies criteria for facilitating, controlling, or initiating an action or a process involving one or more of providing information, providing a notification, transferring funds, and issuing (e.g., electronically) a ticket, a citation, a bill, an invoice, a warning, or other communication. In example embodiments, the signals include vehicle identification information. The signals can also include information relating to one or more of, for example: the vehicle equipped with the electronic device, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle.

The transaction involves usage or utilization by the vehicle of, and/or custody or transportation of the vehicle by, one or more of, for example: a transportation infrastructure (e.g., a toll road), a parking facility or space (e.g., a parking garage), a storage facility or space (e.g., a self storage facility or space), an impound facility or lot (e.g., a police impound lot), a vehicle transport vehicle (e.g., automobile transport vehicles via “Roll On/Roll Off” (RO/RO)), a ship or other vehicle transport vessel or watercraft (e.g., cargo ship or freighter via RO/RO), and an airplane or other vehicle transport aircraft (e.g., cargo aircraft via RO/RO).

In an example method for monitoring, managing, and facilitating transactions involving a vehicle, the transaction includes charging an account associated with one or more of, for example: the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle to one or more other accounts.

In various example embodiments, the signals provide information relating to an interval of time (e.g., the signals include information pertaining to a start time and/or a stop time associated with the transaction). By way of example, the interval of time is associated with a transaction involving the vehicle and one or more of: a transportation infrastructure (e.g., a toll road), a parking facility or space (e.g., a parking garage), a storage facility or space (e.g., a self storage facility or space), an impound facility or lot (e.g., a police impound lot), a vehicle transport vehicle (e.g., automobile transport vehicles via “Roll On/Roll Off” (RO/RO)), a ship or other vehicle transport vessel or watercraft (e.g., cargo ship or freighter via RO/RO), and an airplane or other vehicle transport aircraft (e.g., cargo aircraft via RO/RO).

In an example method for monitoring, managing, and facilitating transactions involving a vehicle, the transaction includes charging an account depending upon an amount of time passing between start and stop times associated with the transaction.

In example embodiments, the method for monitoring, managing, and facilitating transactions involving a vehicle includes presenting a visual representation of one or more of, for example: the vehicle and/or the circumstance, information and/or instructions, a notification, a warning, and a prompt, as previously described herein. By way of example, the circumstance is an identification, a determination, and/or a prediction of one or more of a parking violation and a moving violation associated with one or more of the vehicle, an owner, a driver, a custodian, or a passenger of the vehicle, and a person within or transported by the vehicle. By way of example, the circumstance is an identification, a determination, and/or a prediction that one or more of a registration, a driver's license, and an insurance policy associated with one or more of the vehicle, an owner, a driver, a custodian, or a passenger of the vehicle, and a person within or transported by the vehicle is, or will be, expired, out-of-state, canceled, revoked, and/or suspended. By way of example, the circumstance is an identification, a determination, and/or a prediction that one or more of an account, a tax, an assessment, a charge, a surcharge, a fee, a fine, and a penalty associated with one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle is, or will be, late, overdue, unpaid, delinquent, and/or in default. By way of example, the circumstance is a crime, reported, detected or suspected criminal activity, or an identification, a determination, and/or a prediction of a crime or criminal activity associated with one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle. By way of example, the circumstance is an identification, a determination, and/or a prediction of a status associated with one or more of the vehicle, an owner, a driver, a custodian, or a passenger of the vehicle, a person, an animal, or an object within, secured to, or transported by the vehicle, and a person, an entity, an object, a condition, an event, an indication, or an interrupt associated with the vehicle. By way of example, the circumstance is an identification, a determination, and/or a prediction of one or more of a condition, an indication, and an interrupt associated with one or more of the vehicle, an owner, a driver, a custodian, or a passenger of the vehicle, a person, an animal, or an object within, secured to, or transported by the vehicle, a person, an entity, an object, a status, or an event associated with the vehicle, and a location, an area, a region, or an environment within which the vehicle is located, or that the vehicle is approaching or departing from. By way of example, the circumstance is an event for or during which a location of the vehicle or a person, an animal, or an object within, secured to, or transported by the vehicle presents or potentially raises a concern in relation to the event. By way of example, the circumstance is an identification, a determination, and/or a prediction that a location of the vehicle is within, approaching, or departing from an area, a region, or an environment designated as prohibited, unlicensed, limited, restricted, or cautionary access in relation to one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle. By way of example, the circumstance is an identification, a determination, and/or a prediction that a location of the vehicle is outside, departing from, or returning to an area, a region, or an environment designated as allowed, permitted, licensed, unlimited, unrestricted, or safe access in relation to one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle.

In example embodiments, the method for monitoring, managing, and facilitating transactions involving a vehicle includes providing information pertaining to one or more of the vehicle, an owner, a driver, a custodian, or a passenger of the vehicle, a person, an animal, or an object within, secured to, or transported by the vehicle, a person, an entity, an object, a status, a condition, an event, an indication, or an interrupt associated with the vehicle, the circumstance, and a location, an area, a region, or an environment within which the vehicle is located, or that the vehicle is approaching or departing from, to one of more of, for example: a law enforcement agency, a government agency, a state, a county, a city, a town, or a municipality, a company or other private-sector entity or organization, an individual or a group provided with an authorized or approved device, an owner or a registered owner of the vehicle, and a person authorized or approved by the owner and/or the registered owner.

In example embodiments of the method for monitoring, managing, and facilitating transactions involving a vehicle, the notification pertains to one or more of, for example: a parking violation and/or a moving violation associated with one or more of the vehicle, an owner, a driver, a custodian, or a passenger of the vehicle, and a person within or transported by the vehicle, a crime, criminal activity, illegal action, prohibited substance, criminal record or notice and/or conviction associated with one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle, a location and/or a movement of the vehicle, locations and/or movements of one or more vehicles associated with a person, persons, entity, object, group, organization, event, enterprise, and/or circumstance, an event for or during which a location of the vehicle or a person, an animal, or an object within, secured to, or transported by the vehicle presents or potentially raises a concern in relation to the event, an area, a region, or an environment designated as prohibited, unlicensed, limited, restricted, or cautionary access in relation to one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle, an area, a region, or an environment designated as allowed, permitted, licensed, unlimited, unrestricted, or safe access in relation to one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle, a registration, a driver's license, and/or an insurance policy associated with one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle, vehicle registration requirements for new residents of the state, and information and/or updates to information in a law enforcement database, a DMV database, an insurance database, and a lienholder database, a transportation infrastructure database, a parking facility database, a storage facility database, an impound facility database, and a vehicle transport service database, or other database.

In example embodiments, the method for monitoring, managing, and facilitating transactions involving a vehicle includes transferring funds from an account associated with one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle to one or more other accounts. The one or more other accounts are associated with one or more of, for example: an owner or operator of, or an authorized person or entity associated with, a transportation infrastructure, a parking facility or space, a storage facility or space, an impound facility or lot, a vehicle transport vehicle, a ship or other vehicle transport vessel or watercraft, and/or an airplane or other vehicle transport aircraft, an entity authorized to receive or collect funds in relation to a parking or moving violation associated with the vehicle, a state agency, a city, a municipality, a court, a lienholder, and an insurance company.

In example embodiments, the method for monitoring, managing, and facilitating transactions involving a vehicle includes adding information pertaining to one or more of, for example: the vehicle, one or more transactions involving the vehicle, an owner, a driver, a custodian, or a passenger of the vehicle, a person, an animal, or an object within, secured to, or transported by the vehicle, a person, an entity, an object, a status, a condition, an event, an indication, or an interrupt associated with the vehicle, the circumstance, and a location, an area, a region, or an environment within which the vehicle is located, or that the vehicle is approaching or departing from, to a database and/or using the information to update a database.

In example embodiments, the method for monitoring, managing, and facilitating transactions involving a vehicle includes adding to or modifying the information, the circumstance, and/or the criteria in response to an input or inputs provided by one or more of, for example: an owner or operator of, or an authorized person or entity associated with, a transportation infrastructure, a parking facility or space, a storage facility or space, an impound facility or lot, a vehicle transport vehicle, a ship or other vehicle transport vessel or watercraft, and/or an airplane or other vehicle transport aircraft, a state, a county, a city, a town, or a municipality, a court, a government agency, a law enforcement agency, a department of motor vehicles, a parking and/or traffic enforcement agency, a company or other private-sector entity or organization, authorized operators and users of a system for monitoring and managing transportation infrastructure and locations of vehicles therein, an individual or a group provided with one or more authorized or approved devices, the use of which results in input(s) being provided, a person or an entity authorized or approved to receive or collect funds in relation to a parking or moving violation associated with the vehicle, an owner or a registered owner of the vehicle, a person or persons authorized or approved by the owner and/or the registered owner of the vehicle, a lienholder, a person or entity authorized or approved to repossess the vehicle, an insurance company, an authorized or approved source or device, a processor or controller, a biometric data acquisition device, a user-input mechanism, a RFID device, a NFC device, a camera, a code reader or generator, and a parking meter.

Example embodiments described herein involve the provision or utilization of transportation infrastructure utilization information (e.g., in relation to traffic management). The transportation infrastructure utilization information is accessed, utilized, and/or updated in association with a vehicle (e.g., in response to receiving signals including, associated with, or in association with information identifying and/or pertaining to a vehicle). The signals and/or information are processed to identify a circumstance that satisfies criteria for facilitating, controlling, or initiating one or more communications and/or transactions pertaining to, involving, or in relation to the vehicle (and/or other vehicles) and one or more transportation infrastructures.

Example systems and methods described herein involve monitoring, managing, and facilitating communications and/or transactions relating to use or utilization by a vehicle (and/or other vehicles) of one or more transportation infrastructures or portions thereof. In an example technology and/or methodology, signals including or providing, or facilitating or initiating a process of providing access to transportation infrastructure utilization information (e.g., involving or in relation to the vehicle and/or other vehicles) are received, and the signals and/or information are processed to identify, responsive to, or determined by or in relation to or in consideration of, the transportation infrastructure utilization information and in association with the vehicle (and/or other vehicles), a circumstance that satisfies criteria for facilitating, controlling, or initiating one or more communications and/or transactions pertaining to, involving, or in relation to the vehicle (and/or other vehicles) and one or more transportation infrastructures.

By way of example, the transportation infrastructure utilization information involves usage or utilization by the vehicle (and/or other vehicles) of one or more of a transportation infrastructure (or infrastructures), or multiple different portions (e.g., segments, areas, regions) thereof, a parking facility or space, and a storage facility or space. In example embodiments, a transportation infrastructure is defined (at least in part) as an area, i.e., an infrastructure area, and can include one or more roadways and/or parking facilities or spaces therein. Additionally, or alternatively, the process of providing access to transportation infrastructure utilization information can be responsive to, or determined by or in relation to or in consideration of, the transportation infrastructure utilization information.

The criteria for facilitating, controlling, or initiating one or more communications and/or transactions can depend, for example, upon one or more of the transportation infrastructure utilization information, and times and/or locations of transportation infrastructure utilization by the vehicle (and/or other vehicles). In example embodiments, the information includes one or more inputs and/or parameters for one or more communications and/or transactions involving, associated with, and/or facilitated in association with the vehicle (and/or other vehicles). By way of example, the one or more communications and/or transactions involve usage or utilization by the vehicle (and/or other vehicles) of, and/or custody or transportation of the vehicle (and/or other vehicles) by, one or more of: a transportation infrastructure (e.g., a toll road) or portions thereof, a parking facility or space (e.g., a parking garage), a storage facility or space (e.g., a self storage facility or space), an impound facility or lot (e.g., a police impound lot), a vehicle transport vehicle (e.g., automobile transport vehicles via “Roll On/Roll Off” (RO/RO)), a ship or other vehicle transport vessel or watercraft (e.g., cargo ship or freighter via RO/RO), and an airplane or other vehicle transport aircraft (e.g., cargo aircraft via RO/RO).

In example embodiments, the one or more inputs and/or parameters are provided utilizing a signal and/or information that identifies or uniquely identifies the vehicle. In example embodiments, the one or more inputs and/or parameters are provided utilizing an identifier that does not utilize a signal and/or information identifying or uniquely identifying a vehicle.

In example embodiments, the one or more inputs and/or parameters determine, adjust, and/or facilitate establishing a cost associated with at least one communication and/or transaction in consideration of and/or to incentivize one or more of a desired (e.g., specified, or otherwise determined) infrastructure utilization, and a redirection, a change of location, and/or a redistribution of one or more users or prospective users of a transportation infrastructure or infrastructures in relation to one or more marketplaces.

In example embodiments, the one or more communications and/or transactions involve usage or utilization by the vehicle (and/or other vehicles) of one or more of a transportation infrastructure (or infrastructures), or multiple different portions (e.g., segments, areas, regions) thereof, a parking facility or space, and a storage facility or space.

The criteria for facilitating, controlling, or initiating one or more communications and/or transactions can depend, for example, upon a status, a condition, an event, an indication, or an interrupt associated with one or more of a transportation infrastructure or infrastructures, the vehicle (and/or other vehicles), a personal computing or communications device (or other “auxiliary device”) associated with the vehicle, an entity associated with the vehicle, and/or a person associated with the vehicle, an owner, a driver, a custodian, or a passenger of the vehicle, and a person, an animal, or an object within, secured to, or transported by the vehicle.

In example embodiments, an apparatus for monitoring, managing, and facilitating an action or process relating to transportation infrastructure utilization includes: one or more electronic devices that provide signals and/or information, the signals including or providing, or facilitating or initiating a process of providing access to transportation infrastructure utilization information (e.g., involving or in relation to the vehicle and/or other vehicles). In example embodiments, the one or more electronic devices are configured (e.g., programmed) to process, or facilitate or initiate processing of the signals and/or information to identify, responsive to, or determined by or in relation to or in consideration of, the transportation infrastructure utilization information and in association with the vehicle (and/or other vehicles), a circumstance that satisfies criteria for facilitating, controlling, or initiating one or more communications and/or transactions pertaining to, involving, or in relation to the vehicle (and/or other vehicles) and one or more transportation infrastructures. In example embodiments, the one or more electronic devices include at least one device configured to initiate, request, and/or facilitate a transfer or charge from an account to one or more other accounts in relation to the one or more communications and/or transactions.

In example embodiments, the one or more of the electronic devices facilitate providing information including one or more inputs and/or parameters for one or more communications and/or transactions involving a vehicle, or associated with a vehicle. For example, one or more of the communications and/or transactions is associated with a vehicle, even as to or in the case of communications/transactions that do not involve the vehicle (i.e., communications/transactions that do no pertain per se to infrastructure utilization by the vehicle or that do not otherwise intrinsically involve the vehicle).

As previously discussed, in example embodiments, the processing center 910 and/or other participatory elements of a monitoring system receive or are provided with the signals and/or information (e.g., signals and/or information received over an interval of time). In example embodiments, the processing center 910 and/or other participatory elements of a monitoring system store the signals and/or information, utilize the signals and/or information to update one or more databases, and/or process the signals and/or information.

One or more of the electronic devices 1000 and 1001, or modified versions thereof, can be configured to receive and respond to interrupts and/or commands from one or more of, for example: an authorized or approved source and/or device (e.g., law enforcement agencies, police and other authorized transmitter devices, blood alcohol sensors, one or more departments of motor vehicles, parking and/or traffic enforcement agencies, operators and users of one or more transportation infrastructures and/or one or more parking and/or storage facilities/spaces, a navigation system, and/or a system for monitoring and managing transportation infrastructure and locations of vehicles therein, a person or an entity authorized or approved to receive or collect funds, an owner or a registered owner of the vehicle, a person or persons authorized or approved by the owner and/or the registered owner of the vehicle, lienholders, insurance companies, a processor or controller of or in communication with the electronic device 1000), a biometric data acquisition device, a user-input mechanism (e.g., on-board touch screen, mobile telephone, smartphone, or personal communication device (PCD) of the registered owner of the vehicle, emergency call devices), a RFID device (e.g., RFID transmitters and/or transponders), a NFC device, a camera (e.g., speed camera transmitters), a code reader or generator, and a parking meter.

In an example embodiment, one or more of the signals and/or information establish times and/or locations associated with one or more of the communications and/or transactions. For example, and in this regard, a transaction can include charging an account (e.g., automatically or otherwise) depending upon at least one time (e.g., a start time and/or a stop time) and/or at least one location (e.g., a starting point and/or a stopping point along a route or path) associated with one or more of the communications and/or transactions.

In an example technology and/or methodology, one or more start times, stop times, and/or other times associated with one or more communications and/or transactions is established (e.g., automatically) by one or more reader devices and/or transponders, for example, establishing a location-specific start time, a location-specific stop time, and/or one or more location-specific times therebetween in association with one or more of the communications and/or transactions. By way of example, one or more times and/or intervals of time (location-specific or otherwise, or combinations thereof) are associated with one or more communications and/or transactions that involve usage or utilization by a vehicle of one or more of a transportation infrastructure (or infrastructures), or multiple different portions (e.g., segments, areas, regions) thereof, a parking facility or space, and a storage facility or space. In relation to and to the extent that fees, costs, or/or other charges are to be assessed in association with the one or more communications and/or transactions, amounts are determined, for example, in consideration of transportation infrastructure(s) utilization information (e.g., depending upon spatial and/or temporal information associated with particular communications and/or transactions and/or associated with groups of communications and/or transactions). One or more accounts associated with the one or more communications and/or transactions is charged (e.g., automatically or otherwise) depending upon the amounts.

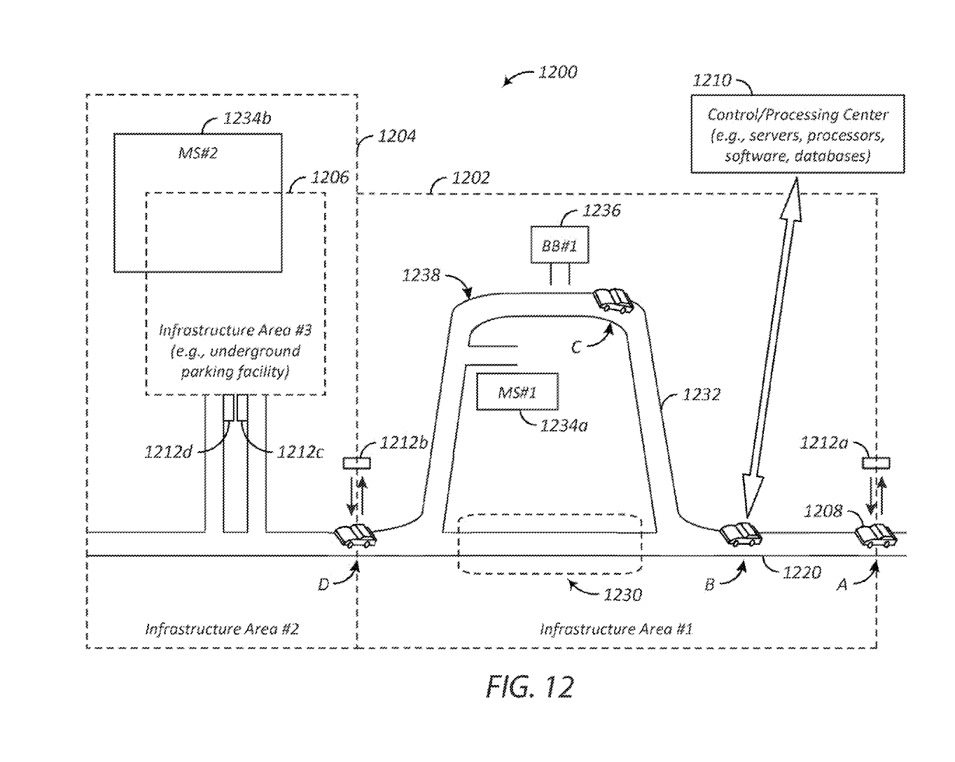

Referring to FIG. 12, in this example depiction, an infrastructure(s)/marketplace(s) environment 1200 includes infrastructure areas 1202, 1204, and 1206 (denoted “Infrastructure Area #1”, “Infrastructure Area #2”, and “Infrastructure Area #3”, respectively) and a vehicle 1208 is shown at four different locations (denoted “A”, “B”, “C”, and “D”, respectively) within the environment. For example, the vehicle 1208 can be equipped with an electronic device (such as the electronic devices 904 and 1000) configured to facilitate communications (e.g., one or more of cellular, radio and satellite communications) and/or interfacing elements. In this example, the infrastructure(s)/marketplace(s) environment 1200 is equipped as shown with electronic devices 1212a, 1212b, 1212c, and 1212d (such as the electronic devices 912 and 1001) configured to receive signals generated or transmitted by the electronic device of the vehicle 1208. In example embodiments, the electronic device of the vehicle 1208 is configured to communicate with a network (such as the network 906) via the electronic devices 1212a, 1212b, 1212c, and 1212d. The aforementioned network can also be utilized to facilitate communications links between the electronic device of the vehicle 1208 and one or more of the control/processing center 1210 (e.g., implemented in the form of servers, processors, or the like operating under the control of software and/or other sources of commands or inputs) and system interfacing elements (e.g., participatory elements described herein). By way of example, the vehicle 1208 is equipped or provided with an electronic device (such as the electronic device 1000) that includes a RFID tag (such as the RFID tag 1006), and the electronic devices 1212a, 1212b, 1212c, and 1212d are provided as electronic devices (such as the electronic device 1001) that each include a RFID reader (such as the RFID reader 1010).

The transportation infrastructure utilization information is accessed, for example, in consideration of or in relation to infrastructure locations associated with the vehicle at one or more times and/or during one or more time intervals. The transportation infrastructure utilization information can involve or relate to the vehicle (e.g., indicating times when the vehicle is determined to be at particular locations within an infrastructure area) and/or to multiple vehicles (e.g., indicating an area of traffic congestion involving and/or potentially affecting traffic flow in relation to one or more of the vehicles). By way of example, and referring to FIG. 12, the electronic devices 1212a and 1212b are located along the roadway 1220 at opposite ends (or boundary portions) of the infrastructure area 1202 (Infrastructure Area #1). When the vehicle is at (or repositions through) the location denoted “A”, the electronic device 1212a receives a signal (e.g., from the electronic device of the vehicle 1208) that facilitates or initiates a process of establishing transportation infrastructure utilization information associated with the vehicle 1208 at a particular time (e.g., the time when a signal is received by the electronic device 1212a in association with the vehicle 1208) for a particular location (e.g., the location of the electronic device 1212a within the infrastructure area 1202). Similarly, when the vehicle is at (or repositions through) the location denoted “D”, the electronic device 1212b receives a signal (e.g., from the electronic device of the vehicle 1208) that facilitates or initiates a process of establishing transportation infrastructure utilization information associated with the vehicle 1208 at a particular time (e.g., the time when a signal is received by the electronic device 1212b in association with the vehicle 1208) for a particular location (e.g., the location of the electronic device 1212b within the infrastructure area 1202). By way of example, transportation infrastructure utilization information established by, or via, the electronic devices 1212a and 1212b is utilized (e.g., by the control/processing center 1210) to monitor, manage, and/or facilitate a transaction relating to transportation infrastructure utilization by the vehicle (e.g., a transaction that includes determining an amount to be charged in relation to movement of the vehicle 1208 through one or more portions of Infrastructure Area #1 and automatically charging an account associated with the transaction). The transaction can include determining an amount to be charged depending upon one or more times when signals associated with the vehicle 1208 were received by one or more of the electronic devices 1212a and 1212b and/or depending upon location-specific information associated with one or more of the received signals. The amount can be based on one or more received signals and/or other information. For example, a communication and/or transaction amount can be based on a time input (e.g., determined by averaging times associated with multiple different received signals), a location input (e.g., determined by calculating a single location, an area, and/or a path from locations associated with multiple different received signals), or a combination of time and location inputs. The process of calculating a single location can include, for example, determining a centroid location from locations associated with multiple different received signals.

Multiple different time inputs can be assigned different relative values or weightings, e.g., depending upon location-specific or other criteria. For example, if a time input associated with an infrastructure area or a portion thereof falls within a time interval during which the infrastructure area or a portion thereof typically experiences or is determined to be presently experiencing rush hour traffic, that time input can be utilized in determining one or more communication and/or transaction amounts (e.g., adjusting communication and/or transaction charges or rates respectively associated with multiple different infrastructure areas or portions thereof), and other time inputs, if any, can be disregarded or assigned a lower value or weighting.

Multiple different location inputs can be assigned different relative values or weightings, e.g., depending upon time-specific or other criteria. For example, if a location input received or provided in associated with a particular time interval includes location information indicating or associated with an infrastructure area or a portion thereof in relation to a particular leg or portion of a travel path, route, or itinerary, that location input can be utilized in determining one or more communication and/or transaction amounts (e.g., reducing an associated charge to reward or incentivize the “on schedule” driver), and other location inputs, if any, can be disregarded or assigned a lower value or weighting.

The transportation infrastructure utilization information can include navigation information (e.g., associated with a vehicle and one or more travel paths, routes, or itineraries). By way of example, an on-board navigation system (e.g., of a vehicle) receives inputs, commands, or the like from a driver (or other source) specifying criteria, requirements, and/or preferences to be utilized in generating navigation information, which can be provided as part of the transportation infrastructure utilization information, or vice versa. In example embodiments, an on-board navigation system, the processing center 910, or a combination thereof is utilized to generate and/or provide one or more sets of navigation information. An on-board navigation system can be configured (programmed) to generate and/or provide such navigation information, either alone or in conjunction with one or more other processing resources and/or databases (including, for example, one or more navigation system databases). Navigation information can include, for example, information associated with one or more travel paths, routes, or itineraries that are requested, required, and/or approved by the driver (e.g., to be presented to the driver as an available option regardless of cost and/or current or predicted traffic or other conditions, or to be presented to the driver on a conditional basis depending, for example, upon a maximum amount that a driver or an employer of the driver is willing to pay in relation to utilizing a particular travel path, route, or itinerary at a particular time, an amount available in an account, or an amount such as a monthly budget associated with one or more specified or otherwise determined or identified transportation infrastructure(s) utilizations).

One or more websites, user interfaces, and/or applications can be utilized in relation to generating or providing one or more of the navigation information, portions of the navigation information, and inputs utilized in determining the navigation information. In an example embodiment, the processing center 910 can perform the functions of, provide, or facilitate a service host (e.g., implemented in the form of servers, processors, or the like operating under the control of software and/or other sources of commands or inputs) configured, for example, to utilize a system application or other platform to facilitate generating and providing navigation information (e.g., added to and/or utilized to update the transportation infrastructure utilization information), for example, by hosting a website accessible by system participants and/or users via the network 906.

In example embodiments, a method for monitoring, managing, and facilitating communications and/or transactions relating to transportation infrastructure utilization includes processing the signals and/or information to identify in association with the vehicle a circumstance that satisfies criteria for facilitating, controlling, or initiating an action or a process responsive to, or determined by or in relation to or in consideration of, the transportation infrastructure utilization information. The information includes, for example, one or more inputs and/or parameters for one or more communications and/or transactions involving, associated with, and/or facilitated in association with the vehicle. The one or more communications and/or transactions can include charging an account associated with one or more of, for example: the vehicle, a personal computing or communications device (or other “auxiliary device”), a person (e.g., an owner, a driver, a custodian, or a passenger of the vehicle) or entity associated (e.g., biometrically or otherwise) with the vehicle, and an event, activity, or enterprise involving or associated with usage or utilization of a transportation infrastructure (or infrastructures). In example embodiments, the one or more inputs and/or parameters determine, adjust, and/or facilitate access to, or communication of, a transportation infrastructure (or infrastructures) utilization protocol that determines costs associated with use or utilization of portions of a transportation infrastructure (or infrastructures) by one or more users or prospective users of the transportation infrastructure (or infrastructures) in relation to one or more of, for example: adjusting traffic flow on one or more portions of the transportation infrastructure (or infrastructures), and preventing or decreasing accidents associated with the transportation infrastructure (or infrastructures) or one or more portions thereof. In example embodiments, the transportation infrastructure(s) utilization protocol situationally determines costs associated with use or utilization of portions of a transportation infrastructure (or infrastructures), for example, depending upon traffic flow on one or more portions of the transportation infrastructure (or infrastructures) and/or the circumstance or other inputs and/or parameters (e.g., as described herein).

The circumstance can be (or include or involve) an identification, a determination, and/or a prediction (e.g., of a status) associated with one or more of, for example: a transportation infrastructure (or infrastructures) or one or more portions thereof, the vehicle (and/or other vehicles), a person (e.g., an owner, a driver, a custodian, or a passenger of the vehicle), an animal, or an object associated (e.g., biometrically or otherwise) with the vehicle, one or more users or prospective users of the transportation infrastructure (or infrastructures), and an event, activity, or enterprise involving or associated with the transportation infrastructure (or infrastructures) (and/or usage or utilization of one or more portions thereof).

The action or process can involve one or more of, for example: providing information, providing a notification, transferring funds, and issuing a ticket, a citation, a bill, an invoice, a warning, or other communication. The action or process can include providing inputs to a system or device for providing a vehicle (or vehicles) with autopilot functionality (e.g., in relation to a “self-driving” vehicle, or a personal pod, enclosure, or other transportation device accommodating a person or persons). For example, the inputs can be provided in relation to an action or process of reducing or incentivizing a reduction in vehicle speed and/or to reroute one or more vehicles around or away from an area of congestion or inclement weather or the location of an accident, a hazard, a crime scene, a motorcade, or surveillance or other law enforcement action or operation.

Referring to FIG. 12, within Infrastructure Area #1, an area 1230 (denoted in dashed lines) designates, for example, an area of congested traffic. It can also represent, by way of example, an area experiencing (or associated with) inclement weather or the location of an accident, a hazard, a crime scene, a motorcade, or a surveillance or other law enforcement action or operation. By way of example, in response to an identification, determination, or prediction of or in relation to such a circumstance within the area 1230, the control/processing center 1210 sends a message or other communication to the approaching vehicle 1208 (e.g., when the vehicle arrives at or repositions through the location denoted “B”) suggesting, for example, the alternative route 1232.

In FIG. 12, Infrastructure Area #1 ends as the vehicle passes the electronic device 1212b moving into Infrastructure Area #2. An infrastructure(s)/marketplace(s) environment can include one or more infrastructure areas contained within another infrastructure area. For example, Infrastructure Area #2 includes an Infrastructure Area #3, e.g., a parking lot/facility or a portion thereof. In example embodiments, infrastructure areas overlap. Different charges or rates (e.g., for transportation infrastructure utilization by vehicles) can be associated with different infrastructure areas, for example, depending upon traffic flow on one or more portions of the transportation infrastructure (or infrastructures) and/or the circumstance or other inputs and/or parameters (e.g., as described herein).

Additional or multiple transactions can be facilitated. For example, with reference to FIG. 12, transportation infrastructure utilization information established by, or via, the electronic devices 1212c and 1212d is utilized (e.g., by the control/processing center 1210) to monitor, manage, and/or facilitate a transaction relating to transportation infrastructure utilization by the vehicle (e.g., a transaction that includes determining an amount to be charged in relation to use by the vehicle 1208 of Infrastructure Area #3 and automatically charging an account associated with the transaction). By way of example, the vehicle 1208 is equipped or provided with an electronic device (such as the electronic device 1000) that includes a NFC tag or a NFC-enabled electronic device, and the electronic devices 1212c and 1212d are each provided as an electronic device (such as the electronic device 1001) that includes a NFC reader.

In various example embodiments, and as previously discussed, one or both of the electronic devices 1000 and 1001 can be configured to read a NFC device (e.g., which operates at 13.56 MHz on ISO/IEC 18000-3 air interface and at rates ranging from 106 kbit/s to 848 kbit/s and typically requires a distance of 4 cm or less between the NFC tag and reader). For example, the electronic devices 1212c and 1212d each include a NFC device (e.g., located as shown at the entrance and exit, respectively, of Infrastructure Area #3, or implemented in the form of a NFC-enabled handset, mobile telephone, or PCD) which is utilized to read identifier information stored on another NFC device (e.g., a NFC tag, or a NFC-enabled electronic device, such as a smartphone running

Google Wallet or another NFC-based application). By way of example, an electronic device (such as the electronic device 1000), and/or a communications device operatively connected thereto, transmits or otherwise provides the identifier information to electronic devices (such as the electronic device 1001) of the electronic devices 1212c and 1212d, respectively, and/or a processing center.

In example embodiments, as previously discussed, the electronic device 1000 can operate in multiple operating modes simultaneously (e.g., utilizing multiple transponders). In example embodiments, as previously discussed, the electronic device 1001 includes multiple reader devices (e.g., a far-field device and a near-field device). Also, and as previously discussed, selectability between modes of operation that differ in their range and/or utilize different electronic devices allows a driver, for example, to turn off the far field device after exiting a toll road and subsequently use a near-field device (e.g., the driver's NFC-enabled smartphone) to establish a start time when entering a parking structure.

As previously discussed, additional examples of operating modes involve migrating and/or sharing a process of generating, transmitting, and/or reading code (e.g., code identifying the vehicle). In an example “auxiliary device” mode, the electronic device (e.g., the electronic device 1000 and/or the electronic device 1001) communicates, for example, with an auxiliary device and provides the auxiliary device with information and/or data such as code identifying the vehicle. The auxiliary device, in turn, utilizes the information and/or data to generate or transmit the code. In example embodiments, the auxiliary device is, includes, or is provided via a NFC-enabled electronic device, such as a smartphone or PCD (e.g., of the driver or a passenger in the vehicle) that is configured with and/or provided with access to a NFC-based application (such as Google Wallet). In an example “auxiliary device” mode, the auxiliary device is provided with code identifying the vehicle and utilizes a NFC-based application to generate the code in response to the auxiliary device being positioned sufficiently close to a NFC code reader device (e.g., at an entrance or exit of a parking facility). In an example embodiment, the code is provided on a temporary basis, for example, the information and/or data includes instructions to the NFC-based application limiting the amount of time that the driver has to establish a start or stop time for a parking transaction involving the vehicle. Moreover, in an example embodiment, the information and/or data provides that the code automatically expires and/or is permanently deleted from the auxiliary device within an amount of time (e.g., a time limit) after the auxiliary device is provided with the code and authorized to use it in relation to a transaction involving the vehicle. In another example “auxiliary device” mode, the electronic device (e.g., the electronic device 1000 and/or the electronic device 1001) communicates indirectly with the auxiliary device (e.g., via one or more of the network 906 and the processing center 910). In another example “auxiliary device” mode, a source or device other than the electronic devices 1000 and 1001 (e.g., the processing center 910) communicates with the auxiliary device (e.g., a NFC-enabled smartphone) to provides the auxiliary device with the information and/or data (e.g., including and/or providing access to code identifying the vehicle).

In example embodiments, and as previously discussed, the electronic device 1001 includes multiple reader devices. In the case of a transportation infrastructure (e.g., a toll road), reader devices are located, for example, at the entrances and exits of the transportation infrastructure and/or provided in the form of hand-held reader devices that can be used by operators, employees, or service or other personnel of the transportation infrastructure (e.g., toll both attendants). In the case of a parking facility (e.g., a parking garage or parking lot), reader devices are located, for example, at the entrance(s) and exit(s) of the parking facility/lot and/or provided in the form of hand-held reader devices that can be used by operators, employees, or service or other personnel of the parking facility/lot (e.g., parking facility/lot attendants). In the case of a storage facility (e.g., a self storage facility), reader devices are located, for example, at entrance(s) and exit(s) of the storage facility and/or provided in the form of hand-held reader devices that can be used by operators, employees, or service or other personnel of the storage facility (e.g., storage facility attendants).

Thus, in an example embodiment, a method for monitoring, managing, and facilitating communications and/or transactions relating to transportation infrastructure utilization includes: receiving signals including, associated with, or in association with information identifying and/or pertaining to a vehicle, the signals including or providing, or facilitating or initiating a process of providing access to transportation infrastructure utilization information (e.g., involving or in relation to the vehicle and/or other vehicles); and processing the signals and/or information to identify, responsive to, or determined by or in relation to or in consideration of, the transportation infrastructure utilization information and in association with the vehicle (and/or other vehicles), a circumstance that satisfies criteria for facilitating, controlling, or initiating one or more communications and/or transactions pertaining to, involving, or in relation to the vehicle (and/or other vehicles) and one or more transportation infrastructures. In an example embodiment, the method further includes facilitating, controlling, or initiating the one or more communications and/or transactions (e.g., utilizing one or more electronic communications devices, computer-controlled or electronic displays, and/or electronic graphical user interfaces or other computer-controlled electronic user interfaces). In an example embodiment, the method further includes applying one or more of the signals and/or information, the transportation infrastructure utilization information, times and/or locations of transportation infrastructure utilization by the vehicle (and/or other vehicles), the circumstance, and one or more of the criteria to information (e.g., transportation infrastructure utilization information) associated with the vehicle to facilitate, control, or initiate an action or process involving the one or more communications and/or transactions and controlling or utilizing one or more electronic communications and/or display devices to effect at least a portion of the action or process. In an example embodiment, the method further includes facilitating or initiating a process of presenting a visual representation (e.g., controlling an electronic display to generate a visual representation) of one or more of the signals and/or information, the transportation infrastructure utilization information, times and/or locations of transportation infrastructure utilization by the vehicle (and/or other vehicles), the circumstance, one or more of the criteria, a transportation infrastructure or infrastructures, a parking facility or space, a merchant store, the vehicle (and/or other vehicles), one or more communications and/or transactions pertaining to, involving, or in relation to the vehicle and one or more transportation infrastructures, information and/or instructions, a notification, a warning, and a prompt. In an example embodiment, the method further includes applying one or more of the signals and/or information, the transportation infrastructure utilization information, times and/or locations of transportation infrastructure utilization by the vehicle (and/or other vehicles), the circumstance, and one or more of the criteria to facilitate, control, or initiate an action or process that involves generating or providing a visual representation pertaining to one or more communications and/or transactions and controlling or utilizing one or more electronic communications and/or display devices to effect at least a portion of the action or process.

In example embodiments, a method for monitoring, managing, and facilitating communications and/or transactions relating to transportation infrastructure utilization includes effecting an action or process involving the one or more communications and/or transactions. For example, the action or process includes controlling, utilizing, or providing access to an electronic (and/or computer-controlled or facilitated) device or interface and/or an application or other platform that facilitates at least a portion of the action or process. The electronic (and/or computer-controlled or facilitated) device or interface and/or application or other platform can include one or more of, for example: an electronic communications device, a computer-controlled or electronic display (e.g., a head-up display, also referred to as a HUD, or a holographic display), an electronic graphical user interface or other computer-controlled electronic user interface, a website or other platform that provides an electronic user interface, and a custom plug-in system application which functions as an extension and overlay to an existing (third party) system application or other platform.

In example embodiments, a method for monitoring, managing, and facilitating communications and/or transactions relating to transportation infrastructure utilization includes applying one or more of the signals and/or information, the transportation infrastructure utilization information, an identified circumstance (or circumstances), and one or more of the criteria to facilitate, control, or initiate an action or process involving the one or more communications and/or transactions. The action or process can include controlling or utilizing one or more electronic communications and/or display devices to effect at least a portion of the action or process. For example, transportation infrastructure utilization information and an identified circumstance associated with the vehicle are applied to control (e.g., remotely control) one or more electronic communications devices in relation to at least a portion of an action or process of providing updates (e.g., in real time) to transportation infrastructure utilization information associated with the vehicle.

In example embodiments, a method for monitoring, managing, and facilitating communications and/or transactions relating to transportation infrastructure utilization includes applying one or more of the signals and/or information, the transportation infrastructure utilization information, an identified circumstance (or circumstances), and one or more of the criteria to facilitate, control, or initiate an action or process of generating or providing one or more visual representations pertaining to one or more communications and/or transactions. The action or process can include controlling or utilizing one or more electronic communications and/or display devices to effect at least a portion of the action or process. For example, transportation infrastructure utilization information and an identified circumstance associated with the vehicle can be applied (e.g., automatically and/or in response to changes in vehicle location or to one or more of the criteria) to control (e.g., remotely control) one or more electronic displays in relation to at least a portion of an action or process of generating or providing one or more visual representations pertaining to one or more communications and/or transactions. The one or more visual representations can include a visual representation of one or more of, for example: the signals and/or information, transportation infrastructure utilization information, times and/or locations of transportation infrastructure utilization by the vehicle (and/or other vehicles), an identified circumstance or circumstances, and one or more criteria associated with (and/or presented in relation to effecting an electronic interface that allows a user to facilitate, control, or initiate) the one or more communications and/or transactions. In example embodiments, the one or more visual representations include multiple simultaneously and/or sequentially presented visual representations of one or more of, for example: the signals and/or information, transportation infrastructure utilization information (e.g., associated with the vehicle and/or other vehicles), times and/or locations of transportation infrastructure utilization by the vehicle (and/or other vehicles), one or more circumstances (e.g., identified in relation to one or more vehicles and/or one or more transportation infrastructures), one or more of the criteria, a transportation infrastructure or infrastructures, a parking facility or space, a merchant store, the vehicle (and/or other vehicles), one or more communications and/or transactions pertaining to, involving, or in relation to the vehicle (and/or other vehicles) and one or more transportation infrastructures, information and/or instructions, a notification, a warning, and a prompt.

Example embodiments described herein involve the electronic provision or facilitation of a group of marketplace participants in relation to one or more marketplaces and/or infrastructures. Communications and/or transactions relating to infrastructure and/or marketplace utilization are monitored, managed, and facilitated. For example, an identifier is utilized to automatically activate one or more electronic communications and/or display devices in association with multiple different participants, respectively, in relation to a process of determining one or more communication and/or transaction amounts.

In example embodiments, an infrastructure(s)/marketplace(s) environment can include one or more marketplace participants (e.g., as described herein). Referring to FIG. 12, in this example depiction, the infrastructure(s)/marketplace(s) environment 1200 includes merchant stores 1234a and 1234b (denoted “MS#1” and “MS#2”, respectively) and a billboard 1236 (denoted “BB#1”). In example embodiments, participatory elements or “participants” of an infrastructure(s)/marketplace(s) environment include one or more merchant stores (e.g., retail stores) and/or display devices (e.g., billboards). For example, each merchant store includes, or is operatively connected to, one or more electronic devices that facilitate communications with a processing center (e.g., the processing center 910) and reading or otherwise obtaining identifier information (e.g., from one or more identifiers). As to the latter functionality, a merchant store is equipped or provided, for example, with an electronic device (such as the electronic device 1001) that includes a NFC reader (e.g., that reads a NFC tag provided by or via a NFC-enabled electronic device, such as a smartphone or other “auxiliary device”). In example embodiments, each display device includes, or is operatively connected to, one or more electronic devices that facilitate communications with a processing center (e.g., the processing center 910) and/or reading or otherwise obtaining identifier information (e.g., from one or more identifiers). For example, a display device (e.g., a billboard located adjacent to a roadway) includes an electronic display (or other device) controlled to generate one or more images (or components or elements thereof) suitable for capture by an imaging device. In example embodiments, the one or more images (or components or elements thereof) include a resource (e.g., URL) or other information that is read or otherwise obtained (e.g., decoded) in association with an identifier (e.g., an identifier provided by or via an image capture device, such as a smartphone or other “auxiliary device”, equipped with code reading software).

Example methodologies and technologies described herein involve utilizing, providing, or facilitating or initiating an action or process involving one or more electronic devices (e.g., one or more auxiliary or other devices) and the infrastructure(s)/marketplace(s) environment 1200 (e.g., displays and other devices or objects, collectively represented by BB#1 for the sake of clarity, which generate images that can be captured by the one or more auxiliary or other devices). For example, the one or more electronic devices include a device that utilizes an image recognition technology or application (such as Google Goggles), and the billboard 1236 includes an electronic display controlled to generate one or more images (or components or elements thereof) suitable for capture utilizing the image recognition technology or application. The one or more images can be controlled, for example, to include components or elements which are captured by an image capture device and decoded by the image recognition technology or application to provide a resource (e.g., URL) or other information.

Example methodologies and technologies described herein involve the provision or utilization of identifier information (e.g., an identifier) in relation to one or more communications and/or transactions. For example, the identifier information is applied to determine and/or provide one or more communication and/or transaction amounts associated with or in association with one or more communications and/or transactions pertaining to, involving, or in relation to one or more transportation infrastructures. In example embodiments, the identifier information includes one or more identifiers at least one of which is mobile, floating, or transportable (e.g., in relation to a vehicle).

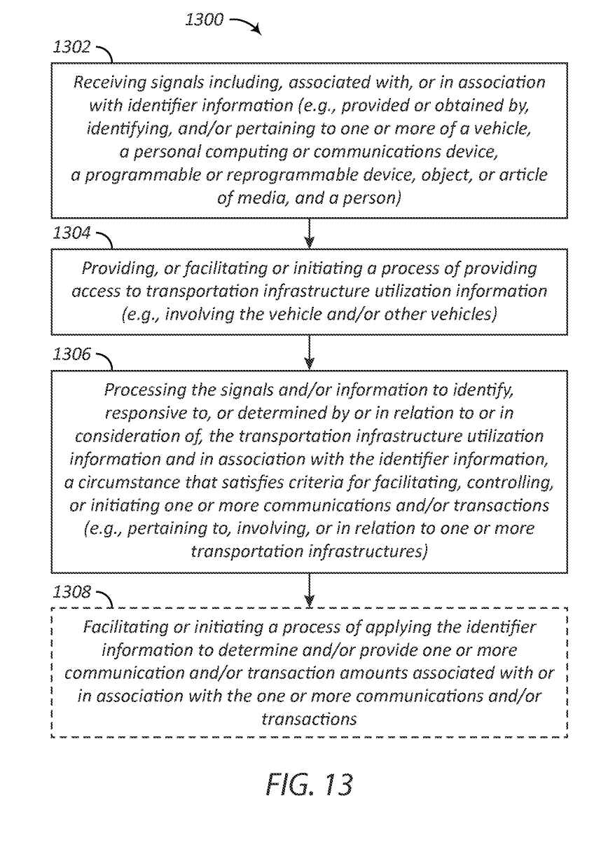

FIG. 13 shows an example embodiment of a method 1300 for monitoring, managing, and facilitating communications and/or transactions relating to transportation infrastructure utilization. The method includes, at 1302, receiving signals including, associated with, or in association with identifier information (e.g., provided or obtained by, identifying, and/or pertaining to one or more of a vehicle, a personal computing or communications device, a programmable or reprogrammable device, object, or article of media, and a person). At 1304, transportation infrastructure utilization information (e.g., involving the vehicle and/or other vehicles) is provided, a process of providing access to transportation infrastructure utilization information is facilitated or initiated. At 1306, the signals and/or information are processed to identify, responsive to, or determined by or in relation to or in consideration of, the transportation infrastructure utilization information and in association with the identifier information, a circumstance that satisfies criteria for facilitating, controlling, or initiating one or more communications and/or transactions (e.g., pertaining to, involving, or in relation to one or more transportation infrastructures). In example embodiments, the method 1300 further includes, at 1308, facilitating or initiating a process of applying the identifier information to determine and/or provide one or more communication and/or transaction amounts associated with or in association with the one or more communications and/or transactions (e.g., controlling or utilizing one or more electronic communications and/or display devices to facilitate or initiate a process of applying the identifier information to determine and/or provide one or more communication and/or transaction amounts associated with or in association with the one or more communications and/or transactions).

Thus, in an example embodiment, a method for monitoring, managing, and facilitating communications and/or transactions relating to transportation infrastructure utilization includes: receiving signals including, associated with, or in association with identifier information provided or obtained by, identifying, and/or pertaining to one or more of a vehicle, a personal computing or communications device, a programmable or reprogrammable device, object, or article of media, and a person, the signals including or providing, or facilitating or initiating a process of providing access to transportation infrastructure utilization information (e.g., involving the vehicle and/or other vehicles); and processing the signals and/or information to identify, responsive to, or determined by or in relation to or in consideration of, the transportation infrastructure utilization information and in association with the identifier information, a circumstance that satisfies criteria for facilitating, controlling, or initiating one or more communications and/or transactions pertaining to, involving, or in relation to one or more transportation infrastructures. The information includes, for example, one or more inputs and/or parameters for one or more communications and/or transactions involving, associated with, and/or facilitated in association with the identifier information). In an example embodiment, the one or more inputs and/or parameters determine, adjust, and/or facilitate establishing a cost associated with at least one communication and/or transaction in consideration of and/or to incentivize one or more of, for example: a desired (specified, or otherwise determined) (amount or character of an) infrastructure utilization (e.g., to control traffic flow by influencing the cost of travel), and a redirection, a change of location, and/or a redistribution of one or more users or prospective users of a transportation infrastructure or infrastructures in relation to one or more marketplaces (e.g., redirect vehicles and thus vehicle occupants toward merchant stores and/or service providers requesting additional business, in response to an indication/determination of additional inventory, restocked goods, service times/appointments available, cancelations, open tables, etc.).

In an example embodiment, the method further includes controlling or utilizing one or more electronic communications and/or display devices to facilitate or initiate a process of applying the identifier information to determine and/or provide one or more communication and/or transaction amounts associated with or in association with the one or more communications and/or transactions. In an example embodiment, controlling or utilizing one or more electronic communications and/or display devices includes providing access to or utilizing a custom add-in or plug-in system application which functions as an extension and overlay to an existing system application or other platform that facilitates one or more of, for example: traffic management, vehicle navigation, and communications and/or transactions relating to transportation infrastructure and/or marketplace utilization.

In example embodiments, the received signals include or facilitate or initiate a process of providing access to information provided or obtained by, identifying, and/or pertaining to a vehicle, a personal computing or communications device, an entity, and/or a person. For example, information (e.g., identifier information) is transmitted upon entry into and exit from a segment or other portion of a transportation infrastructure (e.g., a section of a metropolitan roadway/highway that is congested). In this regard, a location associated with identifier information (e.g., an identifier) can be included in information provided by the transmitted signal. For example, a location associated with the identifier information can be designated or updated to be the location of an electronic or other device obtaining (e.g., reading and decoding information provided by the transmitted signal to obtain) the identifier information. For example, a location associated with the identifier information can be designated or updated to be the location (determined, for example, utilizing GPS) of a mobile device transmitting or receiving the identifier information. Independent of the source of the received signals (i.e., the device transmitting or otherwise providing the signals), in example embodiments, the identifier information is, or includes or provides, vehicle identification information (e.g., VIN). In example embodiment, the step of receiving signals can include receiving signals generated or transmitted by at least one electronic device that includes one or more of, for example: an electronic tracking device, a mobile telephone, a smartphone, or one or more computing or communications devices, a device that generates, transmits, or reads code and/or other information in relation to providing or obtaining the identifier information, an authorized or approved source or device, a processor or controller, a biometric data acquisition device, a user-input mechanism, a RFID device, a NFC device, a camera, a code reader or generator, and a parking meter.

The criteria for facilitating, controlling, or initiating one or more communications and/or transactions pertaining to, involving, or in relation to one or more transportation infrastructures can depend upon (e.g., are a function of) one or more of, for example: the transportation infrastructure utilization information (e.g., transportation infrastructure utilization information involving the vehicle and/or other vehicles), times (e.g., intervals of time) and/or locations (actual, tracked, reported, etc.) of transportation infrastructure utilization by a vehicle (and/or other vehicles), and a transportation infrastructure use or utilization history or predicted future utilization (e.g., associated with the vehicle and/or other vehicles). In example embodiments, times and/or locations of transportation infrastructure utilization by a vehicle are identified by or associated with the identifier information. The criteria can depend upon a status, a condition, an event, an indication, or an interrupt associated with one or more of, for example: a transportation infrastructure or infrastructures, a vehicle (e.g., identified by or associated with the identifier information) and/or other vehicles, an owner, a driver, a custodian, or a passenger of the vehicle, and a person, an animal, or an object within, secured to, or transported by the vehicle.

The criteria can additionally, or alternatively, depend upon a status, a condition, an event, an indication, or an interrupt associated with one or more of, for example: a personal computing or communications device (or other “auxiliary device”), an entity, and a person (e.g., a device, entity, or person identified by or associated with the identifier information) (e.g., a device, entity, or person associated with the vehicle).

In example embodiments, the one or more inputs and/or parameters determine, adjust, and/or facilitate access to, or communication of, a transportation infrastructure (or infrastructures) utilization protocol that determines costs associated with use or utilization of portions of a transportation infrastructure (or infrastructures) by one or more users or prospective users of the transportation infrastructure (or infrastructures) in relation to one or more of, for example: adjusting traffic flow on one or more portions of the transportation infrastructure (or infrastructures), and preventing or decreasing accidents associated with the transportation infrastructure (or infrastructures) or one or more portions thereof (in relation, for example, to an identified, determined, and/or predicted circumstance).

In example embodiments, a transportation infrastructure(s) utilization protocol determines costs associated with use or utilization of portions of a transportation infrastructure (or infrastructures), for example, depending upon traffic flow on one or more portions of the transportation infrastructure (or infrastructures) and/or the circumstance or other inputs and/or parameters (e.g., as described herein). In example embodiments, a transportation infrastructure(s) utilization protocol utilizes, provides, and/or updates one or more of, for example: infrastructure utilization instructions, rules, guidelines, cautions, and recommendations (e.g., to drivers).

The one or more communications and/or transactions can involve usage or utilization by the vehicle (and/or other vehicles) of one or more of, for example: a transportation infrastructure (or infrastructures) or multiple different portions (e.g., segments, areas, regions) thereof, a parking facility or space, and a storage facility or space.

In example embodiments, the one or more communication and/or transaction amounts are associated with one or more of, for example: the vehicle, a personal computing or communications device (or other “auxiliary device”), a person (e.g., an owner, a driver, a custodian, or a passenger of the vehicle) or entity associated (e.g., biometrically or otherwise) with the vehicle, and an event, activity, or enterprise involving or associated with usage or utilization of a transportation infrastructure (or infrastructures).

The circumstance satisfying criteria for facilitating, controlling, or initiating one or more communications and/or transactions pertaining to, involving, or in relation to one or more transportation infrastructures can be (or include or involve) an identification, a determination, and/or a prediction (e.g., of a status) associated with one or more of, for example: a transportation infrastructure (or infrastructures) or one or more portions thereof, the vehicle (and/or other vehicles), a person (e.g., an owner, a driver, a custodian, or a passenger of the vehicle), an animal, or an object associated (e.g., biometrically or otherwise) with the vehicle, one or more users or prospective users of the transportation infrastructure (or infrastructures), and an event, activity, or enterprise involving or associated with the transportation infrastructure (or infrastructures) (and/or usage or utilization of one or more portions thereof).

The circumstance can include, involve, or relate to one or more of, for example: time intervals (e.g., location-specific) when there is a high incidence of accidents (e.g., times when drivers on a particular portion of transportation infrastructure face the sun), locations where there is a high incidence of accidents (e.g., blind drives), locations/times where there is a high risk of accidents (e.g., involving pedestrians/animals based on database/record of such accidents) (e.g., locations adjacent to or near playgrounds, for example, during school hours and when children and parents are arriving and departing) (e.g., locations adjacent to or near college bars, for example, at or around closing time, certain nights of the week, after sporting events), and environmental/emergency/other conditions (e.g., inclement weather, fog, high winds, etc.). By way of example, in response to an identification, a determination, and/or a prediction involving a particular circumstance, a process of adjusting (e.g., reducing) speed limits can be determined, initiated, or scheduled in relation to particular locations of the transportation infrastructure and communicated (e.g., automatically) to drivers in or approaching such locations.

The circumstance can include, involve, or relate to a person. In example embodiments, such a circumstance is identified or determined utilizing one or more of, for example: information pertaining to the person (e.g., accessed from a database), measurements associated with the person (e.g., telemetry or other sensed data), one or more times (and/or time intervals), and one or more locations (and/or areas). For example, by monitoring the output of a motion sensor (e.g., an accelerometer or the like configured to detect vehicle motion) a circumstance involving driver inputs, or lack thereof, consistent with a state of driver fatigue can be identified (e.g., in real time), and a process of alerting the driver can be automatically initiated (e.g., a process that includes, for example, overriding the vehicle's sound system to immediately generate an audible alert). Such a process can include providing alerts or communications to nearby drivers as well (e.g., an audible message stating, “Caution: Tired or Impaired Driver Ahead; silver Mercedes; 300 meter ahead”). An amount of time that a person has been driving can be monitored to determine, for example, if the driver has exceeded a maximum number of hours of continuous driving or total number of hours in a given day or other time interval considered safe. The times of transportation infrastructure use by a person can be monitored to determine, for example, whether the person is driving during at permitted times (e.g., in relation to a driver with a restricted license, or a provisionally permitted driver who, for example, is not allowed to drive after sunset).

Example embodiments herein involve the control or provision of methodologies and technologies for controlling (or mitigating) accidents (e.g., as a function of time). In example embodiments, a circumstance (or other information or data) including, involving, or relating to a vehicle, one or more drivers or passengers of the vehicle, and/or cargo carried by the vehicle is monitored (e.g., non-intrusively) in relation, for example, to a process of notifying the driver (and possibly law enforcement personnel) if an unsafe situation is identified. By way of example, such a process can include or utilize a transportation infrastructure(s) utilization protocol (e.g., directed toward accident prevention or mitigation) and one or more circumstances pertinent to the protocol (e.g., a circumstance defined or specified in, or considered pursuant or in relation to, the protocol) (e.g., a circumstance that appears to involve the onset of driver fatigue).

Telemetry can also play a role in such a system or method. For example, if telemetry indicates that a driver is experiencing a condition (e.g., a heart attack, intoxication, fatigue) that is likely (or highly likely or certain) to interfere with the person's ability to drive safely, a process (e.g., controlling or influencing transportation infrastructure utilization) can be determined, initiated, or scheduled (e.g., in relation to particular locations of the transportation infrastructure). In example embodiments, inputs and/or commands are automatically provided or applied in relation to a process involving one or more of, for example: repositioning other (nearby) vehicles to increase the distance between the other vehicles and the driver (associated with the received telemetry information), and providing an interrupt, a warning, an alert, an alarm, a beacon, an SOS, or other communication or command. For example, upon receipt of telemetry information indicating a condition of driver intoxication, an action or process (or protocol) is activated, initiating a response involving one or more of: repositioning (distancing) nearby vehicles, providing control commands to maneuver the vehicle of the intoxicated driver to a safe location at the side of the road (avoiding other vehicles during the maneuver), providing a notification to the intoxicated driver that the vehicle is now being remotely controlled to ensure the safety of the driver and other vehicles, and activating or dispatching (e.g., to the safe location, perhaps to arrive in advance of the intoxicated driver's vehicle) personnel (and/or apparatuses or devices) involving or in relation to a responder function (or interest) or an information collection and/or dissemination process, procedure, or protocol (e.g., in relation to one or more of law enforcement agencies/actions, paramedic or other emergency responders/responses, data collection, scene recording, and an automated or other generation or provision of instructions, information, interfaces, prompts, and legal or other disclosures or statements).

Signals (e.g., including telemetry, measurements, or other data) can be generated or provided by one or more of, for example: an on-board transmitter and “an auxiliary device” (e.g., as described herein). In an example embodiment, a communications or other functionality of a primary device (e.g., the on-board transmitter) is replicated by a secondary device (e.g., the “auxiliary device”) or, alternatively, the secondary device is automatically activated (e.g., to assume control of one or more functions of the primary device) if a particular input or inputs is provided and/or one or more circumstances are identified (e.g., an inoperative condition or status of, or malfunction associated with, the primary device). Such a system could prove to be particularly helpful if, for example, an on-board (primary) device (e.g., which functions to transmit important driver-, passenger-, and/or health-related telemetry) malfunctions.

Example methodologies and technologies described herein involve controlling traffic flow utilizing an automated (or semi-automated) process of influencing the cost of travel. By way of example, a vehicle driving on a metropolitan roadway/highway transmits or otherwise provides identifier information (e.g., the VIN of a vehicle) upon entry of a congested section of the roadway/highway. The identifier information can be provided, for example, by one or more electronic devices (e.g., a device that the vehicle is equipped with, or in communication with, or that is carried by a person in the vehicle) configured to transmit or otherwise provide the identifier information. In this example, a transportation infrastructure includes the metropolitan roadway/highway. Portions of the transportation infrastructure are configured or otherwise provided with electronic or other devices that receive the identifier information, which is processed in relation to providing a system for controlling traffic flow (e.g., by influencing the cost of travel). A Toll/Fee system can be implemented and/or controlled such that an amount of travel associated with a portion (e.g., a congested portion) of the transportation infrastructure is determined (e.g., utilizing the identifier information). For example, supposing a vehicle if travelling northbound on I-405 North and assuming that traffic slows down at the intersection of I-105, the Toll/Fee system will pick up the VIN of the vehicle and calculates the number of miles of the congested roadway/highway system travelled (by the vehicle) in association with that particular VIN. In example embodiments, an amount or charge (e.g., a congestion charge) is calculated or otherwise determined or provided for the amount of travel associated with one or more portions (e.g., a congested portion) of the transportation infrastructure, and the amount or charge is automatically incorporated into a transactions (e.g., automatically charged and/or added to a total transaction amount). By way of example, upon exiting the roadway/highway and/or entering a less congested portion of I-405, the “congestion charge” will stop. For example, an account associated with the VIN will be charged for travel along sections of I-405 beginning from I-105 and ending on I-210.

The identifier information can includes one or more of, for example: an identifier that is provided or obtained by a device (e.g., an auxiliary device) (or other identifier source, e.g., providing a code) that is not secured to a vehicle (e.g., a motorized or other vehicle that, for practical purposes, is substantially limited to moving within transportation infrastructures and parking facilities and spaces) (e.g., a mobile, floating, or transportable identifier).

The identifier information can include one or more of, for example: an identifier that is selectable (e.g., in order to be activated and/or designated as a primary identifier) (e.g., remotely) from a plurality of (authorized or approved) identifiers, and an identifier that expires after an amount of time (e.g., specified, selected, or otherwise determined) and/or is only usable in a location or area (e.g., specified, selected, or otherwise determined).

The identifier information can include one or more of, for example: an identifier that is activated and/or designated as a primary identifier in response to one or more inputs (for example, voice commands, a manually entered password, a code or biometric input generated by an image capture device), an identifier that is activated and/or designated as a primary identifier in response to an output of a switch or an electronic circuit (for example, an ignition switch and/or an electronic switch that switches on other electronic devices or systems of the vehicle depending on feedback), and an identifier that is activated and/or designated as a primary identifier (e.g., automatically or after a verification input is provided) in response to an indication or determination that another identifier is altered, compromised, damaged, deactivated, disabled, inoperable, malfunctioning, modified, out of range, suspended, unauthorized, unavailable, or unreadable.

The identifier information can include one or more of, for example: an identifier that is activated and/or designated as a primary identifier in response to one or more inputs (for example, voice commands, a manually entered password, a code or biometric input generated by an image capture device), an identifier that is activated and/or designated as a primary identifier in response to an output of a switch or an electronic circuit (for example, an ignition switch and/or an electronic switch that switches on, e.g., applies power to, other electronic devices or systems of a vehicle depending on feedback, e.g., from the ignition lock cylinder of the vehicle), and an identifier that is activated and/or designated as a primary identifier (e.g., automatically or after a verification input is provided) in response to an indication or determination that another identifier is altered, compromised, damaged, deactivated, disabled, inoperable, malfunctioning, modified, out of range, suspended, unauthorized, unavailable, or unreadable.

The identifier information can include one or more identifiers (e.g., multiple identifiers) (e.g., multiple different identifiers) at least one of which is mobile, floating, or transportable in relation to a vehicle.

The identifier information can include a “primary identifier” which means an authorized/approved identifier that is activated or otherwise permitted to operate at present. The identifier information can include a “secondary identifier” which means an authorized/approved identifier that is not activated or otherwise permitted to operate at present.

The identifier information can include an “imprimatur identifier” which means any authorized/approved identifier that is activated or otherwise permitted to operate at present.

The identifier information can include one or more of, for example: multiple identifiers, multiple (different) identifiers only one of which is operable, or activated or authorized to serve, at a given time, as a primary identifier (i.e., multiple different identifiers that are mutually exclusive in respect to being operable, or activated or authorized to serve, at a given time, as an identifier), multiple (different) identifiers at least one of which is operable, or activated or authorized to serve(e.g., as an imprimatur identifier), multiple (different) identifiers, members of which are changeably assigned statuses as a primary identifier (which means an authorized/approved identifier that is activated or otherwise permitted to operate at present) and one or more secondary identifiers (which means authorized/approved identifiers that are not activated or otherwise permitted to operate at present), respectively (e.g., implemented, for example, utilizing access tokens, keys, security descriptors, floating or concurrent licensing technology, or a distributed contents keys scheme), and both a primary identifier (e.g., information provided or obtained by, identifying, and/or pertaining to a vehicle, such as VIN) and a secondary identifier (e.g., information provided or obtained by, identifying, and/or pertaining to a personal computing or communications device or other “auxiliary device”, an entity, and/or a person.

The identifier information can include one or more of, for example: multiple different identifiers (e.g., differing in type and/or providing distributed contents), multiple different identifiers, at least one which includes, or facilitates or initiates a process of accessing, information provided or obtained by, identifying, and/or pertaining to a vehicle (such as VIN), multiple different identifiers, at least one which is provided or obtained by a personal computing or communications device or other “auxiliary device” (which, in an example embodiment, is only assigned imprimatur or primary identifier status when the ignition switch to the vehicle is turned off and/or when the device is identified or otherwise determined to be relocated or repositioning away from the vehicle), and multiple different identifiers, at least one which is provided or obtained by a biometric data acquisition device (e.g., utilized to obtain a person's biometric information), a user-input mechanism, a RFID device, a NFC device, a camera (or other image capture device), and/or a code reader or generator.

With reference to FIG. 13, in example embodiments, the method for monitoring, managing, and facilitating communications and/or transactions further includes facilitating or initiating a process of presenting a visual representation (e.g., controlling an electronic display to generate a visual representation) of one or more of, for example: the signals and/or information, the identifier information, the transportation infrastructure utilization information, times and/or locations of transportation infrastructure utilization by the vehicle, the circumstance, one or more of the criteria, a transportation infrastructure or infrastructures, a parking facility or space (or multiple parking facilities or spaces), and/or a merchant store (or multiple merchant stores) (e.g., associated or affiliated with a transportation infrastructure or a parking facility or space), one or more vehicles (e.g., a vehicle identified by or associated with the identifier information), an acknowledgement that a start time, a stop time, and/or an association between the vehicle and one or more communications and/or transactions has been established, one or more communications and/or transactions pertaining to, involving, or in relation to the vehicle and one or more transportation infrastructures, the one or more electronic communications and/or display devices, the one or more communication and/or transaction amounts, a prompt or request for additional information or user inputs, information and/or instructions, a notification, and a warning.

In example embodiments, the method for monitoring, managing, and facilitating communications and/or transactions further includes providing or accessing information pertaining to one or more of, for example: a transportation infrastructure or infrastructures (e.g., in relation to a past/present/predicted, time-specific, and/or a shared transportation infrastructure utilization, transportation infrastructure(s) utilization protocols, updates/changes to same) (e.g., congested times/locations), a vehicle (e.g., identified by or associated with the identifier information) (and/or other vehicles), one or more communications and/or transactions relating to transportation infrastructure utilization (e.g., by the vehicle and/or other vehicles), one or more communications and/or transactions involving, associated with, and/or facilitated in association with the identifier information), an owner, a driver, a custodian, or a passenger of the vehicle, a person, an animal, or an object within, secured to, or transported by the vehicle, a person, an entity, an object, a status, a condition (e.g., an unsafe condition), an event, an indication, or an interrupt associated with the vehicle, the circumstance, and a location, an area, a region, or an environment within which the vehicle is located, or that the vehicle is approaching or departing from. In example embodiments, the information is provided to one or more of, for example: a law enforcement agency, a government agency, a state, a county, a city, a town, or a municipality, a company or other private-sector entity or organization (e.g., owner or operator of a transportation infrastructure or infrastructures), an individual or a group provided with an authorized or approved device, an owner or a registered owner of the vehicle, and a person authorized or approved by the owner and/or the registered owner.

In example embodiments of the method for monitoring, managing, and facilitating communications and/or transactions, the notification pertains to one or more of, for example: a transportation infrastructure or infrastructures, a vehicle (e.g., identified by or associated with the identifier information) (and/or other vehicles) (e.g., in relation to a past/present/predicted, time-specific, and/or a shared transportation infrastructure utilization, transportation infrastructure(s) utilization protocols, updates/changes to same) (e.g., congested times/locations), one or more communications and/or transactions relating to transportation infrastructure utilization (e.g., by the vehicle and/or other vehicles), and one or more communications and/or transactions involving, associated with, and/or facilitated in association with the identifier information.

In example embodiments of the method for monitoring, managing, and facilitating communications and/or transactions, the notification pertains to one or more of, for example: a parking violation and/or a moving violation associated with one or more of a transportation infrastructure or infrastructures, the identifier information, the vehicle, an owner, a driver, a custodian, or a passenger of the vehicle, and a person within or transported by the vehicle.

In example embodiments of the method for monitoring, managing, and facilitating communications and/or transactions, the notification pertains to one or more of, for example: a crime, criminal activity, illegal action, prohibited substance, criminal record or notice and/or conviction associated with one or more of a transportation infrastructure or infrastructures, the identifier information, the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle.

In example embodiments of the method for monitoring, managing, and facilitating communications and/or transactions, the notification pertains to one or more of, for example: a location and/or a movement of the vehicle.

In example embodiments of the method for monitoring, managing, and facilitating communications and/or transactions, the notification pertains to one or more of, for example: locations and/or movements of one or more vehicles associated with a person, persons, entity, object, group, organization, event, enterprise, and/or circumstance.

In example embodiments of the method for monitoring, managing, and facilitating communications and/or transactions, the notification pertains to one or more of, for example: an event for or during which a location of the vehicle or a person, an animal, or an object within, secured to, or transported by the vehicle presents or potentially raises a concern in relation to the event.

In example embodiments of the method for monitoring, managing, and facilitating communications and/or transactions, the notification pertains to one or more of, for example: an area, a region, or an environment designated as prohibited, unlicensed, limited, restricted, or cautionary access in relation to one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle.

In example embodiments of the method for monitoring, managing, and facilitating communications and/or transactions, the notification pertains to one or more of, for example: an area, a region, or an environment designated as allowed, permitted, licensed, unlimited, unrestricted, or safe access in relation to one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle.

In example embodiments of the method for monitoring, managing, and facilitating communications and/or transactions, the notification pertains to one or more of, for example: a registration, a driver's license, and/or an insurance policy associated with one or more of the vehicle, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle.

In example embodiments of the method for monitoring, managing, and facilitating communications and/or transactions, the notification pertains to one or more of, for example: vehicle registration requirements for new residents of the state.

In example embodiments of the method for monitoring, managing, and facilitating communications and/or transactions, the notification pertains to one or more of, for example: information and/or updates to information in a navigation or navigation system database, a law enforcement database, a DMV database, an insurance database, and a lienholder database, a transportation infrastructure database, a parking facility database, a storage facility database, an impound facility database, and a vehicle transport service database, or other database.

In example embodiments, the method for monitoring, managing, and facilitating communications and/or transactions further includes adding information to a database and/or using the information to update a database, the information pertaining to one or more of, for example: a transportation infrastructure or infrastructures, a vehicle (e.g., identified by or associated with the identifier information) (and/or other vehicles), one or more communications and/or transactions relating to transportation infrastructure utilization (e.g., by the vehicle and/or other vehicles), one or more communications and/or transactions involving, associated with, and/or facilitated in association with the identifier information, one or more communications and/or transactions involving the vehicle, an owner, a driver, a custodian, or a passenger of the vehicle, a person, an animal, or an object within, secured to, or transported by the vehicle, a person, an entity, an object, a status, a condition, an event, an indication, or an interrupt associated with the vehicle, the circumstance, and a location, an area, a region, or an environment within which the vehicle is located, or that the vehicle is approaching or departing from.

In example embodiments, the method for monitoring, managing, and facilitating communications and/or transactions further includes adding to or modifying the information, the circumstance, and/or the criteria in response to an input or inputs provided by one or more authorized or approved sources and/or devices (e.g., such as those described herein providing interrupts and/or commands to the electronic devices 1000 and 1001). Example methodologies and technologies described herein involve incentivizing a redirection of traffic flow in relation to one or more marketplaces utilizing an automated (or semi-automated) process. In example embodiments, marketplace participants (e.g., merchant stores) are afforded opportunities (e.g., via an electronic or interactive interface or other electronic platform) to control or influence the manner in which messages or other content are communicated or transmitted (e.g., in relation to an infrastructure(s)/marketplace(s) environment and/or participants thereof). For example, participants of a marketplace (which, in example embodiments, can include transportation infrastructure(s) or portions thereof) are provided with access to an interface that allows a participant such as a merchant (or merchant store) to broadcast an offer, message, advertisement, or other communication seeking to direct or redirect the movement of vehicles (or traffic flow) within the infrastructure(s)/marketplace(s) environment. Participants can include one or more of, for example: members of an electronic marketplace, and non-member participants (e.g., participants paying to access and utilize the electronic marketplace on a “as needed”, a la carte, or other basis).

Referring to FIG. 12, in this example depiction, the merchant stores 1234a and 1234b (denoted “MS#1” and “MS#2”, respectively) are located as shown in infrastructure areas 1202 and 1204, respectively. In example embodiments, merchant stores and/or other participants (e.g., members of an infrastructure(s)/marketplace(s) environment) are provided with access to an interface or the like that allows them to prepare messages, advertisements, offers, or other communications (e.g., to be broadcast throughout one or more infrastructure(s)/marketplace(s) environments) and to control (e.g., schedule and/or initiate) transmission of such messages, advertisements, offers, or other communications. By way of example, MS#2 wishes to promote a sales event (e.g., that starts Saturday at 9:00 a.m.) and schedules a message announcing the sale to be broadcast (e.g., every half hour on Saturday starting at 6:00 a.m.) in a manner (e.g., with sufficient power) to attract potential customers (e.g., within a distance from MS#2 encompassing Infrastructure Area #1). Accordingly, in this example, the driver of vehicle 1208 may receive the message (e.g., hear and/or read the message) beginning at at location “A” (i.e., upon entering Infrastructure Area #1). In this example, if the driver responds to the message by driving through Infrastructure Area #1, driving through Infrastructure Area #2, parking in Infrastructure Area #3, and making a purchase at MS#2, each of these actions can serve as the basis for a transaction, or several of them can be combined or aggregated in relation to determining an overall transaction (for example, actions associated with Infrastructure Area #2 being considered in relation to an infrastructure area-specific transaction or transaction).

In example embodiments, merchant stores pay for a service of transmitting or otherwise providing potential customers with messages, advertisements, offers, or other communications. By way of example, a merchant store (e.g., MS#1) is charged an amount for each vehicle (or person) receiving a communication regarding MS#1 and/or provided at its behest. The communication can include, for example, an advertisement promoting MS#1 and/or a good or service associated with MS#1. The communication can include, or be initiated or determined in response to, a recommendation or suggestion. The communication can include a reroute instruction/communication.

A merchant store can be charged for communications (e.g., broadcast advertisements) based on other metrics or criteria. For example, a communication that becomes associated with an identifier (e.g., when the communication is received), in now being so associated, represents a potential contribution to a running count of received communications (thereby serving as a basis or alternative mechanism for gauging the effectiveness of a particular broadcast or broadcast campaign). The identifier may be obtained at multiple different times and in different ways in relation, for example, to determining an amount that a merchant store is to be charged. For example, an identifier may be provided or obtained when entering a parking lot/structure of or associated with the store (e.g., Infrastructure Area #3/MS#2) and/or in association with other actions involving or in relation to the store. By way of example, an identifier (e.g., relocated from an identifier source or carrier of the vehicle to a mobile communications device of the driver) can be provided or obtained when entering the merchant store (e.g., via an identifier reader located at the entrance). Such an identifier can be provided in response to a determination that the recipient of a particular communication is now near an advertised good on display or the location where an advertised service is offered, or has arrived at a location relevant to an advertised good or service (e.g., as determined based on proximity of the mobile communications device to an electronic device positioned near, secured to, and/or associated with the good or service). The identifier can be provided or obtained in association with one or more actions or processes involving a resource locator (e.g., attendant to a process of capturing and decoding a URL utilizing an image capture device). In example embodiments, the identifier can only be directly provided or obtained (e.g., captured from a merchandise tag by code reader software running on a smartphone). The identifier can be provided or obtained via one or more actions or processes pertaining to a transaction (e.g., confirmation of an amount to be charged by a recipient of the advertisement). The identifier can be provided or obtained via one or more actions or processes pertaining to and/or performed in association with MS#1 (e.g., a purchase or evaluation of a good or service promoted in a scheduled broadcast or in other communications).

The methodologies and technologies described herein also facilitate direction of potential consumers to merchant stores that are not ideally or advantageously located with respect to being easily noticed by vehicle drivers (and/or passengers). For example, in FIG. 12, when the vehicle is traveling along the alternative route 1232 (e.g., as shown at location “C”), MS#1 is located around a sharp turn 1238 and on the left side of the road in relation to the direction of travel of the vehicle. By way of example, the control/processing center 1210 detects the location of the vehicle (e.g., utilizing GPS-derived location information associated with or in association with an identifier) a sufficient distance ahead of the turn 1238, identifies a member and/or participant associated with the vehicle (e.g., utilizing the identifier to access a database that correlates identifiers associated with vehicles to owners and/or drivers of each vehicle), and transmits, or facilitates or initiates, a communication to an identified member and/or participant such as, “MS#1 is just ¼ mile away, turn left immediately after approaching curve. Free parking!” In example embodiments, a merchant is charged a fee (e.g., a feed tariff) in relation to an electronic service (such as described above) that helps to bring more customers into a retail store, increase the amount of foot traffic, etc.

In example embodiments, a member and/or participant (e.g., of one or more marketplaces) or other potential purchasers of goods and/or services, such as the driver of the vehicle 1208, can be identified utilizing location-specific and/or other criteria-dependent criteria (e.g., as described herein).

Alternatively (or additionally), such a communication or a similar communication can be generated (e.g., in the form of a pop-up notification or other message communicated to the driver) in response to receipt of a resource of other locator by (e.g., via an electronic device) a driver or passenger of the vehicle. For example, a resource of other locator (such as a URL) is decoded or otherwise obtained from an image (e.g., on BB#1) that is captured (e.g., by Google Goggles) when a driver or passenger of the vehicle looks at an object (in this example, BB#1) providing the image. Accordingly, in example embodiments, advertisements or other communications (e.g., targeted communications) to drivers and/or passengers of vehicles can be initiated or provided directly to a recipient (or, to put it another way, differently than communications effected by or potentially involving the control/processing center). In example embodiments, an advertisement or other communication can be targeted or directed toward a specified or otherwise determined subset of potential recipients (e.g., among a group of marketplace participants). For example, a communication (e.g., facilitated by the control/processing center 1210) can be directed toward passengers, particular age groups, and/or one or more individuals known to be in the vehicle (e.g., utilizing one or more identifiers to access a database that correlates identifiers associated with vehicles to owners and/or drivers of each vehicle, their family members, and information about these persons relevant, for example, to identifying members of one or more targeted groups of potential recipients). By way of an additional example, a communication (e.g., facilitated by BB#1) can be directed toward subsets of potential recipients (e.g., utilizing an identifier provided or obtained in association with an attempt by or other action of an electronic device to decode a captured image). For example, an identifier is provided or obtained in association with a request transmitted by an on-board electronic device (e.g., automatically generated) to allow the electronic device to decode the captured image (e.g., providing a decryption or other key to the electronic device, if information obtained utilizing the identifier indicates that the request is from or facilitated by a device associated with a member of a targeted group).

In this manner, an owner or entity associated with a billboard (e.g., BB#1) may also be considered a merchant service provider (for example, a provider of advertising or marketing services). The productivity of such a merchant can be measured (and thusly compensated for on this basis), for example, by the number of looks at the billboard detected (e.g., the number of transmitted requested received), or by the number of hits resulting from utilization (e.g., by unique visitors) of a URL associated with that particular billboard (e.g., for a particular day or other interval of time associated with the broadcasting of a particular advertisement, offer, information, or other communication).

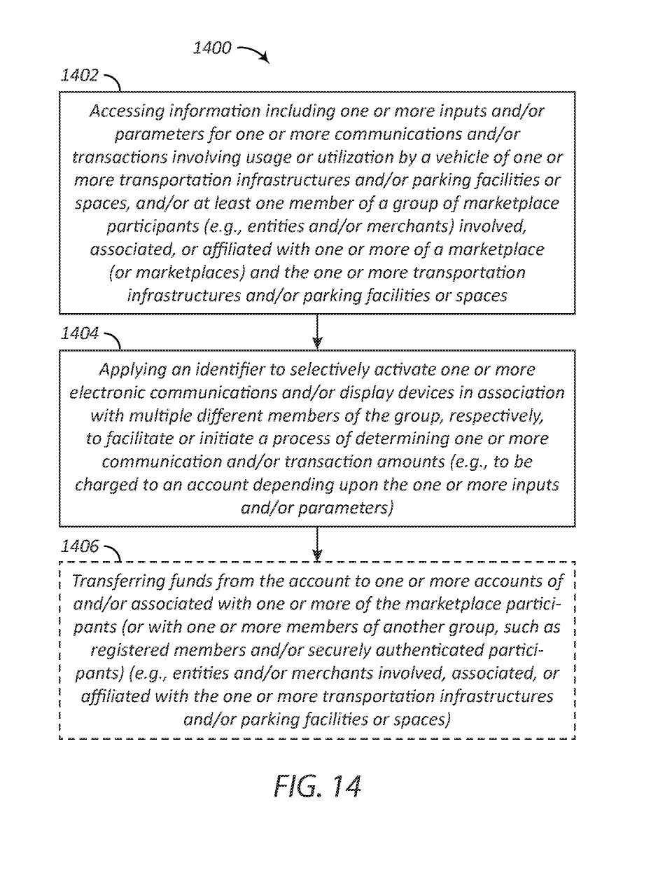

FIG. 14 shows an example embodiment of a method 1400 for monitoring, managing, and facilitating communications and/or transactions relating to infrastructure and/or marketplace utilization. The method includes, at 1402, accessing information including one or more inputs and/or parameters for one or more communications and/or transactions involving usage or utilization by a vehicle of one or more transportation infrastructures and/or parking facilities or spaces, and/or at least one member of a group of marketplace participants (e.g., entities and/or merchants) involved, associated, or affiliated with one or more of a marketplace (or marketplaces) and the one or more transportation infrastructures and/or parking facilities or spaces. At 1404, an identifier is applied to selectively activate one or more electronic communications and/or display devices in association with multiple different members of the group, respectively, to facilitate or initiate a process of determining one or more communication and/or transaction amounts (e.g., to be charged to an account depending upon the one or more inputs and/or parameters). In example embodiments, the method 1400 further includes, at 1406, transferring funds from the account to one or more accounts of and/or associated with one or more of the marketplace participants (or with one or more members of another group, such as registered members and/or securely authenticated participants) (e.g., entities and/or merchants involved, associated, or affiliated with the one or more transportation infrastructures and/or parking facilities or spaces).

Thus, in an example embodiment, a method for monitoring, managing, and facilitating communications and/or transactions relating to infrastructure and/or marketplace utilization includes: accessing information including one or more inputs and/or parameters for one or more communications and/or transactions involving usage or utilization by a vehicle of one or more transportation infrastructures and/or parking facilities or spaces, and/or at least one member of a group of marketplace participants (e.g., entities and/or merchants) involved, associated, or affiliated with one or more of a marketplace (or marketplaces) and the one or more transportation infrastructures and/or parking facilities or spaces; and applying an identifier to selectively activate one or more electronic communications and/or display devices (e.g., devices that provide or obtain an identifier) in association with multiple different members of the group (of marketplace participants), respectively, to facilitate or initiate a process of determining one or more communication and/or transaction amounts to be charged to an account depending upon the one or more inputs and/or parameters.

In example embodiments, the one or more inputs and/or parameters determine, adjust, and/or facilitate establishing a cost associated with at least one transaction or prospective transaction in consideration of and/or to incentivize one or more of, for example: a desired (e.g., specified, or otherwise determined) transportation infrastructures and/or parking facilities or spaces utilization, a redirection, a change of location, and/or a redistribution of one or more users or prospective users of the one or more transportation infrastructures and/or parking facilities or spaces in relation to one or more entities and/or merchants (e.g., among the marketplace participants), and a redirection, a change of location, and/or a redistribution of one or more customers or prospective customers of the marketplace (e.g., in relation to one or more of the entities and/or merchants who are members of the marketplace).

In example embodiments, at least one of the inputs and/or parameters (e.g., for at least one communication and/or transaction) is associated with or established in association with an identifier or one or more identifiers (such as the identifiers previously described herein). In an example embodiment, at least one of the inputs and/or parameters is associated with or established in association with an identifier provided or obtained by, identifying, and/or pertaining to one or more of, for example: the vehicle, a personal computing or communications device or other auxiliary device, an entity, and a person. The inputs and/or parameters can be provided, for example, by an on-board transmitter and “an auxiliary device” (e.g., operable only one at a time, freeing a person to leave their vehicle to go shopping or pursue other or additional transactions). By way of example, a primary identifier (e.g., provided from an identifier source on the vehicle to an identifier reader device at the entrance of a parking facility) is relocated to a personal computing or communications device that a person leaving their vehicle can conveniently carry with them or secure to their clothes or person. An identifier can also relocated to a person, for example, associated with a person's biometric information (e.g., obtained from a retinal scan). To be clear, the retinal scan or other biometric information is not the identifier. Rather, the identifier is associated with information (e.g., biometric information) and, in example embodiments, the identifier is only accessible (e.g., utilizing the biometric information) when the identifier is considered to be “activated” in relation to, for example, a machine, an apparatus, a device, an object, or a sentient entity from which the identifier was obtained. In example embodiments, an identifier remains “associated” with a vehicle independent of the location of a source or carrier of a presently-activated identifier. By way of example, a smartphone configured to function as a source or carrier of an identifier is provided with access to a program that generates a visual representation of the identifier, for example, only when the identifier is presently activated. In the case of an identifier associated with a vehicle, the visual representation of the identifier can include, by way of example, a vehicle-shaped icon accompanied by an audible message such as, “Charge it to the car.” The visual representation can include machine-readable and/or other information utilized to effect one or more portions of a purchase or other transaction in association with the identifier. In example embodiments, a visual representation is provided at one or more electronic or other displays (e.g., at a display of or facilitated by an identifier source or carrier device, and/or at a display accessible to a store employee). In a circumstance when an identifier is no longer activated as to a particular source or carrier, this or another change in status of an identifier can be communicated (e.g., via a text message) to one or more identifier source or carrier devices. Alternatively, or additionally, if the identifier is no longer activated, the visual representation can include, by way of example, a vehicle-shaped icon (perhaps of a different color and/or with an “X” superimposed over the icon) accompanied by an audible message such as, “Charge to car option—not available.”

Example methodologies and technologies described herein involve controlling, providing access to, or utilizing one or more electronic communications and/or display devices in relation to, or to facilitate or initiate, a process of activating and/or providing one or more inputs to a program or application that controls programming and/or reprogramming of the one or more identifiers. For example, one or more electronic communications and/or display devices are controlled or utilized to allow a user to provide inputs to a software application or program that controls a process of programming or reprogramming an identifier (or identifiers) provided by or obtained from one or more of, for example: a programmable or reprogrammable device, object, or article of media, or a vehicle, a personal computing or communications device, or other “auxiliary device” (e.g., which includes, or is operatively connected to, a programmable or reprogrammable device, object, or article of media). For example, an interface can be provided that allows a user to perform actions (e.g., in relation to programming or reprogramming the one or more identifiers) including, inter alia, managing, selecting, or otherwise providing or determining, criteria and/or inputs utilized by or in relation to multiple identifiers.

Example methodologies and technologies described herein involve or facilitate activation of and/or management of the one or more identifiers. For example, one or more electronic communications and/or display devices are controlled or utilized to allow a user to provide inputs to a software application or program that controls a process of managing, selecting, or otherwise providing or determining, criteria and/or inputs utilized by or in relation to multiple identifiers (e.g., activating, deactivating, relocating or reassigning an identifier and/or changing a prioritization as between a plurality of the identifiers). By way of an additional example, an interface can be provided that allows a user to perform actions (e.g., in relation to controlling and/or managing one or more identifiers) including, inter alia, selecting, or otherwise providing or determining, criteria and/or inputs utilized in an automated process for activating and/or deactivating one or more identifiers. Example methodologies and technologies described herein additionally involve facilitating or initiating an action or process of presenting a visual representation of one or more of, for example: the one or more identifiers (e.g., an icon indicating a type of identifier) and a location of at least one of the one or more identifiers (e.g., of an activated primary identifier, or of all activated identifiers).

In example embodiments, processing the signals and/or information includes associating members and/or participants of a marketplace with the identifier information depending upon one or more of, for example: a location (e.g., of a prospective buyer/purchaser location) provided by or determined from the location information (e.g., the location of an identifier as updated, for example, in real time, periodically, when the identifier repositions, when a new search or communication is transmitted, or when a search or other communication is modified), goods and/or services (e.g., a type of goods or services) identified or specified in, or selected (e.g., recommended) in response to, the one or more transaction criteria, and members and/or participants (e.g., sellers, merchants, service providers within a defined proximity of the location) identified as being able to satisfy (e.g., presently satisfy and/or completely or partially satisfy) the one or more transaction criteria. By way of example, a defined proximity can be a close proximity, such as less than a mile, or less than 500 meters.

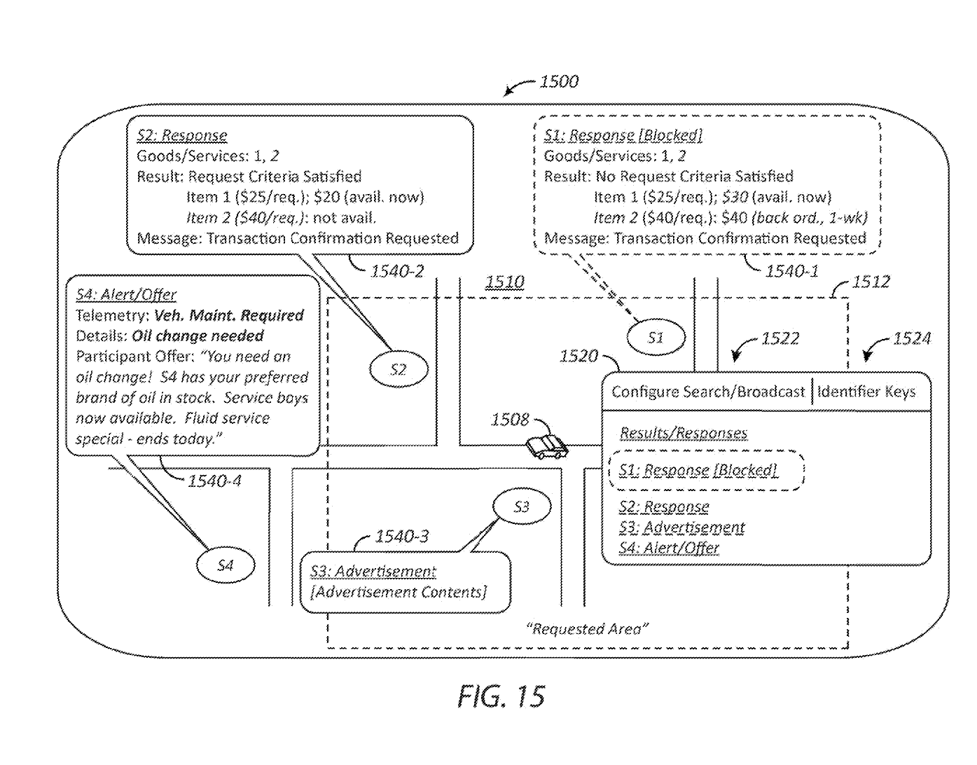

In example embodiments, the processed signals and/or information are utilized to provide an interface, such as the interface 1500 (FIG. 15) that includes a visual representation of an identifier. In this example, a vehicle icon 1508 serves as such a representation and repositions (e.g., in real time, periodically, in response to update requests, and/or as the provision of updated information permits) within a visual representation of an infrastructure(s)/marketplace(s) environment 1510. For example, a real-time market place directly associated with an identifier (e.g., associated with the vehicle), the location of the identifier (in this example, the location of the vehicle), the type of goods and services (e.g., desired or requested in a search by the driver of the vehicle) associated with the identifier, and “eligible” merchants and service providers within a defined proximity of the location of the identifier. By way of example, eligible merchants and service providers are those that have one or more requested goods available in their inventory and/or are able to provide one or more requested services.

The information can include location information defining an area of interest in relation to one or more desired communications and/or transactions. With reference to FIG. 15, in this example, an area 1512 (denoted “Requested Area”) is indicated (e.g., in dashed lines, as in this example) and includes (e.g., bounds, specifies, or defines) a portion of the infrastructure(s)/marketplace(s) environment 1510.

In example embodiments, one or more members and/or participants (e.g., of an electronic marketplace or marketplaces) are identified in response to or in relation to a search or request for one or more goods and/or services. The members and/or participants can be identified, for example, utilizing or in consideration of information previously or presently communicated regarding the members and/or participants or goods and/or services that they are associated with. The identified members and/or participants can include one or more of, for example; one or more sellers (e.g., merchants) of goods identified or determined (e.g., by the seller) (e.g., by access to an inventory database) to have one or more goods requested or otherwise specified in stock (e.g., in their inventory) or ready for delivery, and one or more service providers identified or determined (e.g., by the service provider) (e.g., by access to a service appointment or other database) to be able to accommodate (e.g., service personnel/professionals presently or soon available) or provide one or more services requested or otherwise specified (e.g., by the vehicle owner/driver/passenger associated with the identifier). In example embodiments, marketplace participants can include buyers or purchasers (e.g., Buying Members) as well as sellers and service providers (e.g., “Selling Members”) independent of whether the participants are members of (or registered with) a marketplace (e.g., an electronic marketplace including “Buying Members” and “Selling Members” who can be, but are not necessarily, mutually exclusively categorized as one or the other). Referring to FIG. 15, in example embodiments, the interface 1500 can include one or more areas (or windows or sub-portions) that are controlled (e.g., generated or otherwise provided) in response to or in relation to one or more requested communications and/or transactions. In this example depiction, the interface 1500 includes an area 1520 (denoted “Results/Responses”) and areas 1540-1, 1540-2, 1540-3, and 1540-4 (denoted “S1: Response [Blocked]”, “S2: Response”, “S3: Alert/Offer”, and “S4; Advertisement”, respectively). Further with regard to this example, an owner, driver, and/or passenger (e.g., a “Buying Member”) of a vehicle associated with identifier information (e.g., one or more identifiers) may have a need for specific or particular types of goods or services. In example embodiments, specific and/or particular types of goods or services can be specified, determined, or otherwise described or identified utilizing one or more user interfaces and/or user input mechanisms (e.g., specified by the owner of the vehicle or on the owner's behalf in association with the identifier information). In this example depiction, the display area 1520 includes a pull-down menu 1522 of which the header (denoted “Configure Search/Broadcast”) is shown. In example embodiments, the interface 1500 facilitates (e.g., via a “Configure Search/Broadcast” menu) the application of information and/or inputs in relation to one or more electronic display-facilitated functionalities and/or visual presentations. By way of example, the display area 1520 is initially generated and presented (e.g., such as shown, superimposed over a portion of the infrastructure(s)/marketplace(s) environment 1510) including a list of “Results/Responses” to one or more requests by the driver in relation to one or more communications and/or transactions. In example embodiments, a list or other visual representation of “Results/Responses” is presented in the order received (e.g., in descending order starting with most recently received results/responses) and/or depending upon criteria, requirements, preferences, and/or other inputs provided (e.g., utilizing the “Configure Search/Broadcast” menu). In example embodiments, one or more of the visual representations of individual results/responses can include a resource locator (such as a link facilitating activation of another interface area and/or visual presentation). In this example depiction, each of the individual results/responses (denoted “S1: Response [Blocked]”, “S2: Response”, “S3: Alert/Offer”, and “S4; Advertisement”) in the “Results/Responses” column includes a resource locator (e.g., a hyperlink) that allows a user to access additional information such as details regarding an individual result or response and/or one or more criteria, requirements, preferences, and/or other inputs considered in relation, for example, to inclusion of the result/response among the “Results/Responses” presented. By way of example, a resource locator such as a hyperlink within the presented text “S2: Response” is activated (e.g., via a touch screen) and the interface 1500 is controlled to generate the display area 1540-2 which presents details regarding a request for multiple different goods and/or services and one or more criteria, requirements, preferences, and/or other inputs pertaining to or in relation to the request. Accordingly, in example methodologies and technologies described herein, a Buying Member is able to input its desired goods and/or services (e.g., utilizing an interface to specify, determine or otherwise identify one or more criteria, requirements, preferences, and/or other inputs pertaining to or in relation to one or more requested communications and/or transactions involving the desired goods and/or services) and control and/or schedule a process of transmitting a request to any Selling Member providing such goods and/or services.

The one or more interfaces can include, for example, a website or network-facilitated communications interface. In example embodiments, one or more interfaces are provided utilizing and/or in conjunction with one or more of, for example: an on-board navigation system, one or more applications executable on a personal computer (e.g., a custom add-in or plug-in system application which functions as an extension and overlay to an existing system application or other platform), one or more applications executable on a personal communications and/or computing device (such as a smartphone or tablet computer), and a website or other electronic platform or network-facilitated communications interface.

Other Buyer-oriented features are embodied in the methodologies and technologies described herein. In example embodiments, requests (e.g., searches) and/or broadcasts (e.g., targeted or other advertisements, offers, etc.) can be scheduled. For example, a Buying Member can post details (e.g., utilizing an interface provided or accessed via a website to formulate and submit one or more requests) regarding the shopping objectives (e.g., items sought) of an upcoming (e.g., tomorrow morning) shopping excursion, an area the Buying Member plans or is willing to travel within, and a time interval tentatively scheduled for shopping. The next morning, the Buying Member can utilize one or more interfaces (e.g., a home PC and/or a smartphone) to review responses that were received overnight and presented (e.g., offers transmitted overnight by Seller Members who fit/respond to specified criteria).

Referring to FIG. 15, in display areas 1540-1, 1540-2, 1540-3, and 1540-4, Goods/Services shown in italics are optional (i.e., not required items in relation to the requested communication and/or transaction). With regard to S1's Response, in this example, Item 1 (a required item) is not offered at the requested price. Item 2, although an optional item, is associated with conditional criteria specifying that the Buyer is only willing to purchase Item 2 if it is presently available (e.g., in stock). Accordingly, S1's response does not satisfy the criteria of Buyer's purchase request, and S1's Response (as indicated by the dashed line depicting the area 1540-1) is not presented as a search result. By way of example, S1's Response is not provided to the Buyer (e.g., made available to an electronic device associated with the Buyer). Alternatively, S1's Response is received by a device associated with the Buyer but is not displayed (i.e, filtered from the search results). In example embodiments, a user can configure a presentation of results to optionally present responses that do not satisfy or partially satisfy request criteria (e.g., showing such results in a style visually distinct from other presented results, for example, utilizing a translucent and/or different colored border).

If the aforementioned request includes a requirement that requested goods and/or services are available within the “Requested Area”, S2's response partially satisfies such a location requirement. As in the prior example, Goods/Services shown in italics are optional (i.e., not required items in relation to the requested communication and/or transaction). Accordingly, as shown in the display area 1540-2, an indication is provided that S2 can satisfy the request criteria (“Result: Request Criteria Satisfied”) even though Item 2 (of the requested Goods/Services) is not available from S2.

In the preceding example, S2's Response is a communication responding to a broadcast by or on behalf of the Buyer that was received by S2 (e.g., the prior evening). Example embodiments of methodologies and technologies described herein also involve communications and/or transactions targeted to “active” searchers or other participants. By way of an additional example, and referring again to FIG. 15, as the Buyer (whose location is represented by the vehicle icon 1508) drives through the infrastructure(s)/marketplace(s) environment 1510, S3 broadcasts an advertisement that is location-dependent in its targeting (e.g., addressed to “locals only”) and is therefore receivable, for example, only by a device located within the “Requested Area”. Also, in relation to this scenario, the Buyer had previously, for example, designated advertisements from businesses within the “Requested Area” as communications to be presented (e.g., utilizing one or more communications criteria, requirements, and/or preferences). Accordingly, in this example, the Buyer and S3 had specified mutually matching criteria in relation to receipt of the advertisement by the Buyer. As an additional example, assuming that a “Requested Area” (e.g., defined/specified utilizing inputs provided by the Buyer) represented by the display area 1512 is a communications and/or transactions requirement, in example embodiments, communications from S4 located outside the “Requested Area” would not be included in presented search results. However, under a circumstance, for example, where safety may be at issue (e.g., per telemetry information indicating that the vehicle is in need of an oil change), in example embodiments, a search protocol can be overridden (e.g., taking into account the direction of travel of the vehicle in relation to S4) to communicate to the driver a message. In this example, a communication in the form of an Alert/Offer is presented (e.g., as shown in the display area 1540-4) indicating the previous information and additionally including an offer (e.g., a Participant Offer) from S4 (an oil change facility) such as: “You need an oil change! S4 has your preferred brand of oil in stock. Service bays now available. Fluid service special-ends today.”

In example embodiments, a participant (e.g., a Buying Member) is permitted to select communications criteria, requirements, and/or preferences determining whether all (or, for example, one or more filtered subsets) of messages or advertisements are to be received/presented (e.g., in relation to products and/or services needed or desired by the Buyer). In example embodiments, a participant associated with one or more identifiers can block all communications attempted in association with the identifiers. In example embodiments, certain communications override the preferences of some or all participants. By way of example, a free or low cost application (e.g., as described herein) is configured such that participant (e.g., Buyer) preferences are disregarded in relation to receiving unsolicited advertisements (e.g., until the Buyer upgrades to a more expensive or different version of the program). In example embodiments, participants are provided with access to premium features and/or special offers (e.g., targeted offers reserved only for “premium” members). For example, a participant is provided with access to an interface (e.g., via a private website or other platform, or by unlocking features already included in a program) that allows the participant to request (and pay a surcharge to receive or have the option of receiving) premium offers or other content. In example embodiments, information is communicated to participants indicating locations of merchants or other sellers who satisfy one or more criteria in relation to certain products/services or merchandise in their inventory. In example embodiments, Buying Members are provided with the ability to know the location of such Selling Members (e.g., by information transmitted by Selling Members to Buyer Members).

Example methodologies and technologies described herein provide prospective purchasers (e.g., Buying Members) with access to an identifier-facilitated electronic marketplace that allows a prospective purchaser to request bids from merchants or other sellers utilizing the marketplace and compare or evaluate competing bids in consideration of one or more criteria, requirements, and/or preferences (such, for example, one or more location or proximity criteria considered in conjunction with or in relation to one or more time limited or time dependent criteria). For example, real-time bidding/discounting by Selling Members and the ability to connect Buying Members and Selling Members that are within a close proximity of each other stands to dramatically improve a purchaser's efficiency in relation to time allocated to finding desired goods and/or services. Costs savings are likely to result at least for the reason that sellers of the same goods and/or services are competing against each other to provide the prospective purchaser desired goods and/or services at the best price. Moreover, by providing Selling Members with the ability to bid against other, an advantageous position for a Buying Member within their proximity is created.

In example embodiments, one or more persons or entities (such as, for example, agencies or advertisers) are provided with access to a process that facilitates or initiates providing information about merchants or sellers (e.g., Selling Members) (e.g., regarding goods and/or services desired by a Buying Member) independent of whether they are within a close or other specified proximity of a prospective purchaser.

In example embodiments, merchants or sellers can provide information directly or control access to information (e.g., regarding a good or service desired by an actively searching prospective purchaser). For example, a person (e.g., a Buying Member) associated with an identifier is looking for a storage space to store files and documents. An owner or proprietor of a self storage facility (e.g., a Selling Member) is provided, in example embodiments, with the ability to communicate information (to the Buying Member) regarding available spaces and, for example, its “special offering” to a purchaser associated with the identifier.

Example methodologies and technologies described herein involve and/or facilitate targeted messaging. In example embodiments, a marketplace participant (e.g., a Selling Merchant) is provided with access to an interface (e.g., provided via a private website or other platform and/or utilizing a software program or personal computing device application) that allows the participant to submit, by way of example: a (short) text message, a voice message, a video, an image, or other communication (such as, for example, a quick eye-catching advertisement to a device association with an identifier). In example embodiments, targeted messaging or other communications generated, transmitted, or made available (e.g., presented for approval) based upon or in consideration of the a location associated with the identifier and/or one or more criteria, requirements, and/or preferences associated with the identifier (and/or with one or more persons associated with the identifier).

Example methodologies and technologies described herein involve providing information to persons in search of a residential or other property (e.g., in relation to a desired property purchase or rental). For example, a person (e.g., a Buying Member) associated with an identifier is looking for an apartment to rent. Whether driving or on walking, one or more identifiers (e.g., as described herein) can be utilized by, for example, the owner of an apartment building to send information about available units including rents, size or other attributes (or restrictions). In example embodiments, an application and/or interface is provided (e.g., via an apartment finder application for a mobile communications device) that facilitates screening of prospective purchasers/renters by property sellers/lessors, or vice versa. For example, in association with an identifier, a person utilizes the application/interface to control types of information to be shared and/or one or more criteria, requirements, and/or preferences in relation to one or more of, for example: one or more desired properties or rentals, one or more targeted areas, prices or price ranges of properties or rental, terms of purchase or lease, a prospective purchaser or renter, a prospective seller or lessor, and persons residing in or associated with the one or more targeted areas. In an example embodiment, a circumstance can be defined (e.g., a mutual match in criteria specified by a prospective renter and landlord, respectively) in response to which financial or other information (for example, a FICO score) is automatically communicated to the landlord, which could serve to favorably distinguish a prospective renter from others competing to rent the property.

Example embodiments of methodologies and technologies described herein involve accessing, or facilitating or initiating a process of providing access to, an interface that allows a user to perform actions in relation to activation of and/or management of the one or more identifiers. In example embodiments, the interface-facilitated/identifier-related actions can include, for example: accessing information pertaining to the one or more identifiers (e.g., by activating an interface or a portion thereof. Referring to FIG. 15, in this example depiction, the display area 1520 includes a pull-down menu 1524 of which the header (denoted “Identifier Keys”) is shown. In example embodiments, the identifier-related actions (e.g., also initiated via activation of pull-down menu items) can include one or more of, for example (with example names of menu options noted in quotations): activating a selected identifier (“Activate Selected Key”), deactivating a selected identifier (“Deactivate Selected Key”), adding or creating a new identifier (“Add/Create New Key”, copying or replicating an identifier (“Create Duplicate Key”), changing a prioritization as between a plurality of the identifiers (“Manage Multiple Keys”), managing, selecting, or otherwise providing or determining, criteria and/or inputs utilized by or in relation to multiple (different) identifiers (also via “Manage Multiple Keys”), selecting, or otherwise providing or determining, criteria and/or inputs utilized in an automated process for activating and/or deactivating one or more identifiers (“Configure Automatic Key Activation/Deactivation Options”), managing fund transfers and/or accounts associated with the one or more identifiers (“Manage Key Funding/Accounts”), and managing (potential) communications associated with the one or more identifiers (“Alert Manager”).

By way of example, the identifier-related action of adding or creating a new identifier (“Add/Create New Key”) facilitates utilizing a retinal scanner to associate biometric information with a newly-created identifier (e.g., which, is in turn, associated with an account or other source of funds), thereby providing a person (a child, for example) with a shopping or purchasing experience free of any requirement to carry cash, cards, or even code-generating devices. A new or copied identifier, for example, can be created with use limitations attendant thereto (e.g., including an expiration date and/or a limit as to the credit available in association with the new or copied identifier).

The identifier-related action of relocating or reassigning an identifier (“Move/Reassign/Export Key”) also facilitates relocation of an identifier, for example, in relation to changing vehicles (e.g., providing an identifier to a rental car electronic device).

The identifier-related action of changing a prioritization as between a plurality of the identifiers (“Manage Multiple Keys”) can be utilized, for example, to designate an identifier as a primary identifier thereby automatically de-designating any other authorized/approved identifier (previously designated as a primary identifier) to status as a secondary identifier. As another example, the action of changing a prioritization as between a plurality of the identifiers can include designating multiple identifiers as imprimatur identifiers, i.e., authorized/approved identifiers that are in an activated state or otherwise permitted to operate simultaneously (or presently, or at scheduled or otherwise determined times, respectively).

The identifier-related action of managing, selecting, or otherwise providing or determining, criteria and/or inputs utilized by or in relation to multiple (different) identifiers (also via “Manage Multiple Keys”) relates, in example embodiments, to at least one identifier that is operable, or activated or authorized to serve, as an imprimatur identifier, which refers (for example) to any authorized/approved identifier that is activated or otherwise permitted to operate at present.

The identifier-related action of managing fund transfers and/or accounts associated with the one or more identifiers (“Manage Key Funding/Accounts”) can be utilized in relation to one or more of, for example: adding funds to an account (e.g., associated with or in association with an identifier), adjusting an amount of available funds associated with one or more identifiers, and limiting (or selecting or otherwise designating) the types and/or amounts of transactions allowed in association with a particular identifier or identifiers. For example, an identifier can be managed such that purchases over an amount (say, $25) are prohibited or require a third party approval (e.g., parental) or authorization (e.g., by the bank, entity, or person issuing funds). For example, an identifier can be managed such that its use is limited to food purchases only (e.g., from specified food sellers) and/or to automatically decline purchases of (or requested transactions including), for example, alcohol or tobacco products.

The identifier-related action of managing (potential) communications associated with the one or more identifiers (“Alert Manager”) can be configured, for example, to provide an interface that allows a person to request a communication (e.g., a text message sent to their mobile telephone) as to one or more identifier-related matters or circumstances, for example, notifying the person whenever a transaction, or a particular type of transaction, is made or attempted in association with a particular identifier or identifiers.

With reference to FIG. 14, in example embodiments, the method for monitoring, managing, and facilitating communications and/or transactions relating to infrastructure and/or marketplace utilization further includes facilitating or initiating a process of presenting a visual representation (e.g., controlling an electronic display to generate a visual representation) of one or more of, for example: the information, the one or more inputs and/or parameters, the one or more communications and/or transactions, one or more vehicles (e.g., the vehicle and/or other vehicles), transportation infrastructure utilization information, times and/or locations of transportation infrastructure utilization by the vehicle, marketplace participants, one or more marketplaces, one or more transportation infrastructures and/or parking facilities or spaces, the identifier, the one or more electronic communications and/or display devices, the one or more communication and/or transaction amounts, an acknowledgement that a start time, a stop time, and/or an association between the vehicle and one or more communications and/or transactions has been established, a prompt or request for additional information or user inputs, information and/or instructions, a notification, and a warning.

In an example embodiment, the visual representation is presented at one or more of, for example: a website or other electronically accessible resource, a mobile telephone, a smartphone, or one or more computing or communications devices, a device that generates, transmits, or reads code (e.g., identifying the vehicle, a personal computing or communications device, and/or a person), and a device, interface, or display that is separate from or remotely located in relation to the device that generates, transmits, or reads code. In an example embodiment, the method further includes providing, facilitating, or initiating a communication that includes a resource or other information that provides access to a receipt or other documentation or information relating to a charge to the account associated with one or more of, for example: usage or utilization by the vehicle of one or more transportation infrastructures and/or parking facilities or spaces, and one or more communications and/or transactions involving one or more entities and/or merchants involved, associated, or affiliated with the marketplace.

In example embodiments, the method for monitoring, managing, and facilitating communications and/or transactions relating to infrastructure and/or marketplace utilization further includes accessing, or facilitating or initiating a process of providing access to an interface facilitating modifications/updates to (supplemental) information pertaining to one or more of, for example: the one or more inputs and/or parameters, one or more transactions, one or more transportation infrastructures and/or parking facilities or spaces, usage or utilization by the vehicle of the one or more transportation infrastructures and/or parking facilities or spaces, one or more transactions involving usage or utilization by the vehicle of the one or more transportation infrastructures and/or parking facilities or spaces, a marketplace (or marketplaces), entities and/or merchants (e.g., involved, associated, or affiliated with the marketplace), one or more transactions involving one or more of the entities and/or merchants (e.g., involved, associated, or affiliated with the marketplace), one or more identifiers (e.g., reprogrammable) with which at least one of the inputs and/or parameters is associated or established in association with, a vehicle, a personal computing or communications device, an entity, and/or a person (e.g., identified by or associated with the one or more identifiers), the one or more transaction amounts (determined), one or more of the accounts, and funds transferred between the accounts. In example embodiments, the information is provided to one or more of, for example: an owner or operator of, or an authorized person or entity associated with, a transportation infrastructure, a parking facility or space, a merchant store, and/or an issuing bank, a maintenance or service company, authorized operators and users of a system for monitoring and managing transportation infrastructure and locations of vehicles therein, a law enforcement agency, a parking enforcement agency, a government agency, a company or other private-sector entity or organization, a lienholder, a person or entity authorized or approved to repossess the vehicle, an insurance company, authorized or approved individuals or groups, an owner or a registered owner of the vehicle, and a person or persons authorized or approved by the owner and/or the registered owner of the vehicle.

In example embodiments, technologies and methods for monitoring, managing, and facilitating communications and/or transactions relating to infrastructure and/or marketplace utilization are implemented as an addition and/or an improvement to an existing (e.g., third party) system application, website, or other platform (public or private) involving one or more of, for example: traffic management, a navigation system (e.g., an on-board navigation system service provider), transportation infrastructures (e.g., one or more transportation infrastructures and/or parking facilities or spaces), vehicle service departments of facilities, emergency responders, law enforcement agencies, a tracking device (e.g., stolen vehicle tracking service provider), a marketplace (or marketplaces), and one or more identifiers. For example, interfaces and/or visual representations (or presentations) described herein can be controlled, generated, or provided utilizing a custom add-in or plug-in system application which functions as an extension and overlay to an existing (third party) system application, website, or other platform (e.g., that facilitates one or more of, for example: traffic management, vehicle navigation, communications and/or transactions relating to infrastructure and/or marketplace utilization, and activation of and/or management of one or more identifiers). For example, a visual representation (or multiple visual representations) is (are) controlled, generated, or provided via an interface that is generated utilizing a custom add-in or plug-in system application which functions as an extension and overlay to an existing (third party) system application or other platform that facilitates one or more of, for example: traffic management, vehicle navigation, communications and/or transactions relating to infrastructure and/or marketplace utilization, and activation of and/or management of one or more identifiers.

It should be understood that the user interfaces described herein can be implemented or provided utilizing a website, an addition and/or an improvement to an existing website, or a resource other than a website, and independent of whether the resource is directly accessible by the user. Furthermore, resources can be distributed with respect to their physical locations and can be controlled, individually or as groups (e.g., shared resources), by one or more service hosts and/or system participants.

In example embodiments, a system for monitoring, managing, and facilitating communications and/or transactions relating to infrastructure and/or marketplace utilization includes one or more computer-executable software applications configured or programmed to implement one or more of the technologies and/or methods herein. In example embodiments, one or more computer-executable software applications is/are at least partially cloud-based and/or accessible via a website or other electronic or communications platform (e.g., provided in the form of an application for a personal computing and/or communications device, such as a smartphone or tablet computer).

In an example embodiment, a system for monitoring, managing, and facilitating communications and/or transactions relating to infrastructure and/or marketplace utilization includes one or more computer-executable software applications configured or programmed to facilitate activation of and/or management of the one or more identifiers. In an example embodiment, the one or more computer-executable software applications are configured or programmed to control a process of managing, selecting, or otherwise providing or determining, criteria and/or inputs utilized by or in relation to multiple identifiers (e.g., activating, deactivating, relocating or reassigning an identifier and/or changing a prioritization as between a plurality of the identifiers). In an example embodiment, the one or more computer-executable software applications are configured or programmed to generate or provide an interface that allows a user to perform actions (e.g., in relation to controlling and/or managing one or more identifiers) including, inter alia, selecting, or otherwise providing or determining, criteria and/or inputs utilized in an automated process for activating and/or deactivating one or more identifiers. In an example embodiment, the one or more computer-executable software applications are configured or programmed to control a process of presenting a visual presentation of one or more of, for example: the one or more identifiers (e.g., an icon indicating a type of identifier) and a location of at least one of the one or more identifiers (e.g., of an activated primary identifier, or of all activated identifiers).

Example embodiments described herein involve the provision or utilization of identifier information (e.g., an identifier) in relation to an action or process involving one or more location- and/or other criteria-dependent targeted communications and/or transactions. Signals and/or information (e.g., including, associated with, or received or established in association with identifier information) are processed to identify one or more transactions, advertisements, messages, and/or communications that satisfy one or more of one or more criteria, requirements, and/or preferences. The identifier information is utilized to determine and/or provide one or more amounts, charges, and/or non-monetary considerations associated with or in association with the one or more transactions, advertisements, messages, and/or communications. In example embodiments, the identifier information includes one or more identifiers at least one of which is mobile, floating, or transportable (e.g., in relation to a vehicle). Example methodologies and technologies described herein additionally involve facilitating or initiating a process of transmitting (e.g., broadcasting) and/or receiving one or more advertisements, messages, and/or communications that satisfy the one or more criteria, requirements, and/or preferences (e.g., specified in, determined from, or generated in consideration of one or more of, for example: the location information, one or more broadcast and/or receipt criteria, requirements, and/or preferences, a level/tier of service or membership, and an identification of mutually-specified subject matter as between criteria, requirements, preferences, and/or other inputs associated with or provided by broadcasting and receiving members/participants, respectively).

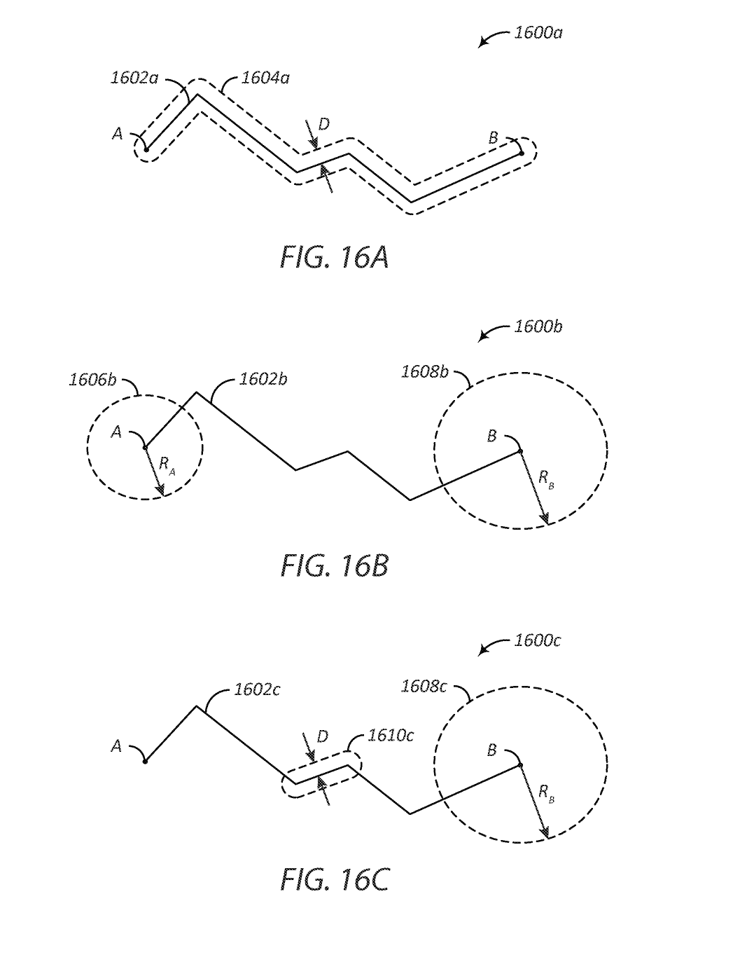

In example embodiments, the criteria, requirements, and/or preferences include at least one location-dependent criteria specifying, or facilitating or initiating a process of identifying or otherwise determining, one or more targeted areas that include one or more portions of a route or path within a marketplace (or marketplaces). In example embodiments, the one or more targeted areas include at least one portion the boundary of which is selected or otherwise determined in relation to one or more of, for example: the route or path, or one or more portions thereof, and one or more locations along the route or path. By way of example, FIG. 16A shows a route or path 1602a, which includes five portions or segments (e.g., legs of a journey) between beginning and end locations/points (denoted “A” and “B”, respectively). In this example, information (e.g., coordinates) associated with the route or path 1602a are utilized with a distance (denoted “D”) from the route or path 1602a to determine a targeted area 1604a (depicted in dashed lines) as shown. Referring to FIG. 16B, in this example, distances (denoted “R_{A}” and “R_{B}”, respectively) in relation to the locations “A” and “B” are utilized to determine the targeted areas 1606b and 1608b, respectively. As another example, referring to FIG. 16C, a distance (denoted “R_{B}”) in relation to the location “B” is utilized to determine the targeted area 1608c, and information (e.g., coordinates) associated with the route or path 1602c are utilized with a distance (denoted “D”) from a portion of the route or path 1602a (i.e., the third leg of the journey to destination “B”) to determine a targeted area 1610c (depicted in dashed lines) as shown.

Operations or actions (e.g., involving transactions, advertisements, messages, and/or communications) can be controlled or otherwise facilitated or initiated in a location- and/or other criteria-dependent manner or dependent upon such criteria. For example, referring to FIG. 15D, if the third leg of a journey (included in targeted area 1610c) is determined to be under strict law enforcement surveillance in relation to speed laws, the user can be provided with an alert under various circumstances (e.g., when driving within, approaching, or departing the area 1610c). By way of example, if the speed of the driver's vehicle is determined (e.g., from telemetry and/or GPS information) to be in excess of a maximum speed permitted at the current location of the driver, or approaching the maximum speed, an alert can be provided to the driver (such as, for example, a voice message reproduced utilizing the sound system of the vehicle and overriding any other music, programs, etc. currently playing).

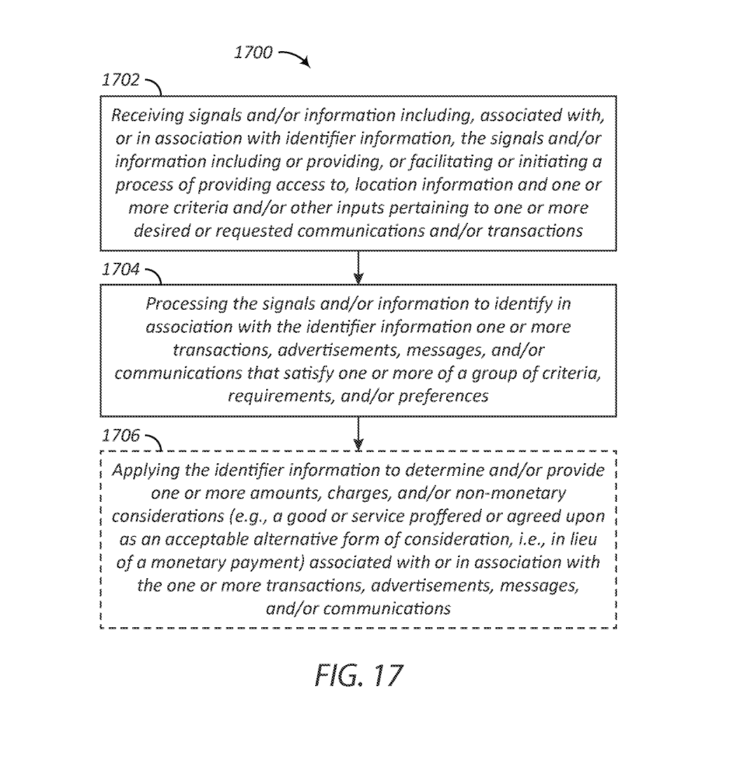

FIG. 17 shows an example embodiment of a method 1700 for monitoring, managing, and facilitating location- and/or other criteria-dependent targeted communications and/or transactions. The method includes, at 1702, receiving signals and/or information including, associated with, or in association with identifier information, the signals and/or information including or providing, or facilitating or initiating a process of providing access to, location information and one or more criteria and/or other inputs pertaining to one or more desired or requested communications and/or transactions. At 1704, the signals and/or information are processed to identify in association with the identifier information one or more transactions, advertisements, messages, and/or communications that satisfy one or more of a group of criteria, requirements, and/or preferences. In example embodiments, the method 1700 further includes, at 1706, applying the identifier information to determine and/or provide one or more amounts, charges, and/or non-monetary considerations (e.g., a good or service proffered or agreed upon as an acceptable alternative form of consideration, i.e., in lieu of a monetary payment) associated with or in association with the one or more transactions, advertisements, messages, and/or communications. In example embodiments, the method further includes controlling or utilizing one or more electronic communications and/or display devices to facilitate or initiate the process.

The location information can be provided or determined based on location of an identifier (e.g., the location of a source or carrier device that provides or obtains an identifier) or can be provided by, or in conjunction with, another signal and/or information source. The location information can be provided by or in relation to one or more of, for example: a prospective buyer (e.g., a Buying Member or Marketplace Participant), a prospective seller (e.g., Selling Member, or Marketplace Participant), and a transaction facilitator/assistant/advisor (e.g., an auxiliary/independent participant, for example, “local expert”, a virtual participant, a device, and/or a program). The location information can be provided or determined by one or more of, for example: an electronic tracking device, a mobile telephone, a smartphone, or one or more computing or communications devices, a device that generates, transmits, or reads code and/or other information provided or obtained by, identifying, and/or pertaining to a vehicle, a personal computing or communications device, an entity, and/or a person, an authorized or approved source or device, a processor or controller, a biometric data acquisition device, a user-input mechanism, a RFID device, a NFC device, a camera, a code reader or generator, and a parking meter.

The one or more criteria and/or other inputs pertain, for example, to user or other inputs that facilitate specifying or otherwise determining the characteristics (or other aspects) of one or more desired or requested communications and/or transactions, for example: a description (and/or type) of goods/services, desired or acceptable prices (or price ranges), offer or acceptance terms (e.g., time of expiration), and location requirements (if any).

The one or more transaction criteria can include, for example, a form of payment offered or accepted (e.g., a communication or information provided to a prospective buyer such as: “This Seller accepts payment only by electronic transfer of funds, credit card (VISA, AMEX), cash (USD, EUR, GBP, AUD, CAD, JPY), and personal check.”) (e.g., a communication or information provided to a prospective seller such as: “This Buyer pays (or prefers to pay) cash.”).

The one or more (additional/other) transaction requirements and/or preferences can be specified in, determined from, or generated in consideration of location information that includes one or more proximity criteria (e.g., within an indicated, selected, or otherwise defined proximity of a particular location, such as the location of an identifier).

The one or more communications criteria, requirements, and/or preferences can be specified in, determined from, or generated in consideration of one or more, for example: one or more locations or location information (e.g., as described herein), a membership level or tier (e.g., pay more for access to an advertisement-free application/interface), one or more preferred, specified, determined, or otherwise identified or characterized persons and/or groups, participant preferences (e.g., only receive advertisements/offers from sellers within one mile from a “verified seller” of specified goods/services, but no communications from sellers/merchants with an unfavorable marketplace rating/rank or individual sellers with a criminal record), advertisement broadcast preferences, and a mutual match (or substantial match) in goods/services specified by the broadcasting and receiving members/participants. The one or more preferred, specified, determined, or otherwise identified or characterized persons and/or groups can include or relate to one or more of, for example: prior purchasers, members of a mailing list, fan clubs, organizations, schools, social networks, contest winners, and VIPs. The one or more preferred, specified, determined, or otherwise identified or characterized persons and/or groups can include or relate to persons having one or more specified or otherwise determined interests, experiences, skills, credentials, behaviors, possessions, instances and/or patterns of consumption, affiliations, characteristics, conditions, personal/situational/environmental circumstances, needs and/or challenges. The one or more preferred, specified, determined, or otherwise identified or characterized persons and/or groups can include or relate to one or more of, for example: government, military, political, special interest, social, professional, trade, labor, occupational, industry, community, religious, athletic, recreational, artistic, and charitable groups and organizations and/or members thereof (former, current, and/or prospective).

Thus, in an example embodiment, a method for monitoring, managing, and facilitating location- and/or other criteria-dependent targeted communications and/or transactions includes: receiving signals and/or information including, associated with, or in association with identifier information (e.g., information provided or obtained by, identifying, and/or pertaining to a vehicle, a personal computing or communications device, and entity, and/or a person), the signals and/or information including or providing, or facilitating or initiating a process of providing access to, location information and one or more criteria and/or other inputs pertaining to one or more desired or requested communications and/or transactions; and processing the signals and/or information to identify in association with the identifier information one or more transactions, advertisements, messages, and/or communications that satisfy one or more of a group of criteria, requirements, and/or preferences (e.g., a group of interrelated criteria, requirements, and/or preferences including, for example, one or more transaction criteria, one or more transaction requirements and/or preferences specified in, determined from, or generated in consideration of the location information, and one or more communications criteria, requirements, and/or preferences). In an example embodiment, the method further includes controlling or utilizing one or more electronic communications and/or display devices to facilitate or initiate a process of applying the identifier information to determine and/or provide one or more amounts, charges, and/or non-monetary considerations (e.g., a good or service proffered or agreed upon as an acceptable alternative form of consideration, i.e., in lieu of a monetary payment) associated with or in association with the one or more transactions, advertisements, messages, and/or communications. In an example embodiment, the method further includes providing, facilitating, or initiating a communication that includes a resource or other information that provides access to a receipt or other documentation or information relating to a charge, a debit amount, and/or an electronic non-monetary tender estimated, determined, provided, or associated with one or more transactions, advertisements, messages, and/or communications.

In example embodiments, the signals and/or information can include or provide, or facilitate or initiate a process of providing access to, information relating to and/or provided by one or more of, for example: members and/or participants of a marketplace (or marketplaces), purchasers and/or prospective purchasers of goods or services, sellers and/or prospective sellers of goods or services, and transaction facilitators, assistants, and/or advisors. In example embodiments, the “members and/or participants” can include verified, certified, approved, applicant, or candidate members and/or participants. In example embodiments, the “members and/or participants” can include suspended, banned, censured, or probationary members and/or participants.

The signals and/or information can include telemetry (e.g., associated with the vehicle or with a driver or passenger, or relating to environmental or other sensed, measured, or reported conditions). Example methodologies and technologies described herein pertain to, or facilitate or initiate, one or more transactions, advertisements, messages, and/or communications that include, utilize, or involve one or more of: telemetry and location-dependent targeted information.

Example methodologies and technologies described herein pertain to, or facilitate or initiate, one or more transactions, advertisements, messages, and/or communications depending upon one or more criteria, requirements, and/or preferences.

Example methodologies and technologies described herein involve facilitating or initiating one or more transactions that satisfy one or more of: one or more transaction criteria, and one or more (additional/other) transaction requirements and/or preferences. Example methodologies and technologies described herein involve facilitating or initiating a process of transmitting (e.g., broadcasting) and/or receiving one or more advertisements, messages, and/or communications that satisfy one or more criteria, requirements, and/or preferences (e.g., such as described herein). In example embodiments, the one or more communications criteria, requirements, and/or preferences are specified in, determined from, or generated in consideration of one or more of, for example: the location information, the one or more transaction criteria, broadcast and/or receipt criteria, instructions, protocols, and/or preferences, a level/tier of service or membership, and an identification of mutually-specified subject matter as between criteria and/or other inputs associated with or provided by broadcasting and receiving members/participants, respectively. For example, the broadcast and/or receipt criteria can be location-dependent (e.g., directed toward prospective buyers in a particular location or proximity to a broadcasting seller) and/or targeted (e.g., directed toward actively searchers for goods and/or services). For example, the level/tier of service or membership is utilized to influence priorities and/or resources dedicated as between multiple potentially competing communications and/or requested communications (e.g., buyer members/participants pay more to utilize an advertisement-free application; seller members/participants pay more for priority placement/broadcasting of their advertisements or other content).

In example embodiments, the one or more transactions, advertisements, messages, and/or communications can include, utilize or involve one or more targeted communications (e.g., an advertisement or offer) that is receivable only by members and/or participants satisfying one or more of, for example: one or more transaction match criteria (e.g., in relation to particular, specified, or otherwise determined subject matter) (e.g., goods and/or services), one or more recipient (or preferred recipient) criteria (e.g., “eligible recipient” criteria which are, for example, specified or otherwise determined in relation to one or more of a characteristic, a status, an action, a behavior, a history, a rating, a classification, a rank, a priority, a membership, and an affiliation of potential recipients), and one or more location or proximity criteria (e.g., only “eligible recipients” who are identified or otherwise determined to be at or within a specified or otherwise determined targeted location or proximity are permitted to receive the targeted communication).

Example methodologies and technologies described herein allow a participant (e.g., a Merchant or Seller) to add, specify broadcast, and/or modify advertising content, for example, utilizing time windows, automatic shut off or cessation of advertising broadcasts at particular inventory levels, automatic start or restart of advertising broadcasts at other inventory levels (e.g., as a function of day of the week, time of day, and/or other factors).

Other Seller-oriented features are embodied in the methodologies and technologies described herein. In example embodiments, requests (e.g., searches) and/or broadcasts (e.g., targeted or other advertisements, offers, etc.) can be scheduled. For example, a Selling Member can target Buying Members interested in specific goods and/or services who are located (e.g., utilizing an identifier as described herein) within a specified proximity (e.g., close proximity) of the Selling Member. For example, this will enable restaurants (e.g., as a Selling Members) to notifying Buying Members associated with an identifier (e.g., within a specified proximity) that they have available tables. Such a notification scheme can utilize or incorporate other processes including one or more of, for example: inventory monitoring, occupancy monitoring, and table (availability) monitoring. In example embodiments, a stadium or sports venue such as Staples Center is provided with access to a system and/or interface that facilitates or initiate a process of notifying Buying Members associated with an identifier (e.g., within a specified proximity) that seats are available (e.g., a notification provided shortly before the start of a basketball game).

In example embodiments, the one or more transactions, advertisements, messages, and/or communications can include, utilize or involve one or more targeted communications (e.g., an advertisement or offer) that is receivable only by members and/or participants satisfying a conditional and/or a time-limited offer. In example embodiments, the Selling Member is provided with access to an interface that allows the Selling Member to target participants (e.g., utilizing identifier and/or other information) who are searching in a particular city, region or proximity, and to transmit a message communicating a conditional offer (e.g., offering special discount(s) to one or more Buying Members within a short-time frame) to entice a Buying Member to purchase a product indicated as desired by the Buying Member. In example embodiments, a conditional offer is time limited and determined by location or proximity criteria. In example embodiments, an offer is dependent upon an inventory (e.g., based upon an inventory trigger). For example, a Selling Member to able to offer a product such as a television to a Buying Member associated with an identifier (e.g., within a close or other specified proximity) when the Selling Member has that particular television in its inventory. In example embodiments, a prospective purchaser (e.g., associated with the identifier) is offered a discounted price or other incentive which can be conditional (e.g., contingent upon completing a purchase transaction within a specific timeframe). In example embodiments, multiple merchant or sellers (e.g., transmitting offers and/or other information to prospective purchasers) are provided with access to a system or interface that allows them to “compete” for sales, for example, within a specific timeframe (e.g., as previously described).

With reference to FIG. 17, in example embodiments, the method for monitoring, managing, and facilitating location- and/or other criteria-dependent targeted communications and/or transactions further includes facilitating or initiating a process of presenting a visual representation (e.g., controlling an electronic display to generate a visual representation) of one or more of, for example: the signals and/or information, the one or more desired or requested communications and/or transactions, one or more criteria, requirements, preferences, and/or other inputs (e.g., pertaining to and or associated with one or more desired or requested communications and/or transactions) (e.g., one or more location-dependent and/or targeted criteria, requirements, and/or preferences), one or more communication and/or transaction criteria, requirements, and/or preferences (e.g., specified in, determined from, or generated in consideration of one or more of, for example: the location information, one or more broadcast and/or receipt criteria, requirements, and/or preferences, a level/tier of service or membership, and an identification of mutually-specified subject matter as between criteria, requirements, preferences, and/or other inputs associated with or provided by broadcasting and receiving members/participants, respectively), one or more transactions, advertisements, messages, and/or communications (e.g., satisfying one or more location-dependent and/or targeted criteria, requirements, and/or preferences) (e.g., one or more advertisements, messages, and/or communications that satisfy the one or more communication and/or transaction criteria, requirements, and/or preferences), the one or more amounts, charges and/or non-monetary considerations (e.g., pertaining to and/or associated with one or more desired or requested communications and/or transactions), the one or more electronic communications and/or display devices, one or more accounts (e.g., of and/or associated with the members and/or participants of one or more marketplaces), a marketplace (or marketplaces), members and/or participants of one or more marketplaces, locations of the members and/or participants, marketplace utilization information (e.g., associating one or more members and/or participants of one or more marketplaces with one or more identifiers) (e.g., pertaining to one or more transactions, advertisements, messages, and/or communications and/or one or more members and/or participants of one or more marketplaces), one or more targeted areas (e.g., that include one or more portions of a route or path) and/or groups (e.g., members and/or participants) within one or more marketplaces, the identifier information (e.g., one or more identifiers) (e.g., one or more identifiers with which at least one of the inputs is associated or established in association with), a vehicle, a personal computing or communications device, an entity, and/or a person (e.g., identified by or associated with one or more identifiers), the location information (e.g., pertaining to one or more identifiers with which at least one of the inputs is associated or established in association with and/or one or more desired or requested communications and/or transactions), an acknowledgement that a start time, a stop time, and/or an association between an identifier and one or more communications and/or transactions has been established, a prompt or request for additional information or user inputs, information and/or instructions, a notification, and a warning.

In example embodiments, a visual representation controlled, generated, or provided utilizing a navigation system and/or one or more applications or other platforms that facilitate such a system, can include one or more of, for example: one or more transportation infrastructures and/or parking facilities or spaces (or multiple parking facilities or spaces), and/or a merchant store (or multiple merchant stores) (e.g., associated or affiliated with a transportation infrastructure or a parking facility or space), one or more vehicles, transportation infrastructure utilization information, one or more vehicles, transportation infrastructure utilization information, times and/or locations of transportation infrastructure utilization by the vehicle.

Example embodiments described herein involve the provision or utilization of one or more identifiers in relation to an action or process of accessing or providing access to location information and one or more criteria, requirements, preferences, and/or (other) inputs pertaining to, or initiating or facilitating, one or more desired or requested communications and/or transactions. Signals and/or information (that include or provide, or facilitate or initiate the action or process) are processed to identify (e.g., in association with at least one of the one or more identifiers) one or more transactions, advertisements, messages, and/or communications that satisfy one or more of the criteria, requirements, and/or preferences. By way of example, the location information pertains to one or more identifiers with which at least one of the inputs is associated or established in association with. By way of example, the location information pertains to one or more desired or requested communications and/or transactions. In example embodiments, at least one of the one or more identifiers is mobile, floating, or transportable (e.g., in relation to one or more of a machine, an apparatus, a device, an object, and a sentient entity with which the identifier is associated). In example embodiments, the one or more identifiers include multiple different identifiers, at least one which is provided or obtained by a personal computing or communications device or other auxiliary device. Example methodologies and technologies described herein additionally involve accessing, or facilitating or initiating a process of providing access to, an interface that allows a user to perform actions (e.g., in relation to controlling a visual presentation involving one or more transactions, advertisements, messages, and/or communications) including, inter alia, controlling and/or managing one or more searches and/or broadcasts (e.g., selecting, or otherwise providing or determining, criteria and/or inputs utilized in generating a visual presentation of search results and/or responses to broadcasts).

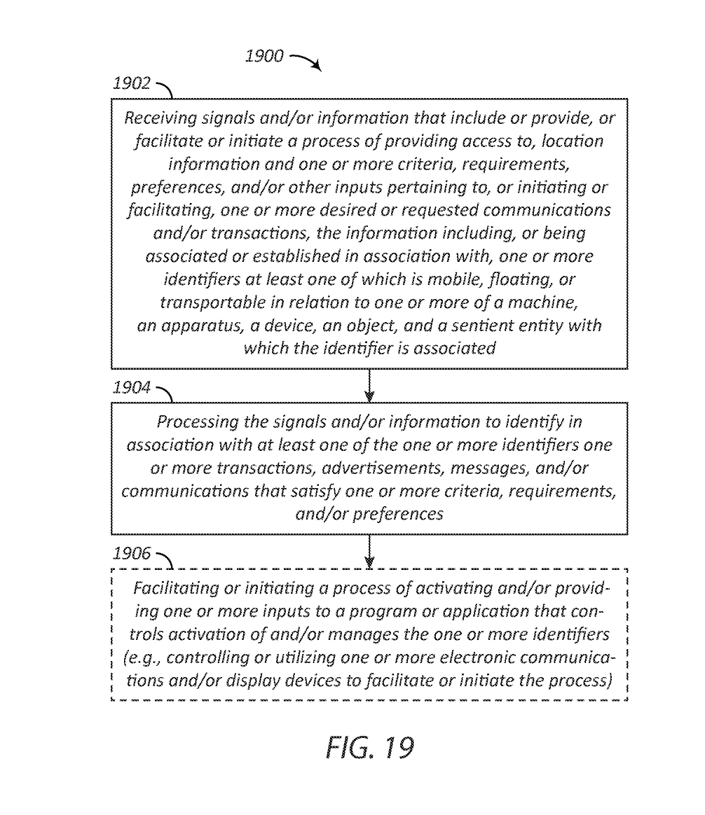

FIG. 19 shows an example embodiment of a method 1900 for monitoring, managing, and facilitating location- and/or other criteria-dependent targeted communications and/or transactions. The method includes, at 1902, receiving signals and/or information that include or provide, or facilitate or initiate a process of providing access to, location information and one or more criteria, requirements, preferences, and/or other inputs pertaining to, or initiating or facilitating, one or more desired or requested communications and/or transactions, the information including, or being associated or established in association with, one or more identifiers at least one of which is mobile, floating, or transportable in relation to one or more of a machine, an apparatus, a device, an object, and a sentient entity with which the identifier is associated. At 1904, the signals and/or information are processed to identify in association with at least one of the one or more identifiers one or more transactions, advertisements, messages, and/or communications that satisfy one or more criteria, requirements, and/or preferences. In example embodiments, the method 1900 further includes, at 1906, facilitating or initiating a process of activating and/or providing one or more inputs to a program or application that controls activation of and/or manages the one or more identifiers (e.g., controlling or utilizing one or more electronic communications and/or display devices to facilitate or initiate the process). In example embodiments, the method further includes activating and/or managing the one or more identifiers. In example embodiments, the method further includes controlling, providing access to, or utilizing one or more electronic communications and/or display devices in relation to, or to facilitate or initiate, a process of activating and/or providing one or more inputs to a program or application that controls activation of and/or manages the one or more identifiers.

Thus, in an example embodiment, a method for monitoring, managing, and facilitating location- and/or other criteria-dependent targeted communications and/or transactions includes: receiving signals and/or information that include or provide, or facilitate or initiate a process of providing access to, location information and one or more criteria, requirements, preferences, and/or other inputs pertaining to, or initiating or facilitating, one or more desired or requested communications and/or transactions, the information including, or being associated or established in association with, one or more identifiers at least one of which is mobile, floating, or transportable in relation to one or more of a machine, an apparatus, a device, an object, and a sentient entity (including components, natural or unnatural, of or associated therewith) (e.g., one or more of a vehicle, a personal computing or communications device or other “auxiliary device”, a programmable or reprogrammable device, object, or article of media, and a person) with which the identifier is associated; and processing the signals and/or information to identify in association with at least one of the one or more identifiers one or more transactions, advertisements, messages, and/or communications that satisfy one or more criteria, requirements, and/or preferences (e.g., one or more location-dependent and/or targeted criteria, requirements, and/or preferences).

In example embodiments, at least one of the inputs (e.g., for at least one desired or requested communication and/or transaction) includes or is associated with or established in association with an identifier or one or more identifiers (such as the identifiers previously described herein). In an example embodiment, at least one of the inputs includes (or is associated with or established in association with) an identifier (or one or more identifiers) provided or obtained by, identifying, and/or pertaining to one or more of: the vehicle, a personal computing or communications device or other auxiliary device, an entity, and a person.

With reference to FIG. 19, in example embodiments, the method for monitoring, managing, and facilitating location- and/or other criteria-dependent targeted communications and/or transactions further includes facilitating or initiating a process of presenting a visual representation (e.g., controlling an electronic display to generate a visual representation) of one or more of, for example: location information (e.g., pertaining to one or more identifiers with which at least one of the inputs is associated or established in association with and/or one or more desired or requested communications and/or transactions), one or more criteria, requirements, preferences, and/or other inputs (e.g., pertaining to and or associated with one or more desired or requested communications and/or transactions) (e.g., one or more location-dependent and/or targeted criteria, requirements, and/or preferences), one or more transactions, advertisements, messages, and/or communications (e.g., satisfying one or more location-dependent and/or targeted criteria, requirements, and/or preferences), a marketplace (or marketplaces), members and/or participants of one or more marketplaces, locations of the members and/or participants, one or more targeted areas (e.g., that include one or more portions of a route or path) and/or groups (e.g., members and/or participants) within one or more marketplaces, one or more identifiers (e.g., reprogrammable) with which at least one of the inputs is associated or established in association with (e.g., an icon indicating a type of identifier), a location of at least one of the one or more identifiers (e.g., of an activated primary identifier, or of all activated identifiers), marketplace utilization information (e.g., associating one or more members and/or participants of one or more marketplaces with one or more identifiers) (e.g., pertaining to one or more transactions, advertisements, messages, and/or communications and/or one or more members and/or participants of one or more marketplaces), a vehicle, a personal computing or communications device, an entity, and/or a person (e.g., identified by or associated with one or more identifiers), one or more amounts, charges, and/or non-monetary considerations (e.g., pertaining to and/or associated with one or more desired or requested communications and/or transactions), one or more accounts (e.g., of and/or associated with the members and/or participants of one or more marketplaces), funds transferred between the accounts and/or one or more non-monetary tenders, information and/or instructions, a notification, a warning, and a prompt.

In an example embodiment, the visual representation is presented at one or more of, for example: a website or other electronically accessible resource, a mobile telephone, a smartphone, or one or more computing or communications devices, a device that generates, transmits, or reads code in relation to providing or obtaining information identifying and/or pertaining to the vehicle, the personal computing or communications device, the entity, and/or the person, and a device, interface, or display that is separate from or remotely located in relation to the device that generates, transmits, or reads code.

In example embodiments, the method for monitoring, managing, and facilitating communications and/or transactions further includes providing or accessing information (and/or notifications) pertaining to one or more of, for example: location information (e.g., pertaining to one or more identifiers with which at least one of the inputs is associated or established in association with and/or one or more desired or requested communications and/or transactions), one or more criteria, requirements, preferences, and/or other inputs (e.g., pertaining to and or associated with one or more desired or requested communications and/or transactions) (e.g., one or more location-dependent and/or targeted criteria, requirements, and/or preferences), one or more transactions, advertisements, messages, and/or communications (e.g., satisfying one or more location-dependent and/or targeted criteria, requirements, and/or preferences), a marketplace (or marketplaces), members and/or participants of one or more marketplaces, locations of the members and/or participants, one or more targeted areas (e.g., that include one or more portions of a route or path) and/or groups (e.g., members and/or participants) within one or more marketplaces, one or more identifiers (e.g., reprogrammable) with which at least one of the inputs is associated or established in association with, marketplace utilization information (e.g., associating one or more members and/or participants of one or more marketplaces with one or more identifiers) (e.g., pertaining to one or more transactions, advertisements, messages, and/or communications and/or one or more members and/or participants of one or more marketplaces), a vehicle, a personal computing or communications device, an entity, and/or a person (e.g., identified by or associated with one or more identifiers), one or more amounts, charges, and/or non-monetary considerations (e.g., pertaining to and/or associated with one or more desired or requested communications and/or transactions), one or more accounts (e.g., of and/or associated with the members and/or participants of one or more marketplaces), and funds transferred between the accounts and/or one or more non-monetary tenders. In example embodiments, the information is provided to one or more of, for example: the members and/or participants, an owner or operator of, or an authorized person or entity associated with, the marketplace, a transportation infrastructure, a parking facility or space, and/or a storage facility or space, a state, a county, a city, a town, or a municipality, a court, a government agency, a law enforcement agency, a department of motor vehicles, a parking and/or traffic enforcement agency, a company or other private-sector entity or organization, authorized operators and users of a system for monitoring and managing transportation infrastructure and locations of vehicles therein, an individual or a group provided with one or more authorized or approved devices, the use of which results in input(s) being provided, a person or an entity authorized or approved to receive or collect funds in relation to a parking or moving violation associated with the vehicle, the personal computing or communications device, and/or the person, an owner or a registered owner of the vehicle and/or the personal computing or communications device, a person or persons authorized or approved by the owner and/or the registered owner of the vehicle and/or the personal computing or communications device, a lienholder, a person or entity authorized or approved to repossess the vehicle and/or the personal computing or communications device, an insurance company, an authorized or approved source or device, and a processor or controller,

In example embodiments of the method for monitoring, managing, and facilitating communications and/or transactions, the notification pertains to one or more of, for example: a parking violation and/or a moving violation associated with one or more of a transportation infrastructure or infrastructures, the vehicle, the personal computing or communications device, the person, an owner, a driver, a custodian, or a passenger of the vehicle, and a person within or transported by the vehicle.

In example embodiments of the method for monitoring, managing, and facilitating communications and/or transactions, the notification pertains to one or more of, for example: a crime, criminal activity, illegal action, prohibited substance, criminal record or notice and/or conviction associated with one or more of a transportation infrastructure or infrastructures, the vehicle, the personal computing or communications device, the person, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle, the personal computing or communications device, and/or the person.

In example embodiments of the method for monitoring, managing, and facilitating communications and/or transactions, the notification pertains to one or more of, for example: a location and/or a movement of the vehicle, the personal computing or communications device, and/or the person.

In example embodiments of the method for monitoring, managing, and facilitating communications and/or transactions, the notification pertains to one or more of, for example: locations and/or movements of one or more vehicles associated with a person, persons, entity, object, group, organization, event, enterprise, and/or circumstance.

In example embodiments of the method for monitoring, managing, and facilitating communications and/or transactions, the notification pertains to one or more of, for example: an event for or during which a location of the vehicle or a person, an animal, or an object within, secured to, or transported by the vehicle presents or potentially raises a concern in relation to the event.

In example embodiments of the method for monitoring, managing, and facilitating communications and/or transactions, the notification pertains to one or more of, for example: an area, a region, or an environment designated as prohibited, unlicensed, limited, restricted, or cautionary access in relation to one or more of the vehicle, the personal computing or communications device, the person, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle, the personal computing or communications device, and/or the person.

In example embodiments of the method for monitoring, managing, and facilitating communications and/or transactions, the notification pertains to one or more of, for example: an area, a region, or an environment designated as allowed, permitted, licensed, unlimited, unrestricted, or safe access in relation to one or more of the vehicle, the personal computing or communications device, the person, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle, the personal computing or communications device, and/or the person.

In example embodiments of the method for monitoring, managing, and facilitating communications and/or transactions, the notification pertains to one or more of, for example: a registration, a driver's license, and/or an insurance policy associated with one or more of the vehicle, the personal computing or communications device, the person, an owner, a driver, a custodian, or a passenger of the vehicle, a person, an animal, or an object within, secured to, or transported by the vehicle, and a person, an entity, an object, a status, a condition, an event, an indication, or an interrupt associated with the vehicle, the personal computing or communications device, and/or the person.

In example embodiments of the method for monitoring, managing, and facilitating communications and/or transactions, the notification pertains to one or more of, for example: vehicle registration requirements for new residents of the state.

In example embodiments of the method for monitoring, managing, and facilitating communications and/or transactions, the notification pertains to one or more of, for example: information and/or updates to information in a navigation or navigation system database, a law enforcement database, a DMV database, an insurance database, and a lienholder database, a marketplace database, an inventory database, a marketing database, a transportation infrastructure database, a parking facility database, a storage facility database, an impound facility database, and a vehicle transport service database, or other database.

In example embodiments, the method for monitoring, managing, and facilitating communications and/or transactions further includes adding information (e.g., such as described herein) to a database and/or using the information to update a database.

In example embodiments, the method for monitoring, managing, and facilitating communications and/or transactions further includes adding to or modifying the information, the circumstance, and/or the one or more criteria, requirements, and/or preferences in response to an input or inputs provided by one or more authorized or approved sources and/or devices (e.g., such as those described herein providing interrupts and/or commands to the electronic devices 1000 and 1001).

Example methodologies and technologies described herein involve controlling or utilizing one or more electronic communications and/or display devices to facilitate or initiate a process of activating and/or providing one or more inputs (e.g., user inputs) to a program or application that controls, generates, provides, and/or manages (e.g., allows a user to manage a presentation of) one or more visual presentations and/or representations (e.g., involving one or more transactions, advertisements, messages, and/or communications).

Referring to FIG. 15, the display area 1520 (previously discussed) includes a pull-down menu 1522 of which the header (denoted “Configure Search/Broadcast”) is shown. Example methodologies and technologies described herein involve application of information and/or inputs in relation to controlling or facilitating one or more electronic display-facilitated functionalities and/or visual presentations which can be initiated, for example, via activation of pull-down menu items.

In example embodiments, the method for monitoring, managing, and facilitating communications and/or transactions further includes accessing, or facilitating or initiating a process of providing access to, an interface that allows a user to perform actions (e.g., in relation to controlling a visual presentation involving one or more transactions, advertisements, messages, and/or communications). An interface can be provided that allows a user to perform actions (e.g., and with reference to FIG. 15, utilizing the “Configure Search/Broadcast” pull-down menu of the interface 1500) including, for example, accessing information pertaining to the location information and one or more criteria, requirements, preferences, and/or other inputs.

Example methodologies and technologies described herein involve accessing, or facilitating or initiating a process of providing access to, an interface that allows a user to perform actions (e.g., in relation to controlling a visual presentation involving one or more transactions, advertisements, messages, and/or communications) including, inter alia, controlling and/or managing one or more searches and/or broadcasts (e.g., selecting, or otherwise providing or determining, criteria and/or inputs utilized in generating a visual presentation of search results and/or responses to broadcasts).

In the following discussion, example names of interface portions/graphics facilitating entry of user inputs (e.g., pull-down menu options) are noted in quotations. Referring to FIG. 15, in example embodiments, an interface can be provided that allows a user to perform actions including one or more of, for example: activating one or more selected searches and/or broadcasts (“Activate Selected Searches”/“Activate Selected Broadcasts”), deactivating one or more selected searches and/or broadcasts (“Deactivate Selected Searches”/“Deactivate Selected Broadcasts”), adding or creating a new search or broadcast (“Add/Create New Search”/“Add/Create New Broadcast”), and modifying one or more selected searches and/or broadcasts (“Modify Search”/“Modify Broadcast”).

By way of example, the searches and/or broadcasts-related action of adding or creating a new search or broadcast (“Add/Create New Search”/“Add/Create New Broadcast”) provides the user with access to an interface (e.g., a pop-up window, a graphical user interface, or the like) that allows the user to select, or otherwise provide or determine, one or more of the location information and the one or more criteria, requirements, preferences, and/or other inputs in relation to a new search or broadcast, respectively. In example embodiments, the searches and/or broadcasts-related action of modifying one or more selected searches and/or broadcasts (“Modify Search”/“Modify Broadcast”) provides the user with access to an interface (e.g., a pop-up window, a graphical user interface, or the like) that allows the user to modify, select, or otherwise provide or determine, one or more of the location information and the one or more criteria, requirements, preferences, and/or other inputs in relation to modifying a search or broadcast, respectively.

In example embodiments, an interface can be provided that allows a user to perform actions including or in relation to selecting, or otherwise providing or determining, criteria and/or inputs utilized in generating a visual presentation of search results and/or responses to broadcasts (or other communications) (“Live Update Preferences”). In example embodiments, an interface is configured to allow the user to modify, select, or otherwise provide or determine baseline or default preferences (e.g., via pull-down menus, data entry fields, etc.) utilized by the interface in presenting and arranging search results and/or responses to broadcasts (or other communications). By way of example, search results and/or responses to broadcasts (or other communications) can be presented in real time, periodically, when an identifier repositions, when a new search or broadcast (or other communication) is transmitted or received, or when a search or broadcast is modified. Baseline or default preferences include, for example, a selection of how the search results and/or responses to broadcasts (or other communications) are arranged or grouped within the visual presentation.

In example embodiments, an interface can be provided that allows a user to perform actions including or in relation to selecting, or otherwise providing or determining, criteria and/or inputs utilized in arranging and grouping search results and/or responses to broadcasts (or other communications) within the visual presentation,

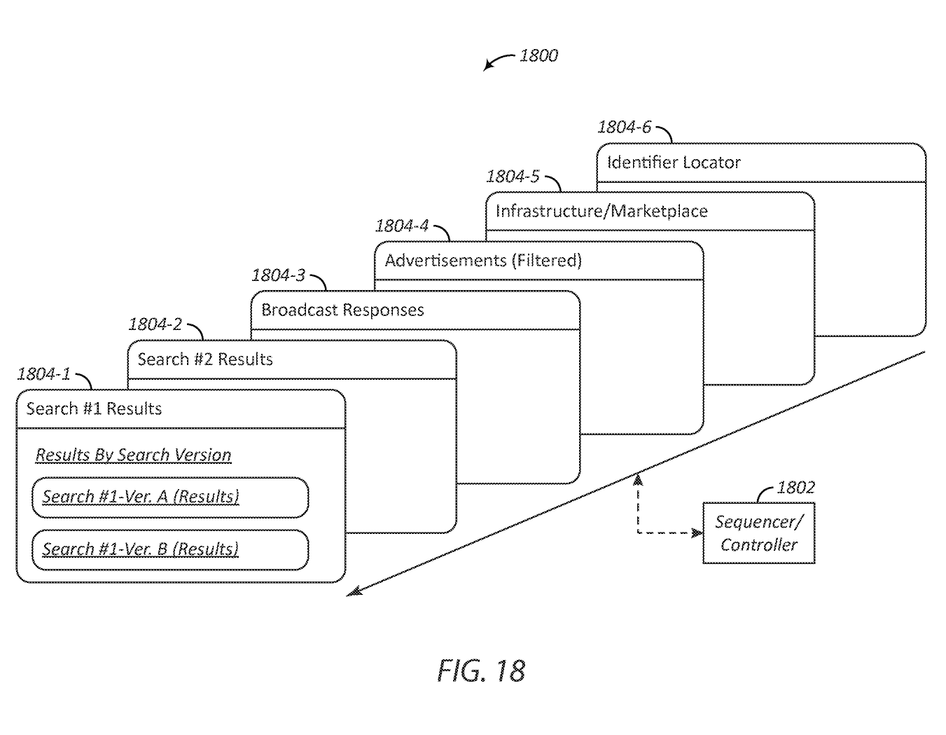

By way of example, selection/activation of “Live Update Preferences” presents a sub-menu option “Group By Type” which provides the user with access to an interface (e.g., a pop-up window, graphical user interface, or the like) that allows the user to select, or otherwise provide or determine, if and how the search results and/or responses to broadcasts (or other communications) are to be grouped within the visual presentation and the order or other manner in which the groups are to be arranged and/or presented in relation to each other. For example, “Group By Type” provides the user with access to a graphical user interface that allows the user to group the search results and/or responses to broadcasts (or other communications) into groups (e.g., FIG. 18) and designate an order of presentment or other spatial arrangement as between the groups. In example embodiments, the interface additionally allows the user to select, assign, import, or otherwise determine visual styles utilized in presenting the different groups (e.g., different colors and/or patterns/tiles/stipples for the windows, field frames, etc. used to present each of the different groups).

By way of example, selection/activation of the “Live Update Preferences” presents sub-menu options “Sort By Relevance” (e.g., in relation to one or more of the location information and the one or more criteria, requirements, preferences, and/or other inputs), “Sort By Search Criteria, Requirements, and/or Preferences”/“Sort By Broadcast Criteria, Requirements, and/or Preferences”, “Sort By Price” (lowest to highest, or vice versa, selectable by the user), “Sort By Popularity”, “Sort By Rating”, “Sort by Distance”, “Sort Selected”, and “Sort Within a Sort”. In example embodiments, the interface additionally allows the user to assign custom weightings to the location information and the one or more criteria, requirements, preferences, and/or other inputs, individually or as groups. For example, an uncommon or unusual transaction and/or communication preference may be of great importance to a particular user.

By way of example, selection/activation of the “Live Update Preferences” presents a sub-menu option “Sort by Distance” which provides the user with access to a graphical user interface or the like that allows the user to select, or otherwise provide or determine, one or more paths (e.g., routes or portions of routes) and/or locations and the manner in which distances (from the one or more paths and/or locations) to locations associated with the search results and/or responses to broadcasts (or other communications) are to be utilized for purposes of generating and updating the visual presentation. See, e.g., FIGS. 16A-16C.

Further with regard to “Modify Search”/“Modify Broadcast”, referring still to FIGS. 16A-16C, in example embodiments, the interface provides a visual presentation of the location information (the dashed lines) and is configured to permit the user to modify the boundaries and/or provide inputs defining different and/or additional areas, and thereby effect corresponding changes to the location information associated with the search. For example, the interface can be configured such that grabbing and stretching a portion of the boundary and/or drawing a new boundary portion or area (e.g., utilizing a touch screen) effects such a change and causes the search to update and represent search results in consideration of the changed location information. Other interfaces and input mechanisms (e.g., voice or motion recognition tools) can also be utilized to modify the location information (as well as the one or more criteria, requirements, preferences, and/or other inputs).

For example, and in relation to an action facilitated utilizing the “Sort By Popularity” input mechanism, a user can custom tailor such a sort utilizing location information of his or own choosing, e.g., selecting only an area outside a particular distance from a seller to determine if a meaningful population of patrons is willing to travel a significant distance to do business with a particular merchant).

For example, and in relation to an action facilitated utilizing the “Sort By Rating” input mechanism, a user can custom tailor such a sort utilizing location information of his or own choosing, e.g., selecting cities or regions of the country that are personally preferred or believed to be more relevant in respect to credibly rating a particular good or service.

Example methodologies and technologies described herein involve or relate to one or more sequences of visual presentations (e.g., in relation to specifying, determining, or otherwise establishing an order in which different groups of search results and/or responses to broadcasts are presented in relation to each other).

In example embodiments, an interface can be provided that allows a user to perform actions including or in relation to selecting, or otherwise providing or determining, criteria and/or inputs utilized in an automated (or semi-automated) process for generating a sequence of visual presentations of one or more search results and/or responses to broadcasts (or other communications). As discussed below, the visual presentation can include one or more filtered and/or sorted visual representations of groups including one or more search results and/or responses to broadcasts.

By way of example, selection/activation of the “Live Update Preferences” presents a sub-menu option “Visual Sequencer” which provides the user with access to an interface (e.g., a pop-up window, graphical user interface, or the like) that allows the user to select, or otherwise provide or determine, a sequence (e.g., a preferred sequence) of visual presentations in relation to search results or responses to broadcasts (or other communications). For example, the results of multiple different searches are automatically presented one after another (e.g., for several seconds each in a cyclical fashion, until a user input is provided that pauses the visual presentation at a selected search result). In another example, multiple different modifications and/or sorts (e.g., preset filtering schemes, favorite or frequently used sort, sorts within sorts, etc.) to a search result are automatically generated (e.g., at the conclusion of the search) and presented one after another (e.g., for several seconds each in a cyclical fashion, until a user input is provided that pauses the visual presentation at a selected modification and/or sort of the search result).

In an example embodiment, the sequencer is controlled such that it advances to the next visual presentation (e.g., in a programmed or otherwise selected sequence of visual presentations) only when there is a new communication or result to be presented or an update to a previously presented communication or result. In another example embodiment, the visual presentation is controlled to fade or reposition (e.g., behind another window) after a time of inactivity in relation to the identification or detection of new communications or results or updates to communications or results. Moreover, in relation to example embodiments described herein, it should be understood that a “visual presentation” can include one or more images or a sequence or sequences of images that are perceived utilizing a human eye and/or an image capture device (e.g., a camera, an imaging device and/or detectors, a robotic or artificial eye, or a technologically augmented human eye) or by utilizing or providing optical/neurological stimulation or other inputs creating a perception of observing one or more visual presentations or image components thereof.

In an example embodiment, the interface allows the user to select, or otherwise provide or determine, a sequence of visual presentations the members of which are selected from one or more search results and multiple different modifications and/or sorts of at least one of the search results. In this manner, a user can more safely (e.g., while driving) monitor updates to visual presentations of search results in relation to multiple different searches, multiple different modifications and/or sorts (of a search result), or a combination thereof.

In an example embodiment, the interface allows the user to select, or otherwise provide or determine, a sequence of visual presentations the members of which are selected from one or more responses to broadcasts (or other communications) and multiple different modifications and/or sorts of responses to at least one of the broadcasts (or other communications). In this manner, a user (e.g., a seller) can more safely (e.g., while driving) monitor updates to visual presentations of responses to broadcasts (or other communications) in relation to multiple different broadcasts (or other communications), multiple different modifications and/or sorts (of responses to a broadcast or other communication), or a combination thereof.

FIG. 18 shows an example depiction of a visual presentations sequence 1800 generated under control of a sequencer/controller 1802 which can be provided, for example, utilizing one or more processors/controllers (e.g., as described herein). In this example, the sequence 1800 includes visual presentations 1804-1 (“Search #1 Results”), 1804-2 (“Search #2 Results”), 1804-3 (“Broadcast Responses”), 1804-4 (“Advertisements (Filtered)”), 1804-5 (“Infrastructure/Marketplace”), and 1804-6 (“Identifier Locator”) which are sequentially presented at an interface or electronic display, for example, within a window or other portion of the interface 1500 such as the display area 1520. In this example, multiple different version of a search (“Search #1”) are specified and scheduled for broadcast (e.g., “Search #1-Ver. A” specifying that location is more important than price; and “Search #1-Ver. B” specifying that if a responding seller accepts cash, the transaction criteria are satisfied even if a subset of all items requested can be provided by the seller). The visual presentation 1804-1 is controlled such that the “Search #1 Results” are arranged in a separate group for each search version (e.g., one group above the other as depicted in this example). The visual presentation 1804-2 is controlled such that the “Search #2 Results” are arranged, for example, with price-related criteria outweighing location-related considerations. The visual presentation 1804-3 is controlled such that the “Broadcast Responses” are arranged, for example, with responses to a most recent of multiple broadcasts receiving prominent placement. The visual presentation 1804-4 is controlled such that the “Advertisements (Filtered)” are presented, for example, depending upon information and/or a status (or rank or rating) associated with the sender or source of the advertisement. By way of an additional example, multiple different received Advertisements can be shown within a single presentation in order of relevant (e.g., to goods and/or services referenced in Search #1 and #2). The visual presentation 1804-5 is controlled to provide a visual representation of an “Infrastructure/Marketplace” (e.g., one or more areas or portions including, for example, a particular location or locations within an infrastructure(s)/marketplace(s) environment, and/or specified in relation to one or more identifiers). The visual presentation 1804-6 (“Identifier Locator”) is controlled, for example, to provide an indication of locations of one or more identifiers (e.g., a map or other visual representation indicating locations of all activated identifiers).

In example embodiments, an interface can be provided that allows a user to perform actions including or in relation to pausing a sequence of visual presentations of one or more search results and/or responses to broadcasts in response to a user input and (for example, if designated as a preferred mode of presentation by the user) automatically resuming the visual presentation when a new search result or response to a broadcast or an update to the one or more search results and/or responses to broadcasts is identified (e.g., satisfies or continues to satisfy criteria, requirements, and/or preferences associated with relevant searches and/or broadcasts).

In example embodiments, an interface can be provided that allows a user to perform actions including or in relation to selecting, or otherwise providing or determining, criteria and/or inputs utilized for establishing or generating (e.g., pursuant to an automated or semi-automated process) a sequence of visual presentations of, or in relation to, results of multiple searches (e.g., including multiple different searches and/or searches made at different times).

In example embodiments, an interface can be provided that allows a user to perform actions including or in relation to selecting, or otherwise providing or determining, criteria and/or inputs utilized for establishing or generating (e.g., pursuant to an automated or semi-automated process) a sequence of visual presentations of, or in relation to, responses to multiple broadcasts (e.g., including multiple different broadcasts and/or broadcasts made at different times).

In example embodiments, an interface can be provided that allows a user to perform actions including or in relation to selecting, or otherwise providing or determining, criteria and/or inputs utilized for establishing or generating (e.g., pursuant to an automated or semi-automated process) a sequence of visual presentations of, or in relation to, multiple different modifications and/or sorts of a search result.

In example embodiments, an interface can be provided that allows a user to perform actions including or in relation to selecting, or otherwise providing or determining, criteria and/or inputs utilized for establishing or generating (e.g., pursuant to an automated or semi-automated process) a sequence of visual presentations of, or in relation to, multiple different modifications and/or sorts of responses to at least one broadcast.

In example embodiments, an interface can be provided that allows a user to perform actions including or in relation to selecting, or otherwise providing or determining, criteria and/or inputs utilized for establishing or generating (e.g., pursuant to an automated or semi-automated process) a sequence of visual presentations the members of which are visual presentations (or image components thereof) associated with one or more search results and multiple different modifications and/or sorts of at least one of the search results.

Example embodiments described herein involve the provision or utilization of one or more identifiers in relation to one or more transactions, advertisements, messages, and/or communications, one or more inputs and/or parameters thereof being associated with or established in association with the one or more identifiers. For example, the one or more identifiers are applied to facilitate or initiate a process of providing or determining one or more amounts, charges, and/or non-monetary considerations associated with the one or more transactions, advertisements, messages, and/or communications. Example methodologies and technologies described herein additionally involve, or facilitate or initiate, an action or process of transferring funds (e.g., between accounts of and/or associated with the members and/or participants) and/or transferring, or providing access to, one or more non-monetary tenders in relation to the one or more amounts, charges, and/or non-monetary considerations.

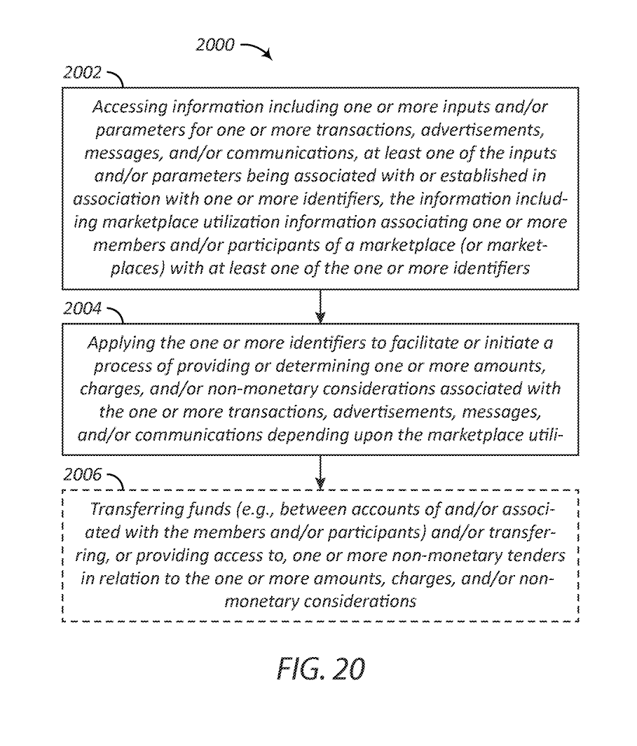

FIG. 20 shows an example embodiment of a method 2000 for monitoring, managing, and facilitating location- and/or other criteria-dependent targeted communications and/or transactions. The method includes, at 2002, accessing information including one or more inputs and/or parameters for one or more transactions, advertisements, messages, and/or communications, at least one of the inputs and/or parameters being associated with or established in association with one or more identifiers, the information including marketplace utilization information associating one or more members and/or participants of a marketplace (or marketplaces) with at least one of the one or more identifiers. In example embodiments, the method further includes facilitating or initiating a process of providing or determining one or more amounts, charges, and/or non-monetary considerations associated with the one or more transactions, advertisements, messages, and/or communications (e.g., depending upon the marketplace utilization information and the one or more inputs and/or parameters). In example embodiments, the method further includes applying the one or more identifiers to facilitate or initiate the process. The method 2000 includes, at 2004, applying the one or more identifiers to facilitate or initiate a process of providing or determining one or more amounts, charges, and/or non-monetary considerations associated with the one or more transactions, advertisements, messages, and/or communications depending upon the marketplace utilization information and the one or more inputs and/or parameters. In example embodiments, the method 2000 further includes, at 2006, transferring funds (e.g., between accounts of and/or associated with the members and/or participants) and/or transferring, or providing access to, one or more non-monetary tenders in relation to the one or more amounts, charges, and/or non-monetary considerations. In example embodiments, the method further includes providing access to a receipt or other documentation or information relating to a charge, a debit amount, and/or an electronic non-monetary tender estimated, determined, provided, or associated with one or more transactions, advertisements, messages, and/or communications. In example embodiments, the method further includes providing, facilitating, or initiating a communication that includes a resource or other information that provides access to the receipt or other documentation or information.

Thus, in an example embodiment, a method for monitoring, managing, and facilitating location- and/or other criteria-dependent targeted communications and/or transactions includes: accessing information including one or more inputs and/or parameters for one or more transactions, advertisements, messages, and/or communications, at least one of the inputs and/or parameters being associated with or established in association with one or more identifiers (e.g., provided or obtained by, identifying, and/or pertaining to a vehicle, a personal computing or communications device, an entity, and/or a person), the information including marketplace utilization information associating one or more members and/or participants of a marketplace (or marketplaces) with at least one of the one or more identifiers; and applying the one or more identifiers to facilitate or initiate a process of providing or determining one or more amounts, charges, and/or non-monetary considerations associated with the one or more transactions, advertisements, messages, and/or communications depending upon the marketplace utilization information and the one or more inputs and/or parameters.

In example embodiments, the one or more identifiers include identifiers (such as previously described herein) and/or a group including (or consisting of) one or more of, for example: an identifier that is provided or obtained by a device that is not secured to a vehicle, an identifier that is selectable from a plurality of identifiers, an identifier that expires after an amount of time and/or only usable in a location or area, an identifier that is activated and/or designated as a primary identifier in response to one or more inputs, an identifier that is activated and/or designated as a primary identifier in response to an output of a switch or an electronic circuit, an identifier that is activated and/or designated as a primary identifier in response to an indication or determination that another identifier is altered, compromised, damaged, deactivated, disabled, inoperable, malfunctioning, modified, out of range, suspended, unauthorized, unavailable, or unreadable, one or more identifiers at least one of which is mobile, floating, or transportable in relation to a vehicle, multiple identifiers, multiple identifiers only one of which is operable, or activated or authorized to serve, at a given time, as a primary identifier, multiple identifiers at least one of which is operable, or activated or authorized to serve, as an imprimatur identifier, multiple identifiers, members of which are changeably assigned statuses as a primary identifier and one or more secondary identifiers, respectively, a primary identifier and a secondary identifier, multiple different identifiers, multiple different identifiers, at least one which includes, or facilitates or initiates a process of accessing, information identifying and/or pertaining to a vehicle, multiple different identifiers, at least one which is provided or obtained by a personal computing or communications device or other auxiliary device, and multiple different identifiers, at least one which is provided or obtained by a biometric data acquisition device, a user-input mechanism, a RFID device, a NFC device, a camera, or a code reader or generator.

With reference to FIG. 20, in example embodiments, the method for monitoring, managing, and facilitating location- and/or other criteria-dependent targeted communications and/or transactions further includes facilitating or initiating a process of presenting a visual representation of one or more of, for example: the one or more inputs and/or parameters, one or more transactions, advertisements, messages, and/or communications, location information (e.g., pertaining to one or more identifiers with which at least one of the inputs is associated or established in association with and/or one or more desired or requested communications and/or transactions), one or more criteria, requirements, and/or preferences (e.g., pertaining to and/or associated with the one or more transactions, advertisements, messages, and/or communications) (e.g., one or more location-dependent and/or targeted criteria, requirements, and/or preferences), one or more transactions, advertisements, messages, and/or communications (e.g., satisfying one or more location-dependent and/or targeted criteria, requirements, and/or preferences), the marketplace (or marketplaces), members and/or participants of one or more marketplaces, locations of the members and/or participants, one or more targeted areas (e.g., that include one or more portions of a route or path) and/or groups (e.g., members and/or participants) within one or more marketplaces, the one or more identifiers, a location of at least one of the one or more identifiers (e.g., of an activated primary identifier), the one or more identifiers (e.g., an icon indicating a type of identifier), a location of at least one of the one or more identifiers (e.g., of an activated primary identifier, or of all activated identifiers), marketplace utilization information (e.g., associating one or more members and/or participants of one or more marketplaces with at least one of the one or more identifiers) (e.g., pertaining to one or more transactions, advertisements, messages, and/or communications and/or one or more members and/or participants of one or more marketplaces), a vehicle, a personal computing or communications device, an entity, and/or a person (e.g., identified by or associated with the one or more identifiers), the one or more amounts, charges, and/or non-monetary considerations, one or more of the accounts, funds transferred between the accounts and/or one or more non-monetary tenders, information and/or instructions, a notification, a warning, and a prompt.

In example embodiments, technologies and methods for monitoring, managing, and facilitating location- and/or other criteria-dependent targeted communications and/or transactions are implemented as an addition and/or an improvement to an existing (e.g., third party) system application, website, or other platform (public or private) involving one or more of, for example: traffic management, a navigation system (e.g., an on-board navigation system service provider), transportation infrastructures (e.g., one or more transportation infrastructures and/or parking facilities or spaces), vehicle service departments of facilities, emergency responders, law enforcement agencies, a tracking device (e.g., stolen vehicle tracking service provider), a marketplace (or marketplaces), an on-line auction (such as, for example, eBay), a social or professional network (such as, for example, Facebook, Twitter, or LinkedIn), a search or question answering interface or platform (e.g., a search engine or specialized search interface or service). For example, interfaces and/or visual representations (or presentations) (e.g., one or more visual representations including, for example, multiple simultaneously and/or sequentially presented visual representations, accessible via one or more interfaces), the one or more identifiers can be controlled, generated, or provided utilizing a custom add-in or plug-in system application which functions as an extension and overlay to an existing (third party) system application, website, or other platform that facilitates one or more of, for example: traffic management, vehicle navigation, communications and/or transactions relating to infrastructure and/or marketplace utilization, an on-line auction or other electronic communications network-facilitated interface, platform, or service that allows buyers and sellers of goods and/or services to offer or request transactions and/or communications with each other, communications and/or transactions involving one or more (or a group of) transaction facilitators, assistants, and/or advisors (e.g., assistant shoppers, personal shoppers, local experts, and/or concierges) (e.g., an on-board concierge, personal assistant/shopper, or virtual or other consultant), communications and/or transactions launched or initiated directly from an on-line or other electronic communications network-facilitated social or professional network interface or platform, communications and/or transactions launched or initiated directly from an on-line or other electronic communications network-facilitated search or question answering interface or platform, and activation of and/or management of one or more identifiers.

It should be understood that the user interfaces described herein can be implemented or provided utilizing a website, an addition and/or an improvement to an existing website, or a resource other than a website, and independent of whether the resource is directly accessible by the user. Furthermore, resources can be distributed with respect to their physical locations and can be controlled, individually or as groups (e.g., shared resources), by one or more service hosts and/or system participants.

In example embodiments, a system for monitoring, managing, and facilitating location- and/or other criteria-dependent targeted communications and/or transactions includes one or more computer-executable software applications configured or programmed to implement one or more of the technologies and/or methods herein. In example embodiments, one or more computer-executable software applications is/are at least partially cloud-based and/or accessible via a website or other electronic or communications platform (e.g., provided in the form of an application for a personal computing and/or communications device, such as a smartphone or tablet computer).

In an example embodiment, a system for monitoring, managing, and facilitating location- and/or other criteria-dependent targeted communications and/or transactions includes one or more computer-executable software applications configured or programmed to facilitate activation of and/or management of one or more visual presentations (e.g., involving one or more transactions, advertisements, messages, and/or communications). In an example embodiment, the one or more computer-executable software applications are configured or programmed to control a process of establishing or generating a sequence of visual presentations (e.g., establishing and controlling an order in which different groups of search results and/or responses to broadcasts are presented in relation to each other). In an example embodiment, the one or more computer-executable software applications are configured or programmed to generate or provide an interface that allows a user to perform actions (e.g., in relation to controlling a visual presentation involving one or more transactions, advertisements, messages, and/or communications) including, inter alia, selecting, or otherwise providing or determining, criteria and/or inputs utilized in an automated process for generating a sequence of visual presentations of one or more search results and/or responses to broadcasts.

As to transaction facilitators, assistants, and/or advisors, in example scenario (set forth below), a person visiting a store notices that a particular item is now available for purchase (e.g., a product that is highly sought after by friends of the person) can utilize an add-in of a social networking website or other platform (e.g., an add-in that is exclusively available through the social network) to communicate this information to one or more friends (e.g., a group, circle, or other subset of the person's entire collection of friends). In a similar fashion, an add-in or other program can be provided to allow a group of shoppers to more efficiently effect one or more desired transactions. For example, a group of people (e.g., including one or more personal shoppers, local experts, and/or concierges) can simultaneously “fan out”, each in pursuit of one or more items from a mission list, notifying others of the group of their progress automatically updating the mission list once an item has been located and/or purchased. Visual representations of one or more of, for example, members of the group, their respective locations, items on the list, located items, purchases in progress, transactions completed, available remaining purchasing resources, available remaining time (e.g., of individual members of the group) to participate in the mission, and other information can be presented, for example, via secured communications available only to electronic devices associated with members of the group. In example embodiments, should a member of the group locate an item assigned to another member, upon receipt of this information, the program can modify information pertaining to the mission (e.g., reassign one or more of the items among the group members). A person with a great deal of shopping to accomplish, perhaps in very little time, may find significant benefit from a technology that would allow the person to engage otherwise idle persons (such as teenagers in the mall) to help them complete their shopping as expeditiously as possible. In some circumstances, the shopper and the person(s) engaged to assist would not need to meet. For example, a purchase made by an assistant shopper on behalf of a principal shopper (e.g., automatically in association with the principal shopper) is completed without the need for the principal shopper to be present during the purchasing transaction. The purchased item(s) can (e.g., per preferences previously indicated by the principal shopper) be held by a store employee (e.g., at a pick up location in the store), delivered to the principal shopper (e.g., by FedEx), or hand-carried to the location of the principal shopper or to a pick up location in or near a parking facility associated with the store. Moreover, in example embodiments, the assistant shopper is automatically paid after completing a transaction on behalf of the principal shopper (e.g., per preferences previously indicated by the principal shopper and/or the assistant shopper) and, thus, need not loiter at a point of purchase waiting to meet up with the principal shopper. In example embodiments, assistant shoppers can broadcast information indicating one or more of, for example: times when they are available to be engaged as an assistant shopper, locations associated with such times, and credentials, certifications or the like in relation to their experience, history, expertise, and/or preferences as a shopping assistant (or as a shopper in general). Such broadcasts can also be targeted, for example, to principal shoppers who plan to shop at a particular store (or stores) or during a particular interval of time, or to principal shoppers indicating that they do not plan to participate, at least in-person, in their proposed shopping mission. For example, a high school student (e.g., while walking to school in the morning) can broadcast his or her availability to be engaged as an assistant shopper at a particular local shopping mall between 3:00 p.m. and 4:30 p.m., thereby, setting in motion a potential opportunity to earn an assistant shopper's fee (e.g., to pay for a movie that they would like to watch, say, at 5:00 p.m., at or near the shopping mall). A busy professional, for example, knowing that today's schedule will only permit a brief stop at the mall on the way home, can respond (e.g., earlier in the day while still at the office) to the broadcast, thereby engaging the high school student in relation to one or more requested purchases that might normally take a half hour to an hour to complete in-person (e.g., involving purchases from two different stores at opposite ends of a very large shopping mall). Disabled persons, or persons of limited mobility, may benefit also from having assistance in such a shopping circumstance. Additionally, payments can be provided via electronic or other forms of barter or trade. By way of example, and of particular synergistic relevance to the foregoing scenario (involving the high school student), the busy professional may have received a free pass to the 5:00 p.m. movie, such pass being electronically transferrable (e.g., by entering or otherwise providing a code) but good only for that particular show. In this example, the busy professional associates the movie pass with a communication in response to the high school student's broadcast (thereby designating a form of barter). If the response is accepted, and the requested transactions are completed, the successful assistant shopper is provided with the code or other information associated with the movie pass (e.g., via an automatically generated e-mail message that includes a visual representation of the movie pass, for example, in the form of a bar code that can be scanned at the ticket window). Thus, a resource of limited duration is prevented from going to waste. Regardless, and independent of the form of payment, a person with available time is afforded opportunities to do work of his or her choosing and is automatically compensated for successful completion of each accepted assignment, and a busy person is afforded opportunities to save time.

In example embodiments, an identifier (e.g., in the form of a code) associated with, or established in association with, a person is mobile, floating, or transportable. In example embodiments, such an identifier also serves as an electronic non-monetary tender. A status, value, or other characteristic of the electronic non-monetary tender can be determined depending, for example, upon an association or re-association of the identifier (e.g., the association changing from one person to another) and/or upon other criteria or inputs and/or parameters such as, for example, a time (or time limit), a location associated with the identifier, or information relating to a person with which the identifier is presently or otherwise associated.

Although the present invention has been described in terms of the example embodiments above, numerous modifications and/or additions to the above-described embodiments would be readily apparent to one skilled in the art. It is intended that the scope of the present invention extend to all such modifications and/or additions.

What is claimed is:

1. A method for providing navigation information for a vehicle performed on a computing device, the method comprising:
receiving an input specifying a travel destination for the vehicle;
determining a plurality of different possible routes for the travel destination, different toll amounts being assessed on at least some segments of the possible routes;
selecting a route among the plurality of possible routes based at least in part on the toll amount for using the route; and
presenting navigation information relating to the selected route.

2. The method of claim 1, wherein the step of selecting a route includes comparing the toll amount for the route to a maximum amount to be paid.

3. The method of claim 1, wherein the step of selecting a route is further based on the estimated travel time for using the route.

4. The method of claim 1, wherein the step of selecting a route is further based on an amount available on an account.

5. The method of claim 1, wherein the step of selecting a route is further based on a temporal travel budget.

6. A method for providing navigation information for a vehicle performed on a computing device, the method comprising:
receiving an input specifying a travel destination for the vehicle;
determining different possible routes for the travel destination, different toll amounts being assessed on at least some segments of the possible routes based on current and/or predicted traffic conditions; and
presenting navigation information relating to the plurality of possible routes regardless of the toll amounts or the traffic conditions, the presented information including any tolls to be assessed.

7. A method for providing navigation information for a vehicle performed on a computing device, the method comprising:
receiving an input specifying a travel destination for the vehicle;
determining a plurality of different possible routes for presentation based at least in part on toll amounts being assessed on at least some segments of the possible routes based on current and/or predicted traffic conditions; and
presenting navigation information related to the plurality of possible routes determined during the determining step.

8. The method of claim 7, wherein the step of determining a plurality of different possible routes includes comparing any tolls to be assessed for a route to a maximum amount to be paid.

9. The method of claim 7, wherein the step of determining a plurality of different possible routes is further based on the estimated travel time for using each route.

10. The method of claim 7, wherein the step of determining a plurality of possible routes is further based on an amount available on an account.

11. The method of claim 6, wherein the step of determining a plurality of possible routes is further based on a temporal travel budget.

12. A method for providing navigation information for a vehicle performed on a computing device, the method comprising:
receiving an input relating to a travel path for the vehicle;
determining a plurality of different possible routes for presentation based at least in part on toll amounts being assessed on at least some segments of the possible routes based on current and/or predicted traffic conditions; and
presenting navigation information related to the plurality of possible routes determined during the determining step, including the amount of any tolls to be assessed.

13. The method of claim 12, wherein the step of determining a plurality of different possible routes includes comparing any tolls to be assessed for a route to a maximum amount to be paid.

14. The method of claim 12, wherein the step of determining a plurality of different possible routes is further based on the estimated travel time for using each route.

15. The method of claim 12, wherein the step of determining a plurality of possible routes is further based on an amount available on an account.

16. The method of claim 12, wherein the step of determining a plurality of possible routes is further based on a temporal travel budget.
